(19) United States
(12) Patent Application Publication
(10) Pub. No.: US 2014/0195269 A1
(43) Pub. Date: Jul. 10, 2014

(54) SYSTEM AND METHOD FOR HEALTH ASSESSMENT, PREDICTION AND MANAGEMENT

(71) Applicant: 360 HEALTH VECTORS PRIVATE LIMITED, Karnataka (IN)

(72) Inventors: Subhasish SIRCAR, Karnataka (IN); Jagsir Singh CHOUHAN, Mahasamund (IN)

(73) Assignee: 360 HEALTH VECTORS PRIVATE LIMITED, Karnataka (IN)

(21) Appl. No.: 14/149,001

(22) Filed: Jan. 7, 2014

(30) Foreign Application Priority Data
Jan. 8, 2013 (IN) 122/CHE/2013

(51) Int. Cl. G06F 19/00

(52) U.S. Cl. CPC G06F 19/322
USPC 705/3

(57) ABSTRACT

A health assessment, prediction, and management system/method includes a first mechanism that acquires and captures a data set comprising an individual's health status, a local computer server having a first platform for the first mechanism to input the data set, and a central server in communication with the local computer having a second platform for the transmittal of the data set from the local computer server to the central server. A second mechanism accesses the data set in the central server, analyzes the data set, and provides an analytical result. The analytical result may include a health score/grade/index generated by the second mechanism and a health risk assessment provided by the second mechanism. A third platform allows the second mechanism to input the data set and the health score/grade/index. An expert system, with self learning/discovery capability is created based on the data set and the health score/grade/index.

### CROSS REFERENCE TO RELATED APPLICATION

This application is a complete application in pursuance of the Provisional Application No. 122/CRE/2013, filed on Jan. 8, 2013, titled “SYSTEM AND METHOD FOR HEALTH ASSESSMENT, PREDICTION, AND MANAGEMENT.,” which is hereby incorporated by reference in its entirety.

### FIELD OF INVENTION

The present invention is directed to a system for health assessment, prediction, and management. More particularly the present invention is directed to a secure system for health assessment, prediction, and management that provides a health score and a health grade for an individual and correspondingly a combined health index for an ecosystem housing the individual. The invention also includes a method for obtaining the health score, health grade and the health index by employing the system. The invention further includes performing risk assessments for the individuals and providing recommendations to the individuals to manage and reduce the health risks.

### BACKGROUND OF INVENTION

In today's fast paced world individuals, in general, lead a very stressful and unhealthy life. Leading a sedentary life with increased work pressure added with erratic food habits, lack of exercise, and/or genetically driven issues are leading to a constant increase in lifestyle diseases like obesity, cardiovascular diseases, hypertension, hypotension, and diabetes. This added to a known lack of time and a denial mode that results in the individual believing that no issue can affect his/her health keeps the individual away from walking the healthy path.

Various attempts are being explored to ensure the availability of efficient and reliable systems and methods to track the health of individuals. However, even if the individual themselves realise the importance of the saying “health is wealth” and actively work towards a healthy life, there remains a continuous need for an efficient and cost-effective system and method to make individuals health conscious and assist and motivate them in maintaining a healthy life and life style.

### SUMMARY OF INVENTION

In one embodiment, is provided a health assessment, prediction, and management system. The system includes a first mechanism capable of acquiring and capturing a data set comprising an individual's health status. The system further includes a local computer server, wherein a first platform is provided for the first mechanism to input the data set. The system also includes a central server in communication with the local computer server wherein a second platform is provided for the transmittal of the data set from the local computer server to the central server. The system includes a second mechanism capable of accessing the data set in the central server and analysing the data set acquired by the first mechanism. The second mechanism is capable of providing an analytical result. The analytical result may include a health score/grade/index generated with associated reasons provided by the second mechanism and a health risk assessment provided by the second mechanism. A third platform is provided in the central server for the second mechanism to input the data set and the health score/grade/index. An expert system is created in the central server based on the data set and the health score/grade/index.

In another embodiment, a health assessment, prediction, and management method is provided. The health assessment, prediction, and management method includes a first step of providing a first mechanism capable of acquiring and capturing a data set comprising an individual's health status. In a second step the method provides a local computer server wherein a first platform is provided for the first mechanism to input the data set. In a third step the method provides a central server in communication with the local computer wherein a second platform is provided for the transmittal of the data set from the local computer server to the central server. In a fourth step the method provides a second mechanism capable of accessing the data set in the central server and analysing the data set acquired by the first mechanism. The second mechanism is capable of providing an analytical result. The analytical result may include a health score/grade/index generated with associated reasons provided by the second mechanism and a health risk assessment provided by the second mechanism. In a fifth step the method provides a third platform in the central server for the second mechanism to input the data set and the health score/grade/index. In a sixth step an expert system is created in the central server based on the data set and the health score/grade/index.

In yet another embodiment is provided a health assessment, prediction and management system. The system includes a first mechanism capable of acquiring and capturing a first data set comprising an individual's health status. The system further includes a local computer server, wherein a first platform is provided for the first mechanism to input the first data set. The system also includes a central server in communication with the local computer wherein a second platform is provided for the transmittal of the first data set from the local computer server to the central server. The system includes a second mechanism capable of accessing the first data set in the central server and analysing the first data set acquired by the first mechanism. The second mechanism is capable of providing an analytical result. The analytical result may include a health score/grade/index generated with associated reasons provided by the second mechanism and a health risk assessment provided by the second mechanism. A third platform is provided in the central server for the second mechanism to input the first data set and the health score/grade/index. An expert system is created in the central server based on the first data set and the health score/grade/index. The expert system is further capable of interpolating, extrapolating, and correlating the health score/grade/index to a second data set acquired by the first mechanism for the same, different, or related individuals in the presence or absence of a second mechanism. The expert system is then capable of generating a health score/grade/index for the second data set. The expert system is capable of identifying infinitesimal changes in the second data set and providing a health score/grade/index associated with the infinitesimal changes.

In still yet another embodiment, a health assessment, prediction, and management method is provided. The health assessment, prediction, and management method includes a first step of providing a first mechanism capable of acquiring and capturing a first data set comprising an individual's health status. In a second step the method provides a local computer server wherein a first platform is provided for the first mechanism to input the first data set. In a third step the method provides a central server in communication with the local computer wherein a second platform is provided for the transmittal of the first data set from the local computer server to the central server. In a fourth step the method provides a second mechanism capable of accessing the data set in the central server and analysing the first data set acquired by the first mechanism. The second mechanism is capable of providing an analytical result. The analytical result may include a health score/grade/index generated with associated reasons provided by the second mechanism and a health risk assessment provided by the second mechanism. In a fifth step the method provides a third platform in the central server for the second mechanism to input the first data set and the health score/grade/index. An expert system is created in the central server based on the first data set and the health score/grade/index. The expert system is capable of interpolating, extrapolating, and correlating the health score/grade/index to a second data set acquired by the first mechanism for the same, different, or related individuals in the presence or absence of a second mechanism and generating a health score/grade/index for the second data set. The expert system is also capable of identifying infinitesimal changes in the second data set and providing a health score/grade/index associated with the infinitesimal changes. The expert system is capable of predicting a state of health of an individual.

In still yet another embodiment, is provided a health assessment, prediction and management system. The system includes a second mechanism, wherein the second mechanism provides a health risk assessment to an individual. The system also includes a first set of tools provided to an individual to act on the health risks assessed for the individual. The first set of tools consists of a Risk Control Tool, Health Assessment Tool, Health Risk Assessment Tool, and a Risk Reduction Path Tool. The system further includes a second set of tools provided to an organization housing a population of individuals to act on the health risks assessed for the population of individuals. The second set of tools consists of a Risk Mitigation Tool, Return on Investment Tool, Heat Map Tool, and Insurance Premium Negotiation Tool.

By employing the above disclosed system and method an efficient method is generated to maintain the health of individuals may be achieved.

### BRIEF DESCRIPTION OF DRAWINGS

The patent application file contains at least one drawings executed in color. Copies of this patent or patent application publication with color drawings will be provided by the Office upon request and payment of the necessary fee.

FIG. 1 is a flow chart illustrating a schematic representation of the health assessment, prediction, and management system in accordance with embodiments of the present technique;

FIG. 2 is a flow chart illustrating a schematic representation of the health assessment, prediction, and management system in accordance with embodiments of the present technique;

FIG. 3 is a flow chart illustrating a schematic representation of the health assessment, prediction, and management system in accordance with embodiments of the present technique;

FIG. 4 is a flow chart illustrating a schematic representation of the health assessment, prediction, and management system in accordance with embodiments of the present technique;

FIG. 5 is a schematic illustrating a comparison of an assessment technique used traditionally and of an assessment technique used in accordance with the health assessment, prediction, and management system in accordance with embodiments of the present technique;

FIG. 6 is a schematic illustrating a comparison of an assessment technique used traditionally and of an assessment technique used in accordance with the health assessment, prediction, and management system in accordance with embodiments of the present technique;

FIG. 7 is a schematic illustrating an assessment technique used in accordance with the health assessment, prediction, and management system in accordance with embodiments of the present technique;

FIG. 8 is a schematic illustrating an assessment technique used in accordance with the health assessment, prediction, and management system in accordance with embodiments of the present technique;

FIG. 9 is a schematic illustrating a classification of the data set in accordance with the health assessment, prediction, and management system in accordance with embodiments of the present technique;

FIG. 10 is a portion of a schematic representation of the health assessment, prediction, and management system in accordance with embodiments of the present technique;

FIG. 11 is a flow chart illustrating a schematic representation of a portion of the health assessment, prediction, and management system in accordance with embodiments of the present technique;

FIG. 12 is a chart illustrating the parameters that have been studied to determine the relative importance of the parameters in a sub-group in accordance with embodiments of the present technique;

FIG. 13 is a graph illustrating the interrelationship between top parameters in accordance with embodiments of the present technique;

FIG. 14 is a chart illustrating relative scoring of ranked parameters in accordance with the embodiments of the present technique;

FIG. 15 is a graph illustrating the score slopes for a group in accordance with embodiments of the present technique;

FIG. 16 is a score data base derived from the score slopes for a sub-group in accordance with embodiments of the present technique;

FIG. 17 is a relative parameter effects scale in accordance with embodiments of the present technique;

FIG. 18 is a relative parameter effects database in accordance with embodiments of the present technique;

FIG. 19 includes parameter effect slopes in accordance with embodiments of the present technique;

FIG. 20 is an age effect database and age effect slope in accordance with embodiments of the present technique;

FIG. 21 is a sub-group score calculating method derived in accordance with embodiments of the present technique;

FIG. 22 is a score distribution plot for a large population of individuals in an ecosystem in accordance with embodiments of the present technique;

FIG. 23 is data on rank and weight age for parameters of a group in accordance with embodiments of the present technique;

FIG. 24 includes color distribution based on parameter weight ages for parameters of a group in accordance with embodiments of the present technique;

FIG. 25 is a group score chart in accordance with embodiments of the present technique;

FIG. 26 is a flow chart showing the super groups in accordance with the embodiments of the present technique;

FIG. 26A is a schematic representation Risk Reduction Path in accordance with the embodiments of the present technique;

FIG. 27 is an Individual Personal Dashboard (IPD) in accordance with an embodiment of the present technique;

FIG. 28 is an Individual Personal Dashboard (IPD) in accordance with an embodiment of the present technique;

FIG. 29 is an Health Assessment Tool (HAT) in accordance with an embodiment of the present technique;

FIG. 30 is an Health Assessment Tool (HAT) in accordance with an embodiment of the present technique;

FIG. 31 is an Health Assessment Tool (HAT) in accordance with an embodiment of the present technique;

FIG. 32 is an Health Assessment Tool (HAT) for an employee and medical practitioner in accordance with an embodiment of the present technique;

FIG. 33 is an Health Risk Assessment Tool (HRAT) for an employee and medical practitioner in accordance with an embodiment of the present technique;

FIG. 34 is a Risk Control Tool (RCT) for an employee and medical practitioner in accordance with an embodiment of the present technique;

FIG. 35 is a Risk Control Tool (RCT) for an employee and medical practitioner in accordance with an embodiment of the present technique;

FIG. 36 is an Employer Global Dashboard 3600 (EGD) in accordance with an embodiment of the present technique;

FIG. 37 is an Employer Global Dashboard 3600 (EGD) in accordance with an embodiment of the present technique;

FIG. 38 is an Employer Global Dashboard 3600 (EGD) in accordance with an embodiment of the present technique;

FIG. 39 is an Employer Global Dashboard 3600 (EGD) in accordance with an embodiment of the present technique;

FIG. 40 is an Employer Global Dashboard 3600 (EGD) in accordance with an embodiment of the present technique;

FIG. 41 is an Employer Global Dashboard 3600 (EGD) in accordance with an embodiment of the present technique;

FIG. 42 is an Employer Global Dashboard 3600 (EGD) in accordance with an embodiment of the present technique;

FIG. 43 is an Employer Global Dashboard 3600 (EGD) in accordance with an embodiment of the present technique;

FIG. 44 is an Employer Global Dashboard 3600 (EGD) in accordance with an embodiment of the present technique;

FIG. 45 is an Employer Global Dashboard 3600 (EGD) in accordance with an embodiment of the present technique;

FIG. 46 is an Employer Global Dashboard 3600 (EGD) in accordance with an embodiment of the present technique;

FIG. 47 is an Employer Global Dashboard 3600 (EGD) in accordance with an embodiment of the present technique;

FIG. 48 is an Employer Global Dashboard 3600 (EGD) in accordance with an embodiment of the present technique;

FIG. 49 is a Risk Mitigation Tool (RMT) for an employer in accordance with an embodiment of the present technique;

FIG. 50 is a Risk Mitigation Tool (RMT) for an employer in accordance with an embodiment of the present technique;

FIG. 51 is an Insurance Premium Negotiation Tool for an employer in accordance with an embodiment of the present technique; and

FIG. 52 is a partial view of a Return On Investment (ROI) tool in accordance with an embodiment of the present technique.

### DETAILED DESCRIPTION

Embodiments of the invention as disclosed herein provide a targeted and focussed health assessment, prediction, and management process. In today's fast paced world health issues may cause severe setback to a country's growth and economy. Following the policy “prevention is better than cure” may provide better quality of life to every individual. Health programs that may be uniquely designed to proactively intervene and keep individuals healthy can be a solution to this need. Particularly corporate employees, in general, lead a very stressful and unhealthy life. Losing employee time temporarily for a short or long period or permanently due to health reasons is a problem every corporate faces at one time or another. Additionally “presenteeism” is another factor that organizations have to deal with since the employee may be physically present at the work place but may not be physically and or mentally fit enough to work efficiently or to the employee's full capacity. This maybe attributed to the various factors including leading a sedentary life, increased work load, family pressures, erratic food habits, lack of exercise, working environment, living environment, geographical location, and genetically driven issues. The system disclosed herein provides a method to take a 360 degree perspective of an individual's health and then use various tools to allow the individual to improve and track changes to their health. In addition, the system also provides various health risk assessment tools that enable the individual to understand the risks associated with their habits, lifestyles, and family history.

The system and method disclosed herein are thus designed to help an individual to adhere to a health plan. The plan includes certain action points that the individual needs to move through almost in a loop type fashion and may be referred to as the “Adherence loop”. The plan attempts to ensure that the individual can take prescribed action to gain maximum benefit. For example, the adherence loop may include the following action points (i) believe: individual needs to believe that they have the condition (i.e., current or potential disease state), that the recommendations will work, and that they can be successful; (ii) frame: individual needs to build a mental model, or framework, of how the recommendations will work on his/her condition; (iii) know: individual needs to know the rules and what to expect; (iv) prompt: knowing what to do is often not enough. Individuals need cues and reminders to prompt action; (v) act: Action requires resources: physical, cognitive, emotional, social, and financial; and (vi) reinforce: Feedback provided to the individual reinforces belief to strengthen and drive adherence.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, and/or components thereof. The method steps, processes, and operations described herein are not to be construed as necessarily requiring their performance in the particular order discussed or illustrated, unless specifically identified as an order of performance. It is also to be understood that additional or alternative steps may be employed.

As used herein the terms first, second, third, etc. . . . describe various elements or steps and these elements or steps should not be limited by these terms. These terms may be only used to distinguish one element or step from another element or step. Terms such as “first”, “second”, and other numerical terms when used herein do not imply a sequence or order unless clearly indicated by the context. Thus, a first platform, first data set, or first step discussed below could be termed a second platform, second data set, or second step without departing from the teachings of the exemplary embodiments.

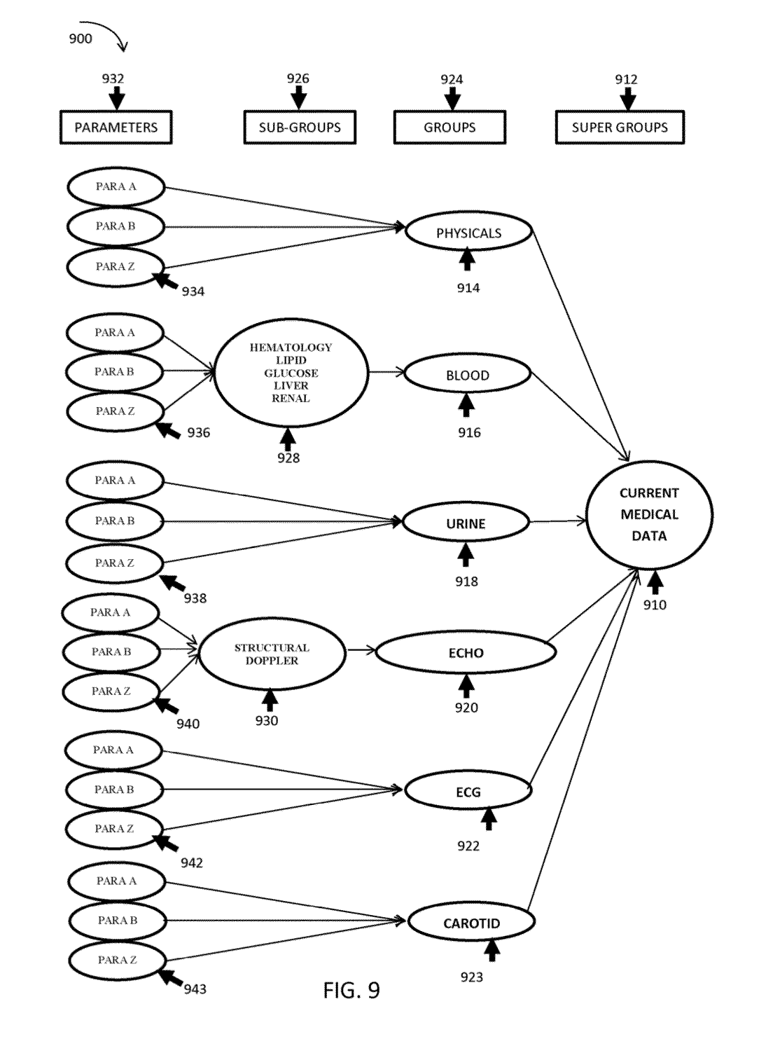

As used herein the term“score” means a health score assigned to different parameters, sub-groups, groups, and super groups as explained hereinafter at least with reference to FIG. 9. These scores are usually between 0 and 10, where 10 is the best and 0 is the worst. These scores are usually generated by determining the most important parameters in the sub-groups, groups, etc. . . . and then providing a weight age to each parameter based on the importance of these parameters to the human physiology. Also considered are deviations from the mean of the normal parameter ranges both, in the positive or in the negative directions and the amount or magnitude of these deviations. In various embodiments, the score may be expressed as a number, an alphabet, or as an alpha numeric value. In the instant disclosure, the score may be expressed as a number.

In the instant disclosure, the term “grade” is usually used when qualitatively defining an individual's health. In various embodiments, the grade may be expressed as a number, an alphabet, or as an alphanumeric value. In the instant disclosure, the grade is expressed either as an alphabet or an alpha numeric. The alphabets go from A through F, where A is attributed to the best possible health, and F is attributed to failed health (i.e., if the individual is in an emergency condition and needs immediate medical attention without any further delay). The numeric value indicates the risk levels that these individuals carry within their respective health alphabets. “1” indicates lower level of risk and any number higher than “1” indicates higher level of risk. The grades are then used to determine the index of an ecosystem housing a population of individuals.

As used herein the term “index” indicates an ecosystem's, for example, an organization's or a company's health status on the whole, i.e., the health status of a population of employees employed in that organization. Any specific group can be assigned a health index for that group. In various embodiments, the index may be expressed as a number, an alphabet, or an alpha numeric value. In the instant disclosure, the health index is expressed as a number with values from 0 to 100, where 100 is the best possible index value and 0 is the worst possible index value. The exact index is determined by the population density of the grades A, B, etc. So more the number of A's and the B's instead of the D's and the F's, the higher the health index for the population.

Additionally the system and method described herein also provide for a visual color coded representation based on the associated health score/health grade/health index determined by employing the system and method described herein.

In one embodiment, the system and method disclosed herein are capable of consistently providing relevant health score/grade/index that help in determining the state of health and hence a required level of intervention to help the individual lead a healthy life. In addition to providing the health score/grade/index the system and method also provide associated reasons for arriving at the health score/grade/index. In another embodiment, the system and method disclosed are also capable of providing health score/grade/index with associated reasons based on an observed trend or pattern when comparing at least two data sets. For example the trend may be observed in different scenarios including but not limited to (i) when the data set may belong to related persons, say father and son; (ii) when the data set collected for a son/daughter includes details of family history and genetic disposition—a trend between the data set of the son/daughter and the historical data; (iii) when both the data sets may belong to a same individual but are obtained at two separate time intervals; and (iv) between two data sets when both the data sets may belong to different individuals. Studying the trend or pattern is advantageous as it assists an individual (via recommendations and prescriptions) to lead a healthy life based on the individual's own or other's experiences and on evidence and experience based science. In one embodiment, the system and method disclosed herein is capable of providing a similar kind of information for a population of individuals in an ecosystem.

In one embodiment, the data set may include necessary or essential data that may be gathered in determining an individual's health status. In another embodiment, the data set may include existing data. For example the data set may include, but is not limited to, data relating to the individual's current health status, past health status, lifestyle habits, family and work related stress, family history, genetic disposition, known medical conditions, work habits, and individual's perception of their health. In various embodiments, the acquired data set may be in the form of numerical data, images, photographs, among other forms as known to one skilled in the art.

In one embodiment, the acquired data set may be captured and stored in a digitized manner or in a numerical format. For example, if the acquired data is a graph of values plotted on an X-Y axis, a visual image, or a plot showing an electrocardiogram, this data may be translated in to a numerical format representing the various parameters that were originally employed in creating the graph or the visual data or the electrocardiogram. Capturing and storing the acquired data in a digitized or numerical format may have several advantages including, but not limited to, (i) minimizing the difference in interpretation or opinion when viewed at different points of time by same or different people; (ii) reducing the time taken to interpret the graph/image in every successive evaluation of the data; (iii) ease with which data interpretation, analyses, and comparisons (trends) can be performed and (iv) automating the data analysis process.

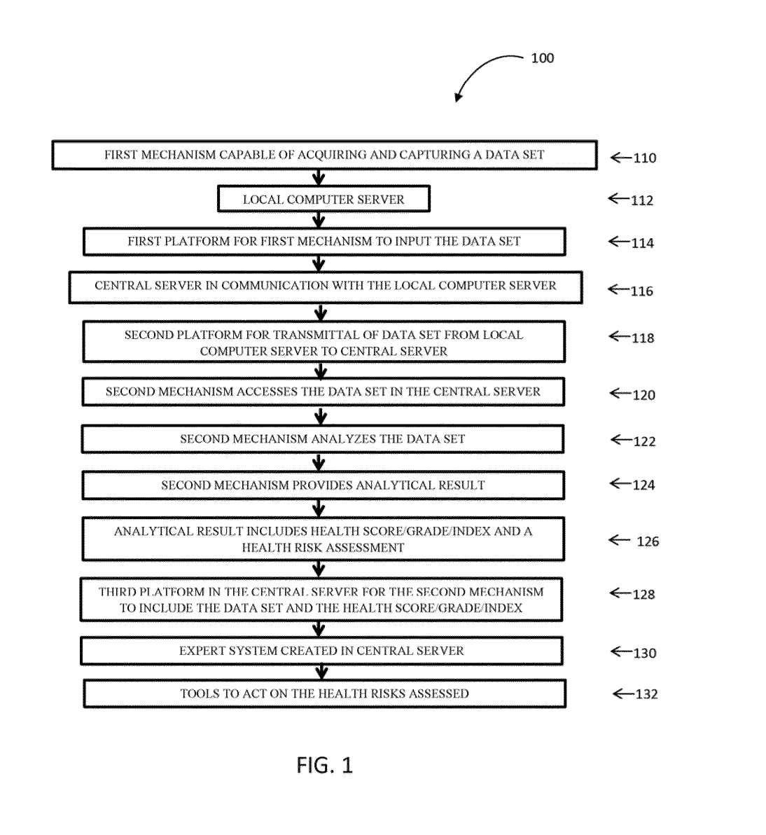

Referring to FIG. 1, in one embodiment, a flow chart illustrating a schematic representation of the health assessment, prediction, and management system 100 in accordance with embodiments of the present technique is provided. The system includes a first mechanism capable of acquiring and capturing a data set 110 comprising an individual's health status. The system further includes a local computer server 112. A first platform is provided for the first mechanism to input the data set 114 in the local computer server. The system also includes a central server in communication with the local computer server 116 wherein a second platform is provided for the transmittal of the data set from the local computer server to the central server 118. The system includes a second mechanism capable of accessing the data set in the central server 120 and analysing the data set acquired by the first mechanism 122. The second mechanism is capable of providing an analytical result 124. The analytical result may include a health score/grade/index generated with associated reasons provided by the second mechanism and a health risk assessment provided by the second mechanism 126. A third platform is provided in the central server for the second mechanism to input the data set and the health score/grade/index 128. An expert system is created in the central server based on the data set and the health score/grade/index 130. Various tools are provided to an individual or an organization housing a population of individuals to act on the health risks of the individual or population of individuals respectively 132.

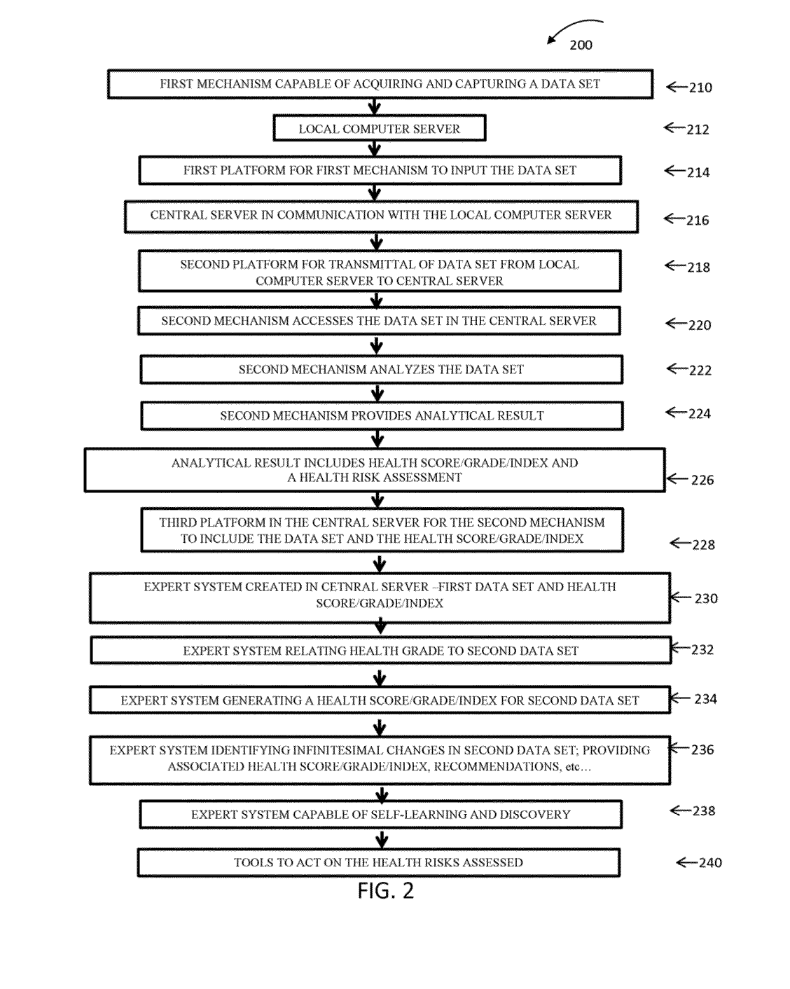

Referring to FIG. 2, in one embodiment, a flow chart illustrating a schematic representation of the health assessment, prediction, and management system 200 in accordance with embodiments of the present technique is provided. The system includes a first mechanism capable of acquiring and capturing a data set 210 comprising an individual's health status. The system further includes a local computer server 212. A first platform is provided for the first mechanism to input the data set 214 in the local computer server. The system also includes a central server in communication with the local computer server 216 wherein a second platform is provided for the transmittal of the data set from the local computer server to the central server 218. The system includes a second mechanism capable of accessing the data set in the central server 220 and analysing the data set acquired by the first mechanism 222. The second mechanism is capable of providing an analytical result 224. The analytical result may include a health score/grade/index generated with associated reasons provided by the second mechanism and a health risk assessment provided by the second mechanism 226. A third platform is provided in the central server for the second mechanism to input the data set and the health score/grade/index 228. An expert system is created in the central server based on the data set and the health score/grade/index 230. The expert system is further capable of interpolating, extrapolating, and correlating the health score/grade/index to a second data set acquired by the first mechanism 232 for the same, different, or related individuals in the presence or absence of a second mechanism. The expert system is then capable of generating a health score/grade/index for the second data set 234. The expert system is capable of identifying infinitesimal changes in the second data set and providing a health score/grade/index, recommendations, etc. . . . associated with the infinitesimal changes 236. The expert system is capable of providing a doctor's and nutritionist's recommendation based on a recommendation bank and the associated heuristics. Thus the expert system is capable of self-learning and discovery 238. Various tools are provided to an individual or an organization housing a population of individuals to act on the health risks of the individual or population of individuals respectively 240.

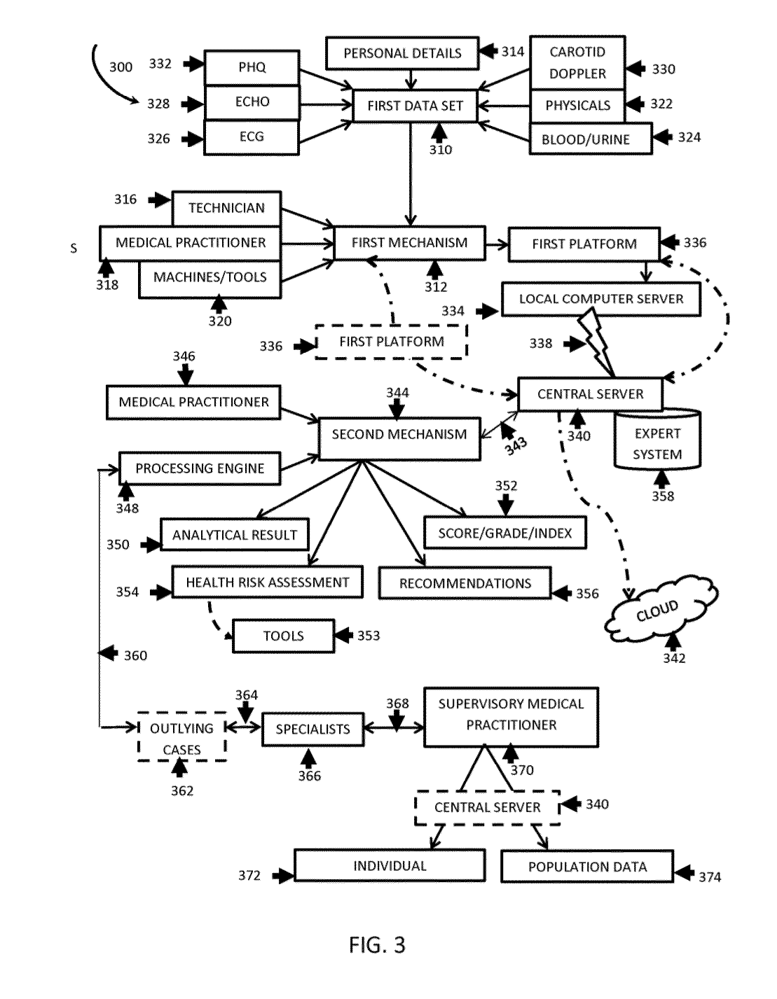

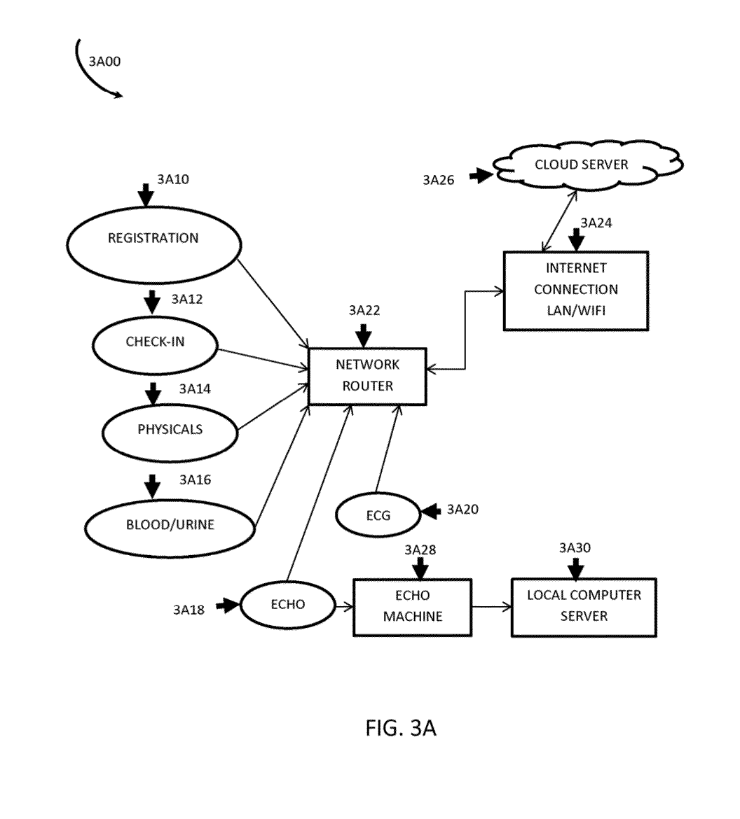

Referring to FIG. 3, a flow chart illustrating an exemplary schematic representation 300 of the health assessment, prediction, and management system in accordance with embodiments of the present technique is provided. The first mechanism 312 provided by the system 300 acquires and captures a first data set 310. The first step in acquiring the first data set 310 may require an individual to provide the individual's personal information/details 314 including name, contact details, and other similar necessary information. This information is used by the first mechanism 312 to register the individual in system 300. First mechanism 312 may provide different modes (not shown in figure) to the individual to provide the personal details 314 including a website of the system, a direct face to face contact where the details are provided, etc. . . . The individual may also use these different modes to schedule their tests and make necessary payments.

In one embodiment, the first mechanism 312 disclosed herein may include a well-equipped facility i.e., data collection center located at a particular place. In another embodiment, the first mechanism 312 disclosed herein may include a well-equipped mobile facility i.e., mobile data collection center that may be taken to the doorstep of the individual, for example, taken to an office or an apartment complex. The first mechanism 312 includes experienced technicians 316 and/or medical practitioners 318 who facilitate and hasten the data acquiring process. The first mechanism 312 may also include machines and tools 320 to assist in capturing the acquired data in a digitized or numerical format as described hereinabove. Tools 320 employed to collect the data may include checklists, medical equipment as known to one skilled in the art, etc. . . .

The first mechanism acquires various kinds of data 310 in addition to the personal details 314 of the individual. The other data may include information on an individual's health status. For example, the data may include but is not limited to (i) physical data 322 i.e., weight, height, measurement of body parts, etc., (ii) medical data i.e., samples like blood and urine 324 for generating medical data, ECG 326 (electrocardiogram), ECHO 328, CarotidDoppler 330, etc., (iii) data set based on a Personal Health Questionnaire (PHQ) 332 i.e., Mental Health & Stress (family related and work related stress, MH&S), Lifestyle Habits (LSH), Family Medical History (FMS), Known Medical Conditions (KMC), Food Habits (FH), Exercise Habits (EH), etc. . . . In different embodiments the data/samples for generating the first data set 310 may be acquired when the individual visits a data collection centre housing the first mechanism 312 or the first mechanism 312 may visit the individual at the individual's place of convenience to acquire the first data set 310 as mentioned hereinabove.

As known to one skilled in the art, the blood and urine samples need to be subjected to medical analysis before the generation of the first data set for blood/urine 324. The blood/urine data 324 may be directly entered into the local computer server 334 by the technicians 316/medical practitioners 318/machines analysing the data 320. The technician/medical practitioner 316/318 may transfer the data using file transfer protocol to the local computer server 334.

Accordingly, the first data set 310 may be captured by the first mechanism 312 using various embodiments as described herein. The first data set 310 including physicals 322, PHQ data 332, ECG 326, ECHO 328, Carotid Doppler 330, may directly be entered into a local computer server 334 by the first mechanism 334 using the first platform 336. One skilled in the art will appreciate that there could be various other clinical inputs that may be equally important for health assessment. The system and method described herein are flexible enough to accommodate such other clinical inputs.

The first mechanism 312 may use methods available in the art while capturing the acquired first data set 310. In one embodiment, where the first mechanism visits the individual at the individual's place of convenience to acquire the data the first mechanism 312 may use a simple method of pen and paper, a laptop, a table PC or any compatible method as first entering device (not shown in figure) for capturing the first data set 310. The first data set 310 may then be sent by the first mechanism 312 to the local computer server 334 by using the first platform 336. In another embodiment, where the individual visits the data collection centre housing the first mechanism 312 the first mechanism 312 may capture the first data set 310 by directly entering the first data set 310 in the local computer server 334 employing the first platform 336.

In one embodiment, the local computer server 334 is in communication 338 with a central server 340. In certain embodiments the local computer server 334 may be an optional feature of the system 300 and method disclosed herein. If the data collection point is located such that the central server is accessible for capturing the first data set 310 acquired by the first mechanism 312, a first platform 336 (indicated by dotted lined box) may be provided in the central server 340 for capturing the first data set 310 by the first mechanism 312. Using technologies available today, the data in the central server 340 may also be stored in a cloud 342 or the cloud 342 may itself serve as a central server 340.

The samples that are collected for generating data, for example, blood/urine samples may be sent to a laboratory for testing on the day of collection. The samples are processed in the laboratory and test results may be uploaded by a laboratory technician 316 on to the FTP site (file transfer protocol site, not shown in figure). The part of the first data set 310 i.e., blood/urine 324 data may then be sent to the central server 340 from the FTP site by the first mechanism 312.

The first data set 310 is then accessed 343 from the central server 340 by a second mechanism 344. In one embodiment, the second mechanism 344 includes but is not limited to a medical practitioner 346. In one embodiment, the medical practitioner 346 reviews the first data set 310 and provides an analytical result 350. In another embodiment, medical practitioner 346 may also provide a health score/grade/index 352 as part of the analytical result 350. In yet another embodiment, medical practitioner 346 may also provide a health risk assessment 354 as part of the analytical result 350. The system and method also provide various tools to an individual or an organization housing a population of individuals to act on the health risks of the individual or population of individuals respectively 353. In yet another embodiment, a medical practitioner 346 may also provide recommendations 356 as part of the analytical result 350. Once a sufficient number of first data sets 310 and corresponding analysis provided by the medical practitioners i.e., the analytical results 350, the health score/grade/index 352, the health risk assessment 354, and recommendations 356 are generated the corresponding analysis may be transferred 343 to the central server 340 by the second mechanism 344 using a third platform (not shown in figure). This corresponding analysis that forms a repository of information/heuristics may be used to form an expert system 358 in the central server 340.

In one embodiment, the second mechanism 344 may include a processing engine 348. In certain embodiments, the next set of first data sets 310 obtained from the central server may be processed directly by the processing engine 348 instead of by a medical practitioner 346. The processing engine 348 analyzes the next set of first data set 310, compares the corresponding results with the repository of information stored in the central server 340 i.e., the expert system 358. In one embodiment, the processing engine 348 may then provide the corresponding analysis i.e., the analytical results 350, the health score/grade/index 352, the health risk assessment 354, and recommendations 356 for the next set of first data sets 310 without the intervention of a medical practitioner.

This corresponding analysis information is also included in the central server 340 and helps to improve the expert system 358 which is a self-learning system. In most instances a specialist's input may not be warranted, except in outlying cases where a specialist's intervention and input may be needed. In certain embodiments, where the processing engine 348 discovers 360 any outlying cases 362 in the first data set 310, i.e., the information obtained from corresponding analysis does not completely or partially match the information in the expert system 358 then the intervention of a medical practitioner 346 is sought by the processing engine 348. The outlying cases 362 in the first data set 310 are sent 364 to specialists 366 (who may be medical practitioners specialized in specific areas, such as for example, cardiologists, ophthalmologists, gynecologists, neurologists, nephrologists, orthopedics, etc. . . . ) In one embodiment, the specialists 366 may then provide 368 the corresponding analysis to a supervisory medical practitioner 370. For example, the supervisory medical practitioner 370 may include a Director of Medical Services (DMS). The supervisory medical practitioner 370 may resend 368 the corresponding analysis back to the specialists 366 if some information still needs some explanation. The supervisory medical practitioner 370 is authorized to either validate the information or edit the information. When the supervisory medical practitioner 370 is satisfied with the explanation provided 368 by the specialist 366 the analysis information is included in the central server 340 using a third platform, based on which the expert system 358 is updated and improved.

Thus the expert system 358 is rendered as a self-learning system. The processing engine thus processes known data without need for intervention from a medical practitioner. In case there is an outlying case, for example, all other data is comparable with information in the expert system, except if the potassium values show an extreme value than what is expected by the expert system or does not fall within the experience range for the outlier parameter this case will be transferred to a specialist 366. This outlying case is reviewed by a team of specialists 366 and the expert system 358 is updated with this outlying case 362 and corresponding analysis. Any new outlying case 362 maybe viewed and analyzed in the same manner. One skilled in the art will appreciate that the system and method disclosed herein are aimed at automating the process of providing an analysis and associated health score/grade/index, recommendations, and risk assessments by forming an expert system. It may further be understood that many a time outlying data may find a place in the collected data sets and may need human intervention i.e., opinion from a medical practitioner. The outlying case and the opinion may then be used to populate the expert system. The expert system will at least be equipped to handle the identified outlying case in future data sets without intervention of any medical practitioner.

The analysis information stored in the central server 340 is then made available to the individual 372 whose first data set 310 was acquired by the first mechanism 312 and analyzed by the second mechanism 344. The analysis information stored in the central server 340 for a population of individuals i.e., population data 374 may be made accessible to an administrator (not shown in figure) of the population data 374. For example, if the population data 374 belongs to a population of individuals who are employees of an organization, the population data 374 is made accessible to the authorized personnel in the organization. The data for each individual in the particular population may be made available to each respective individual. What information may be viewed by the employee or the employer may be pre-decided via policy or contracts. In various embodiments described herein, only population data information may be shared with the employer in a holistic manner. Only if any employee gives permission the employer can delve into details of the individual employee's health records.

In embodiments where the processing engine is involved, the system disclosed herein may be automated based on the analytical results obtained from the second mechanism and comparison of these analytical results with the expert system as described hereinabove. Further not only the first data set 310 may be captured in the cloud 342, the processing engine may also be included in the cloud 342. In cases where part of the data of the first data set 310 are collected or generated using machines, i.e., ECHO, ECG, etc. . . . the data may be directly sent to the central server 340/cloud 342 using the third platform since the machines are in communication with the third platform and the central server 340/cloud 342. One skilled in the art will appreciate that any new system or mechanism for data storage and mining may be employed or adapted to be used with the system and method disclosed herein.

Referring to FIG. 3A, an exemplary schematic flow chart of a first mechanism 3A00 in accordance with embodiments of the present technique are provided. An individual (not shown in figure) may register 3A10 using a wired/wireless network router 3A22 and then check in 3A12 for a health check. The registration may be done online or onsite or through any compatible means. The individual enters the individual's personal data which forms a portion of the first data set. The network router 3A22 sends this information to a cloud server 3A26 via an internet connection 3A24. For the portion of the first data set that is collected by a first mechanism i.e., physicals 3A14 and data generated from the blood/urine 3A16 sample the first mechanism may enter this data in the cloud server 3A26 via the network router 3A22 and internet connection 3A22. Alternatively the first mechanism may enter this data in a local computer (not shown in figure) which is in communication with the cloud server 3A26. For the portion of the first data set that is collected using machines like an ECHO cardiogram 3A18 and ECG 3A20 the first data set may be directly sent to the cloud server 3A26 via the network router 3A22 and the internet connection 3A24. The ECHO cardiogram 3A18 may be also saved directly in a local computer server 3A30 through the ECHO machine 3A28. It may be noted that at all times the system and method disclosed herein make sure that the individual's identity is protected and the first data set is viewable only be authorized persons, i.e., a medical practitioner.

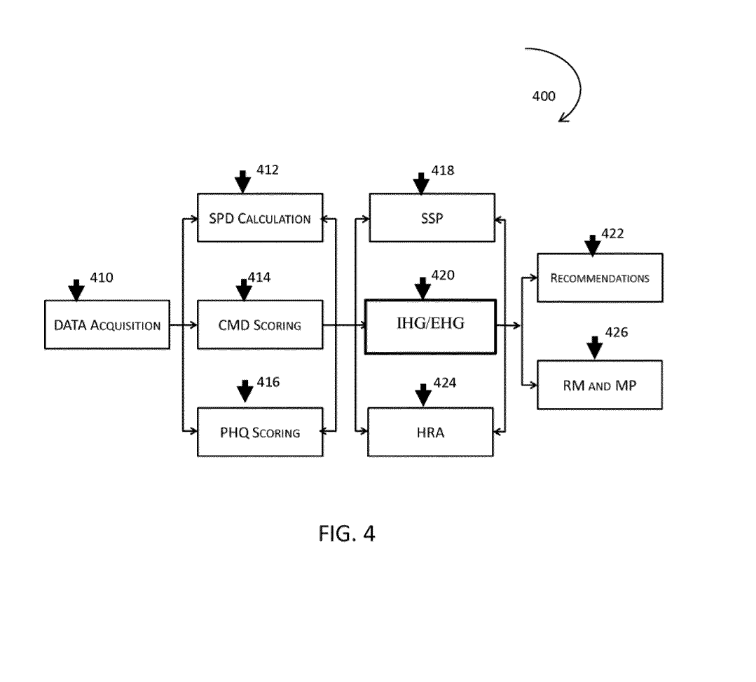

A detailed process followed by the processing engine may be described with reference to the schematic of a flowchart provided in FIG. 4. Referring to FIG. 4, a flow chart 400 illustrating a schematic representation of the health assessment, prediction, and management system in accordance with embodiments of the present technique is provided. The flow chart provides a process followed by the second mechanism, i.e., the processing engine 348 shown in FIG. 3. Once the data is acquired by the first mechanism 410, the second mechanism goes through multiple steps to arrive at the analytical result. The first data set is analysed using Specific Deviation (SPD) calculation 412 by the second mechanism. The CMD 414 and the PHQ data 416 of the individual are scored by the second mechanism to provide corresponding super group scores. The analysed data may then be presented or displayed to different viewers i.e., an individual, an organization (in instances where the individual is an employee of an organization), and a medical practitioner in different formats as explained herein below. In one embodiment, the top parameter issues may be displayed as a subject story palette (SSP) 418.

In another embodiment, an Individual Health Grade (IHG) (Employee health grade EHG in case of an individual who is working in organization) 420 maybe determined by the second mechanism Along with the health grade the second mechanism may also provide a health risk analysis (HRA) 424. The second mechanism may include an expert system (if already formed based on a statistical number of analytical results), a medical practitioner, a processing engine, and a processing engine in conjunction with a medical practitioner. Based on the IHG 420 and HRA 424 the second mechanism may also provide recommendations and required actions 422, and a risk mitigation and health management plan (RM and HMP) 426 to the individuals or the organization. Each analytical step carried out by the second mechanism as indicated in the flow chart 400 with reference to FIG. 4 is explained in detail below.

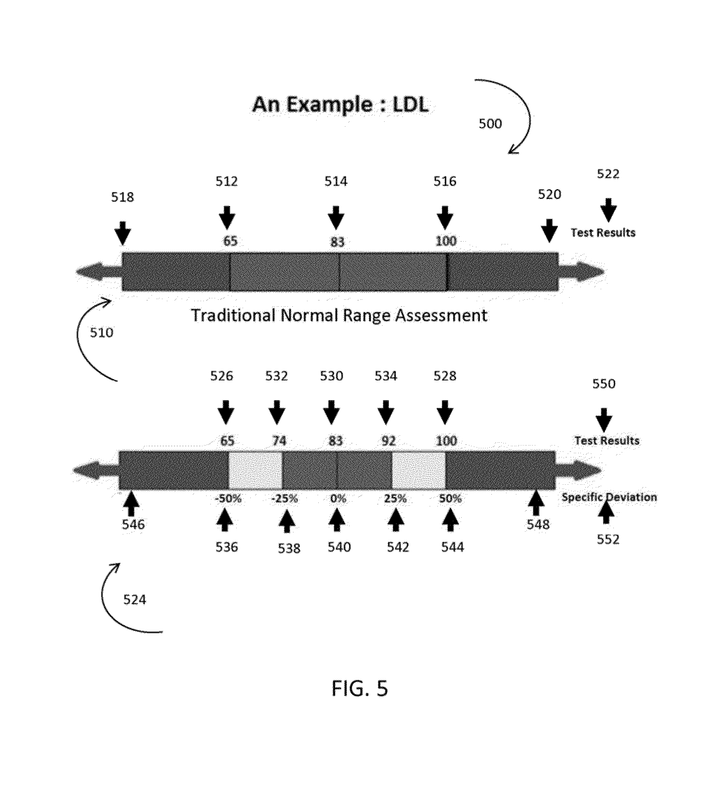

Referring to FIG. 5 a schematic illustrating a comparison 500 of an assessment technique used traditionally 510 (traditional normal range assessment) and of an assessment technique 518 used in accordance with the embodiments of the present technique is provided. FIG. 5 exemplifies the comparison 500 for LDL profile of an individual. In the art health related aspects have been accorded charts that provide normal parameter ranges for various values. Traditionally if the acquired test value for an individual falls within a normal parameter range a medical practitioner is not known to raise any concern or recommend any actions. As used herein the phrase “normal parameter range” in a parameter for a healthy individual is the range that is observed in a normal spread for healthy individuals for that parameter. Table 1 provides information for one set of Lipid Profile normal parameter ranges that are generally used by medical practitioners in the art. In an assessment technique used traditionally 510 if the LDL value of an individual falls within the normal parameter ranges provided in Table 1, the medical practitioners may not even inform the concerned individual of any potential health risk and not provide any recommendation or prescribe any risk mitigation or health management plan.

TABLE 1
Lipid Profile Normal Parameter Ranges in mg/dL

| Parameter | Adult Male | Adult Female |
|---|---|---|
| Total Cholesterol | 108-199 | <200 |
| TGL | 40-150 | 35-135 |
| HDL Cholesterol | 40-60 | 40-60 |
| LDL Cholesterol | 65-100 | 65-100 |
| VLDL | <30 | <30 |

wherein TGL is triglycerides, VLDL is very low density lipoprotein, HDL is high density lipoprotein, and LDL is low density lipoprotein.

For example, as shown in the comparison 500 the Traditional Normal Range Assessment 510 indicates an LDL normal parameter range of from about 65 milligrams per decilitre (mg/dL)512 to about 100 mg/dL 516 with a mean of about 83 mg/dL 514. This range is shown in green color. The ranges indicated by 518 i.e., 65 mg/dL and below and by 520 i.e., 100 mg/dL and above are shown in red color. Traditionally if in the test results 522 for an individual the LDL value falls in the range indicated by 65 milligrams per decilitre (mg/dL) 512 to about 100 mg/dL 516 the medical practitioner may inform the individual that all is well. Only if the LDL value falls in the ranges indicated by 518 i.e., lower than 65 mg/dL 512 or by 520 i.e., higher than 100 mg/dL 514 the medical practitioner may inform the individual and provide necessary recommendations.

In embodiments of the assessment technique of the instant disclosure 524 an LDL range/scale of from about 65 mg/dL 526 to about 100 mg/dL 528 with a mean of about 83 mg/dL 530 includes a distinct sub-range. The sub-range i.e., about 74 mg/dL 532 to about 92 mg/dL 534 with a mean of about 83 mg/dL 530 is colored in green. The range between about 74 mg/dL 532 to about 65 mg/dL 526 and the range between about 92 mg/dL 534 and about 100 mg/dL 528 are colored in yellow. The range indicated by 546 i.e., below 65 mg/dL and by 528 i.e., above 100 mg/dL are shown in red color. In the assessment technique of the instant disclosure 524 the second mechanism normalizes the test results i.e., first data set acquired for all parameters, irrespective of the units of measure using SPD 552 mode of measurement.

For parameters that have a range i.e., a low to a high normal parameter range like LDL, the SPD may be calculated using the following Formula I:

SPD=(TR−M)/S (I)

wherein SPD=Specific Deviation, TR=Test Result of individual, M is mean, S is span. SPD is a measure of the deviation of the respective TR from the normal parameter range mean (positive or negative) as a function of the normal parameter range (span). In various embodiments, the SPDs may be calculated in different ways for different parameters. SPD may be expressed as a percentage. For example as shown in Table 2 below,

TABLE 2

| | | | LOW OF | HIGH OF | MEAN OF | | | SPD |
|---|---|---|---|---|---|---|---|---|
| PARAMETER | UNIT | TR | RANGE | RANGE | RANGE | SPD FORMULA | SPD | PERCENT |
| LDL | mg/dL | 110 | 65 | 100 | 83 | =(110 − 83)/(100 − 65) | 0.79 | 79 |

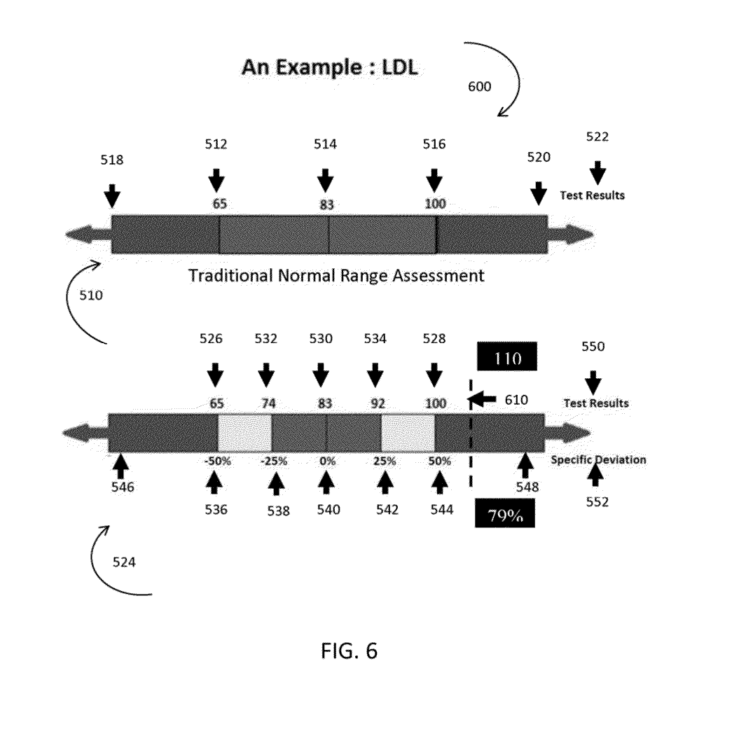

if the LDL TR of an individual is 110 mg/dL then the SPD is 0.79 or 79 percent as shown in Table 2 and FIG. 6 described herein below. The TR 550 are thus converted to SPD values 552 in the assessment technique 524 using the Formula I. Thus the LDL value 65 mg/dL 526 is translated to a SPD value of −50 percent 536, value 74 mg/dL 532 is translated to a SPD value of −25 percent 538, value 83 mg/dL 530 is translated to a specific deviation value of 0 percent 540, 92 mg/dL 534 is translated to a SPD value of +25 percent 542, and value 100 mg/dL 528 is translated to a SPD value of +50 percent 544.

The second mechanism may not provide a recommendation to the individual if the SPD of the individual's test results falls in the range indicated by the green color. However if the individual's test results falls in the range indicated by yellow color or the range indicated by the red color (546, 548) the second mechanism of the instant disclosure may inform the individual. The second mechanism may also provide a health risk assessment to the individual and provide necessary recommendations, for example, a change in the life style of the individual. These recommendations are made with a view to helping the individual in improving the individual's TRs and making an effort to move the TRs within the normal parameter range i.e., within the green color region. The system and method of the instant application provide the yellow color zone that may be considered as the buffer zone. One skilled in art will appreciate when considering a color palette that the yellow color is closer to the red color than the green color. The same analogy is being used here to show that if the system and method disclosed herein are not employed the TR which lies in the yellow zone has a higher possibility of slipping into the red zone than moving back to the green zone.

On the other hand if the system and method disclosed herein are employed the TR which lies in the yellow zone has a higher possibility of moving back to the green zone instead of slipping into the red zone, provided the individual follows the recommendations described herein. Accordingly in the assessment technique of the instant disclosure 524 the second mechanism and/or the medical practitioner inform the individual to take necessary action. This may be considered essentially as a conservative approach to prevent the individuals from entering the yellow zone from the green zone and the red zone from the yellow zone.

Referring to FIG. 6 a schematic illustrating a technique 600 of analysing the test results in accordance with the embodiments of the present technique is provided. In FIG. 6 it is shown 610 that when an LDL TR of an individual is 110 mg/dL then the SPD is 0.79 or 79 percent (data shown in Table 2). Thus as mentioned hereinabove since LDL has a range i.e., a low to a high normal parameter range, the SPD may be calculated using the Formula I given above. The description for the rest of FIG. 6 is the same as that provided for FIG. 5.

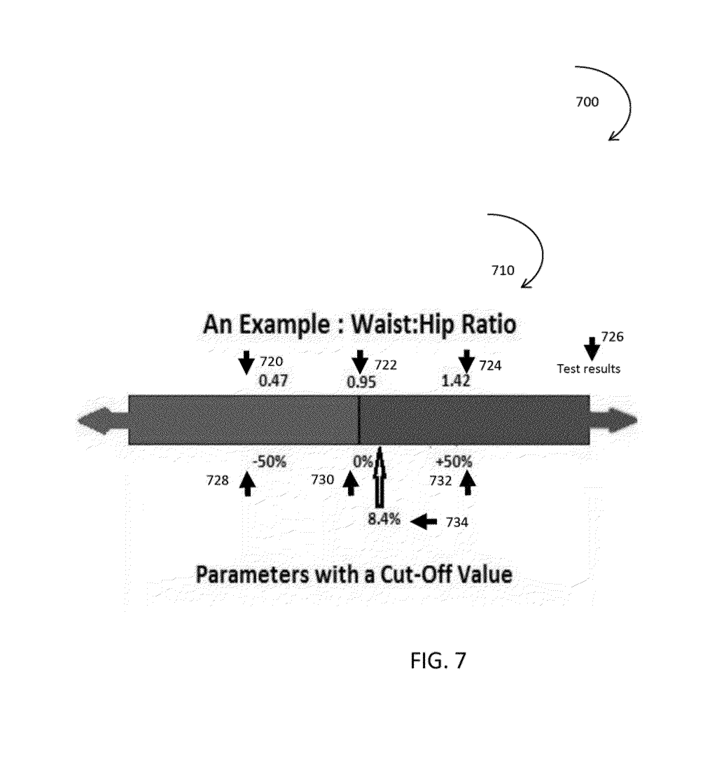

Referring to FIG. 7 a schematic illustrating a technique 700 of analysing the test results in accordance with the embodiments of the present technique is provided. For parameters that have one side cut-off values, for example, a waist/hip ratio 710 the SPD value may be calculated by using the following Formula II:

SPD=(TR−COV)/COV II

wherein SPD=Specific Deviation, TR=Test Result of individual, COV is cut-off value. SPD may be expressed as a percentage. One skilled in the art will appreciate that some parameters have a COV instead of a normal parameter range because medical practitioners understand that either the individual needs to obtain a value higher or lower than a specific value. This specific value is called COV, as shown in Table 3 below.

TABLE 3

| PARAMETER | UNIT | TEST RESULT | COV | SPD FORMULA | SPD | SPD PERCENT |
|---|---|---|---|---|---|---|
| Waist/Hip ratio | None | 1.03 | 0.95 | =(1.03 − 0.95)/0.95 | 0.084 | 8.42 |

As shown in FIG. 7 for the Waist/Hip ratio value of 0.47 720 the corresponding SPD is −50 percent 728, for the Waist/Hip ratio value of 1.42 724 the corresponding SPD is +50 percent 732, and the COV is 0.95 722 the corresponding SPD is 0 percent. The waist/hip ratio values less than the COV 722 is shown in green color and the waist/hip ratio values more than the COV 722 is shown in red color. The SPD 734 calculated for a waist/hip ratio TR 726 of 1.03 (not shown in figure) using formula II is 8.4 percent 734. Thus in accordance with present technique for parameters that have a TR value below the COV is considered healthy and aTR value above the COV is considered unhealthy and the individual is informed accordingly.

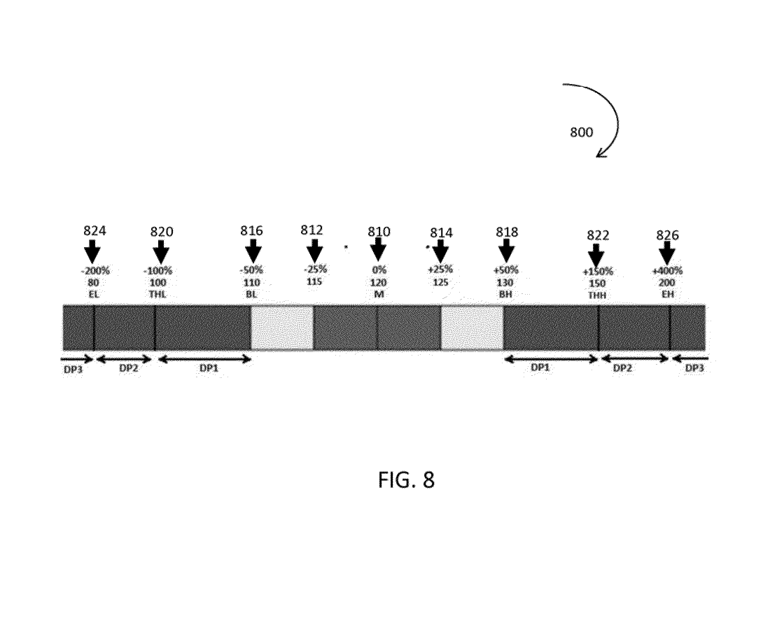

Referring to FIG. 8, a schematic 800 illustrating a definition for deranged parameters used for the assessment technique in accordance with the embodiments of the present technique is provided. The example used here demonstrates BP systolic (blood pressure systolic) test results. As mentioned with reference to FIG. 5 and FIG. 6, the traditional green range is broken up into green and yellow ranges. With reference to FIG. 8, the mean value M810 for the BP systolic value is 120 millimeters of mercury (mm of Hg) and the corresponding SPD at the mean point is 0 percent. The range indicated by green color with 115 mm of Hg 812 on the lower side of the mean value 810 and with 125 mm of Hg 814 on the higher side of the mean value 810 represent −25 percent and +25 percent SPD respectively.

The value 110 mm of Hg 816, with a SPD of −50 percent on the lower side of the mean value 810 is considered as border low (BL) value. The value 130 mm of Hg 818, with a SPD of +50 percent on the higher side of the mean value 810 is considered as border high (BH) value. The range between 812 and 816 (on the lower side) and between 814 and 818 (on the higher side) is shown in yellow. The assessment technique 800 in accordance with the instant disclosure further includes certain well defined parameter states even in the region depicted by the red color that include values lower than BL 816 and higher than BH 818 as provided in. Table 4 below. The emergent low (EL) value 824 with a value of 80 mm of Hg and a SPD of −200 percent and emergent high (EH) value 826 with a value of 200 mm of Hg and a SPD of +400 percent represent TR values beyond which the individual may need immediate attention since without the attention, conditions could be life threatening or a situation that could cause permanent harm to the individual. On the other hand the threshold low (THL) value 820 with aTR of 100 mm of Hg and a SPD of −100 percent and the threshold high (THH) value 822 with a TR of 150 mm of Hg and a SPD of +150 percent represent the TR values that are between the border high and border low values (816, 818) and the emergent values (824, 826) respectively. In the present technique, beyond THL and THH values, medical practitioners may begin to have serious concerns and need to act on the condition. With reference to FIG. 8 it is necessary to note that the figure is not to scale and the measurements shown are based on TR and corresponding calculated SPD. The parameter states defined in the assessment technique of the instant disclosure as shown in FIG. 8 may be described as provided in Table 4 below.

TABLE 4

| PARAMETER | |
|---|---|
| STATES | DEFINITION |
| Border High | Values within which the doctors are not concerned |
| and Border Low | because it is within the typical normal parameter range |
| Threshold | Point beyond which doctors get concerned and do |
| values | something about it, either procedures or medication |
| Emergent | Person needs immediate medical attention, condition |
| Condition | could otherwise be life threatening. |
| Deranged | In red region but not beyond threshold |
| Parameter | |
| 1 (DP1) | |
| Deranged | Between threshold and emergent condition |
| Parameter | |
| 2 (DP2) | |
| Deranged | Beyond emergent condition |
| Parameter | |
| 3 (DP3) | |

In various embodiments, every first data set of the instant disclosure may be classified as belonging to a super group. Each super group may include further BE classified into a group, a sub-group, and/or a parameter. Referring to FIG. 9, an exemplary schematic illustration 900 of the classification of the first data set in accordance with embodiments of the present technique is provided. For example, the CMD 910 may be considered as a super group 912. The physicals 914, blood 916, urine 918, ECHO 920, ECG 922, Carotid 923 and other tests individually conducted to arrive at the CMD may be considered as individual groups 924 that are used to derive a super group score of the CMD. Each group 924 may be further subdivided into sub-groups 926 that provide analytical results and a group score for the group. For example, the group score of group blood 916 of an individual may be determined through sub-groups 928 including hematology, glucose, lipid profile, renal function, liver function, and other necessary tests. Similarly the group score of the ECHO 920 of an individual may be determined through sub-groups 930 including structural and Doppler.

A sub-group score provided for each sub-group 926 is further dependent on various parameters 932 as known to one skilled in art and indicated by 934, 936, 938, 940, 942 and 943 in FIG. 9. Each parameter is accorded a parameter score which are used to derive the sub-group scores of the corresponding sub-groups 926 or group scores of corresponding groups 924 and then the group scores are used to derive the super group score of the corresponding super group 912. In case of certain groups 924, like physicals 914, urine 918, ECG 922, and Carotid 923 there may be no sub-groups and these groups derive their analytical results and group score directly from the parameter scores of the respective parameters 934, 938, 940, 942, and 943. Thus the super group includes groups, each group may include a sub-group or a parameter, and each super-group, group, sub-group, and parameter is allocated a score depending on the TR of all the individual parameters.

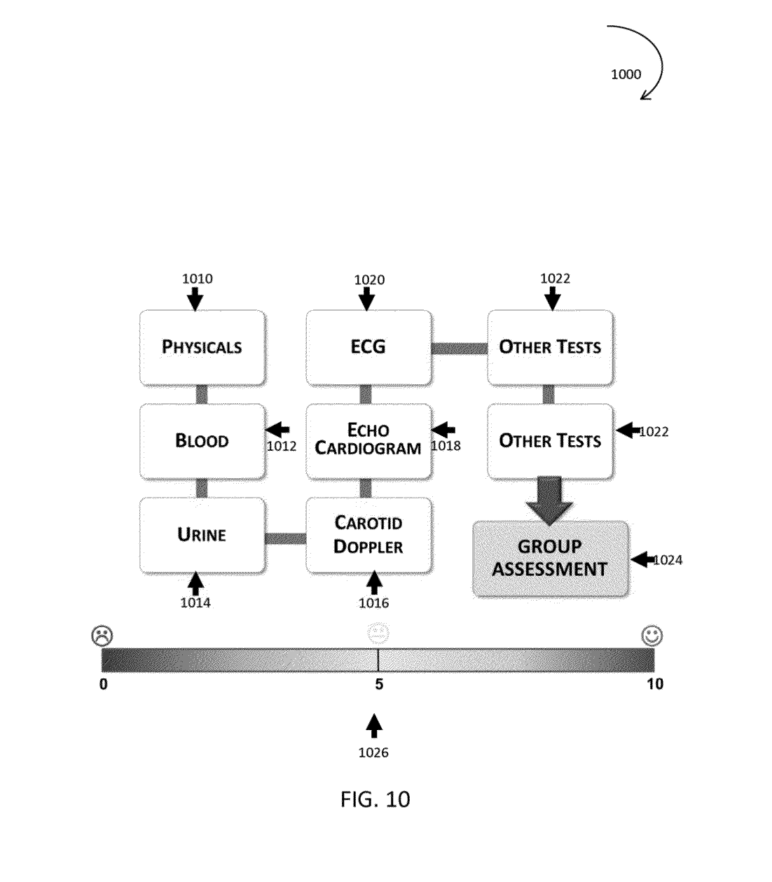

Referring to FIG. 10, a flow chart 1000 illustrating a portion of a schematic representation of the health assessment, prediction, and management system in accordance with embodiments of the present technique is provided. As discussed with reference to FIG. 4 and FIG. 9 Current Medical Data (CMD) is one set of data included in the first data set. As shown in in flow chart 1000 the CMD may include but is not limited to data relating to physicals 1010, blood 1012, urine 1014, Carotid Doppler 1016, ECHO 1018, ECG 1020 and other relevant tests 1022 of an individual. The CMD is a result of the group assessment 1024 of all these tests.

In embodiments with respect to the present technique a color scale is employed to grade the TR into the red, yellow, and green scale as discussed in FIG. 5 and FIG. 6. The color scale 1026 provided below the flow chart in FIG. 10 may be generated using the Lab Color Space. A Lab color space as known to one skilled in the art is a color-opponent space with dimension L for lightness and a and b for the color-opponent dimensions, based on nonlinearly compressed CIE XYZ color space coordinates. This space may be defined using the RED GREEN BLUE (RGB-primary colors) color palette. As shown in the colored scale 926, in the instant technique the XYZ co-ordinates for color green are 0, 150, 18; for color yellow are 245, 255, 45; and for color red are 250, 0, 0. For example, if there is a difference in 5 between two values say for example 245 (X co-ordinate for color yellow) and 250 (X co-ordinate for color red), this difference is divided by 50 to provide corresponding X co-ordinates for the color gradation within this range at every 0.1 score variation. Similar treatment can be accorded to Y and Z co-ordinates if required.

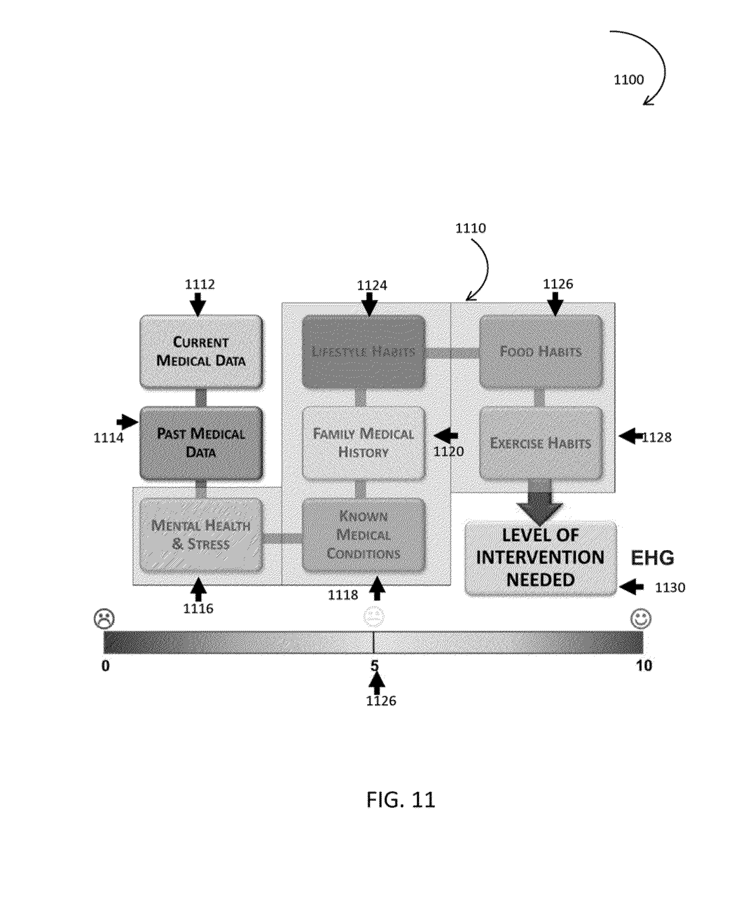

Turning back to FIG. 4, the health grade determination of an individual includes a PHQ 416 used to obtain personal health data. Referring to FIG. 11, a flow chart 1100 illustrating a schematic representation of a portion of the health assessment, prediction, and management system in accordance with embodiments of the present technique is provided. In addition to the super group scores provided to CMD 1112 (discussed hereinabove with reference to FIG. 4 and FIG. 10) and a Past Medical Data (PMD) 1114 (referenced in FIG. 4), the second mechanism may also provide the super group scores to the data based on the PHQ. Moreover, the second mechanism provides a health grade to an individual based on the clinical data and PHQ data. In the flow chart 1100 the data based on PHQ indicated by the grey shaded area 1110. The super group PHQ may include MH&S 1112, LSH 1114, FMS 1116, KMC 1118, FH 1120, EH 1122, and the like. Each super group in this case may directly be divided into parameters wherein the parameters include a set of questions (discussed in Table 13 and 14 hereinbelow). The answers to these questions may give the medical practitioners deep insights into these super groups in matters related to an individual's health.

As discussed herein, a super group score for the CMD may be obtained by assigning sub-group scores to individual sub-groups of the CMD as described at least with reference to FIG. 9. One skilled in the art will appreciate that the sub-groups of the CMD are tests that are general recommended by medical practitioners based on their current knowledge, experience, and available technology. In various embodiments, certain tests may be subtracted and certain tests may be added depending on various parameters including environment of the individual, requirements of the individual, and requirement for revising the testing based on a first round of analytical results, age, and sex of the individual, etc. . . . at the discretion of the medical practitioner.

In one embodiment, the instant disclosure provides at least three types of scoring process based on the super group/group/sub-group/parameters. For example for super group CMD as shown in Table 5:

TABLE 5
Scoring for Super Group CMD

| Scoring Process | Group/Sub-Group |
|---|---|
| Quantitative Data Scoring | Physicals |
| | Blood |
| | ECHO |
| | Other Tests |
| Qualitative Data Scoring using | Urine |
| weighted average method | |
| Mixed Scoring using both | ECG (rhythm - Qualitative) |
| Quantitative and Qualitative scoring | Carotid (Intima-Media Thickness |
| | (IMT) - Quantitative) |

In one embodiment, the instant disclosure additionally provides an understanding on different parameters that are used to obtain the sub-group scores based on the interrelationship between the parameters. Accordingly the identified top parameters i.e., the necessary and sufficient parameters may be identified for all sub-groups. The second mechanism can be just as effective with these few top parameters since the identified top parameters provide the maximum predictive power. The other parameters may not be used by the second mechanism to provide the sub-group scores as they do not significantly alter or add to the predictive power provided by the top parameters. The top parameters may be arrived upon based on the knowledge and experience of the medical practitioner

In one embodiment, the instant disclosure has employed two distinct steps to identify the top parameters in each sub-group. In a first step the medical practitioners may be asked to choose the top parameters in each group. In a second step an inter-parameter linear regression analysis may be run for these top parameters to determine the strength of their relationship with each other. This will determine the predictive power between these top parameters. One parameter that can predict a second parameter is retained and the second parameter is ignored or eliminated from the process of obtaining the analytical results. For example, for group blood, the total number of standard parameters that are tested in a traditional risk assessment method for sub-group haematology are about nineteen. A medical practitioner was asked to identify the top three to six parameters in order of their relative importance. The medical practitioner was also asked to “rank” the parameters based on their experience and knowledge. The statistical technique i.e., a linear regression analysis was applied to these selected top six parameters to determine the strength of their inter-parameter relationship with each other to bring down the number of parameters necessary for accurate analytical results. This resulted in three of the parameters showing enough predictive power for the other three parameters. So effectively three parameters of sub-group haematology were found having enough predictive power to provide accurate analytical results in lieu of the nineteen parameters.

In one embodiment, a panel of medical practitioners are asked to provide ranks, weight ages, and scores for the groups, sub-groups, and/or super groups identified by the instant disclosure. These ranks and weight ages are based on the ranking of parameters included under these groups, sub-groups, and/or super groups. The medical practitioners provide the ranks and weight ages based on their knowledge and experience. One skilled in the art will appreciate that with time and with new understanding and new knowledge this relative importance may change and it may lead to reassignment of ranks and weight ages for the parameters. Accordingly some new parameters may also get included and some existing parameters may be eliminated from the list of top parameters in a group or sub-group.

Referring to FIG. 12, a chart 1200 illustrating the parameters that have been studied to determine the relative importance of the parameters in a sub-group in accordance with embodiments of the present technique is provided. The chart 1200 illustrates parameters referred to in various health test models with reference to the groups/sub-groups. In the chart, the physicals group 1210 is shown to include parameters BP systolic 1212, BP diastolic 1214, BMI 1216, and other parameters 1218. The sub-groups of group blood (not shown in figure) include lipid profile sub-group 1220—with parameters like HDL 1222, LDL 1224, TGL 1226 and others 1228; haematology sub-group 1230—with parameters like platelet count 1232, leucocyte count 1234, haemoglobin count 1236, and others 1238; liver function sub-group 1240—with parameters like Serum Glutamic Phospho Transaminase (SGPT) 1242, total bilirubin 1244, alkaline phosphatase 1246, Serum glutamic oxaloacetic transaminase (SGOT) 1248, and others 1250; renal function sub-group 1252—with parameters like creatinine 1254, urea 1256, albumin 1258, uric acid 1260, and others 1262; glucose sub-group 1264—with parameters like fasting glucose 1266, and others 1268; group ECG 1270—with parameters like rhythm 1272, QR duration 1273, PR duration 1274, QTc interval 1275, ventricular rate 1276, and others 1277; group ECHO structural 1278—with parameters like ejection fraction 1279, septal thickness 1280, LV diastolic diameter 1281, LA AP Dia./BSA 1282, and others 1283; and Group ECHO Doppler 1284—with parameters like mitral deceleration time 1285, aortic valve 1286, and others 1287, group Carotid 1288—with parameters like stenosis 1289, mobility 1290, presence of plaque 1291, IMT thickness 1292, others 1293 and any other group having any other parameters. The parameters mentioned for group ECG and group ECHO structural are well known to one skilled in the art and may be understood at least with reference to the information provided in link http://en.wikipedia.org/wiki/QRS_complex.

As discussed in Table 5 above a part of the data forming the first data set can be analysed using a quantitative scoring process. For example, for sub-group lipid profile which has data with ranges as explained in FIG. 5 and FIG. 6 above the test results i.e., the data are normalized using SPD calculations and scoring is done using a quantitative scoring process as provided in Table 6. Table 6 includes the data and results for three individuals for their lipid profile data.

TABLE 6
An Example
Sub-Group
Lipid Profile: Data Collection and SPD calculations

| | | | | Parameters | | | | |
|---|---|---|---|---|---|---|---|---|
| | | | | | | | Total | |
| | | | | LDL | HDL | TGL | Cholesterol | VLDL |
| Individual | Age | Gender | | mg/dL | mg/dL | mg/dL | mg/dL | mg/dL |
| I-1 | 51 | Male | Range | 65-100 | 40-60 | 40-150 | 108-199 | <30 |
| | | | TR | 152 | 53 | 174 | 228 | 23 |
| | | | SPD | 199% R | 15% G | 72% R | 82% R | −23% G |
| I-2 | 26 | Male | Range | 65-100 | 40-60 | 40-150 | 108-199 | <30 |
| | | | TR | 102 | 39 | 141 | 160 | 19 |
| | | | SPD | 56% R | −55% R | 42% Y | 7% G | −37% Y |
| I-3 | 34 | Female | Range | 65-100 | 46-50 | 35-135 | <200 | <30 |
| | | | TR | 101 | 44 | 114 | 159 | 14 |
| | | | SPD | 53% R | −30% Y | 29% Y | −21% G | −58% R |

Table 6 provides the TR and SPD for individual 1 (age 51 years; gender male); individual 2 (age 26 years; gender male), and individual 3 (age 34 years; gender female). In Table 6 R stands for red, Y stands for yellow and G stands for green. The ranges as provided in Table 6 are same as shown in Table 1 for lipid profile parameter ranges that have been used as a normal parameter range with respect to embodiments of the present technique. One skilled in the art will appreciate that these ranges may differ based on instruments, laboratories, environment, location, countries, population being tested, etc. . . . Table 6 indicates that for a healthy individual LDL is in a normal parameter range of about 65 to 100 mg/dL, HDL is in a normal parameter range of about 40 to 60 mg/dL, TGL is in a normal parameter range of about 40 to 150 mg/dL, total cholesterol is in a normal parameter range of about 108 to 199 mg/dL, and VLDL is in an amount of less than about 30 mg/dL (showing a COV of a maximum of 30 mg/dL). Table 6 also provides the actual TR for the three individuals with respect to these parameters and the corresponding SPD calculated in accordance with Formula I.

Accordingly, when scoring lipid profile, the medical practitioners provide the initial list of top parameters in the group. For example in the case of lipid profile the medical practitioners consider LDL, HDL, TGL, total cholesterol, and VLDL as the top parameters needed to provide an accurate analytical result for the individual. As described herein before, an inter-parameter linear regression analysis may be run for these top parameters to determine the strength of their inter-parameter relationship with each other. This will determine the predictive power between these top parameters.

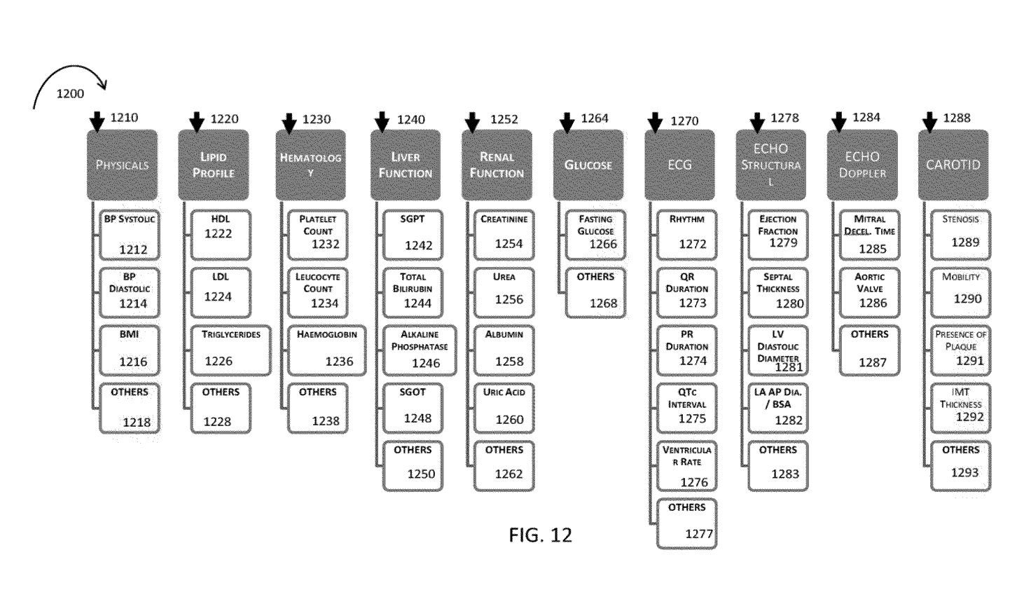

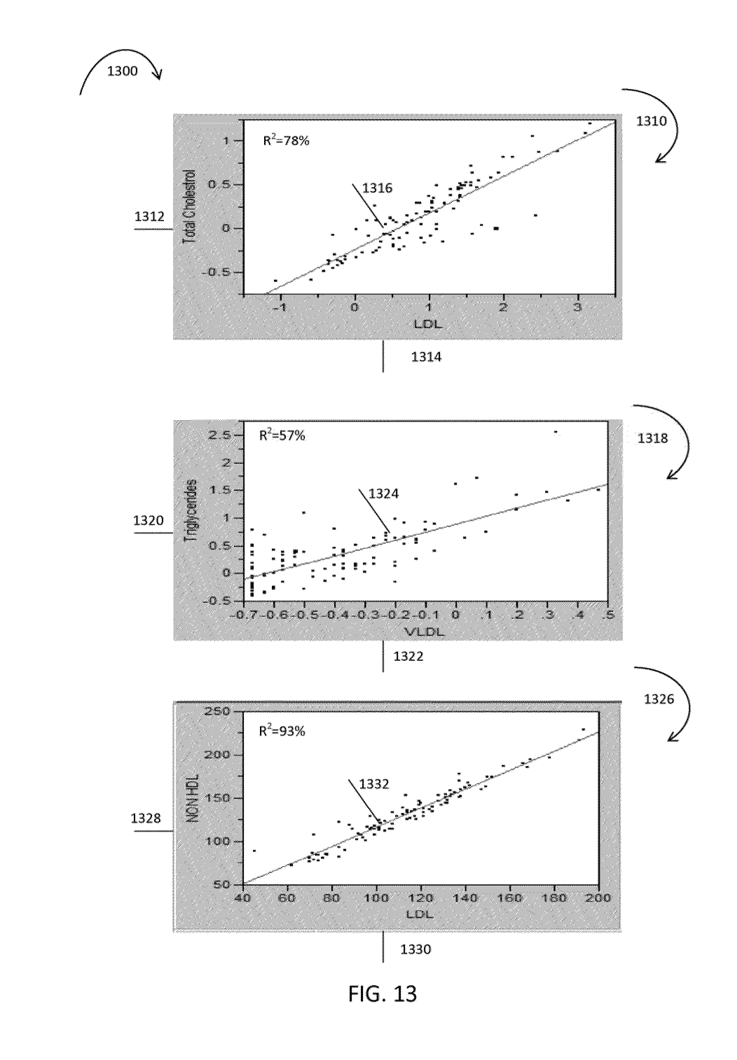

Referring to FIG. 13, graphs 1300 indicating the inter-relationship between top parameters in accordance with embodiments of the present technique is provided. Graph 1310 provides a bivariate fit (for 104 individuals) of total cholesterol and LDL values. The total cholesterol values were plotted on the Y-axis 1312 and LDL values were plotted on the X-axis 1314. A fitted straight line 1316 is also shown on graph 1310. The R² value which indicates the strength of this inter-relationship is 78 percent for graph 1310. In the examples described here the R² value was calculated using method described in the reference link http://easycalculation.com/statistics/r-squared.php. The correlation coefficient or R-squared (R²) value which depict the relationship between two data series and how well the model predicts the future outcomes. Pearson's formula is used for this calculation. Similarly Graph 1318 provides a bivariate fit of TGL and VLDL values. TGL values were plotted on the Y-axis 1320 and VLDL values were plotted on the X-axis 1322. A fitted straight line 1324 is also shown on graph 1318. The R² value which indicates the strength of this inter-relationship is 57 percent for graph 1318. Graph 1326 provides a bivariate fit with NON HDL and LDL values. NON HDL values were plotted on the Y-axis 1326 and LDL values were plotted on the X-axis 1330. A fitted straight line 1324 is also shown on graph 1326. The R² value which indicates the strength of this inter-relationship is 93 percent for graph 1326. Thus the data plotted in the graphs showed a linear relation between the data plotted on the Y-Axis and X-axis as shown in Graphs 1300.

As indicated by the high R² values with respect to Graphs 1310, 1318, and 1326 above, there is observed a strong inter-relationship between the parameters mentioned above. Therefore one parameter may be eliminated without losing the predictive power. Accordingly total cholesterol, non-HDL and VLDL may be ignored or eliminated from the analytical studies as explained herein above. Thus for determining the lipid profile sub-group score the number of top parameters may be reduced from 6 to 3 in the lipid profile sub-group. One skilled in the art will understand that the total number of top parameters, the inter-relationship between these top parameters, and the subsequent elimination of certain top parameters from the analytic studies may differ for different parameters and sub-groups.

In a next step towards achieving an analytical result from the TR for parameters that have normal parameter ranges, medical practitioners consider the high and low sides of these top parameters and rank them based on their effect on the human physiology. For example, in the case of sub-group lipid profile of group blood, low HDL appears to have the greatest effect on human physiology amongst the three parameters chosen based on the study of predictive power of parameters. Hence low HDL is ranked 1, high LDL is ranked 2, and high TGL is ranked 3. While on the other hand low LDL is ranked 4, low TGL is ranked 5, and high HDL is ranked 6.

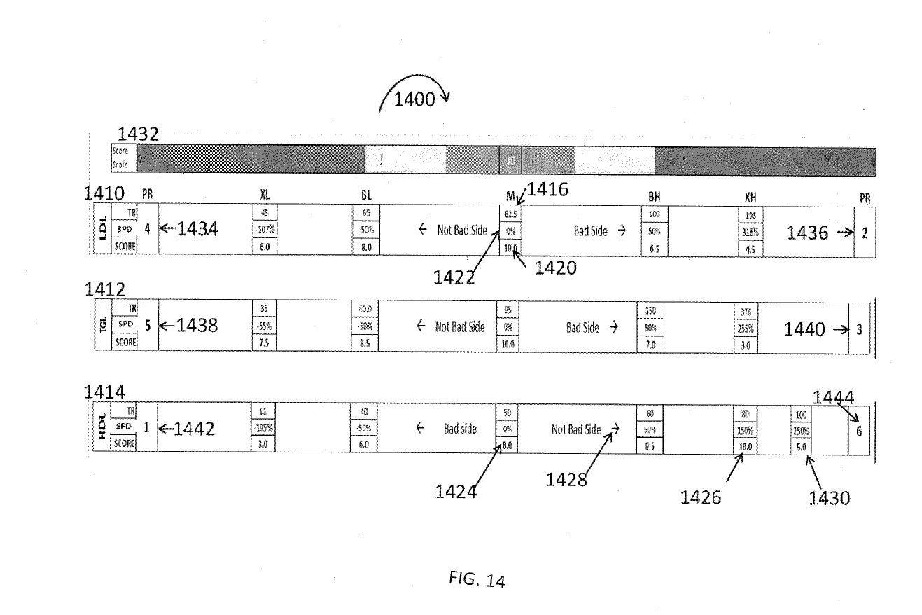

In a next step medical practitioners provide a relative scoring to these ranked parameters at border (B) values i.e., border low BL and border high BH. The medical practitioners also provide a high value much beyond the borders (both on high and low side of the normal range) based on their knowledge and experience of a relatively healthy population. These values are termed as extreme high (XH) and extreme low (XL) values. In the example shown in FIG. 14, the LDL value of 193 is XH and the value of 45 is XL. The medical practitioners not only provide these values of LDL but they also provide an associated relative parameter score depending on the effect of these values of LDL on human physiology. In this case XH has been given a parameter score of 4.5, and XL has been given a parameter score of 6.0, considering that 10 is the best score and 0 is the worst score possible. Thus the scoring on the high and low side of these parameters are expected to be not only inter-parameter based, but also intra-parameter based. Therefore based on this relative ranking, the following parameter scores have been given to the parameters provided in FIG. 14.

Referring to FIG. 14, a chart 1400 indicating relative scoring of ranked parameters in accordance with the embodiments of the present technique are provided. The Chart 1400 includes the parameter score scale 1410 for LDL, 1412 for TGL, and 1414 for HDL. The parameter score scale 1410 for LDL provides the TR values, the SPD values, and the parameter score values (shown but not marked in the figure). As shown in 1410 for LDL the TR with a value of 82.5 mg/dL 1416 has a parameter score of 10 1420 and a SPD of 0 percent 1422. Similarly a TR with a value of 100 mg/dT has a SPD of +50 percent and a parameter score of 6.5; a TR with a value of 193 mg/dL has a SPD of 316 percent and a parameter score of 4.5; a TR with a value of 65 mg/dL has a SPD of −50 percent and a parameter score of 8.0, a TR with a value of 45 mg/dL has a SPD of −107 percent and a parameter score of 6.0. As shown in 1412 for TGL the TR with a value of 95 has a parameter score of 10 and a SPD of 0 percent; a TR with a value of 150 mg/dL has a SPD of +50 percent and a parameter score of 7.0; a TR with a value of 376 mg/dL has a SPD of 255 percent and a parameter score of 3.0; a TR with a value of 40 mg/dL has a SPD of −50 percent and a parameter score of 8.5, a TR with a value of 35 mg/dL has a SPD of −55 percent and a parameter score of 7.5.

As provided by medical practitioners based on their knowledge and experience, the parameter rank PR for low LDL is 4 1434 and for high LDL is 2 1436, the PR for low TGL is 5 1438 and for high TGL is 3 1440, and the PR for low HDL is 1 1442 and for high HDL is 6 1444. In case of HDL, the normal parameter range is from about 40 mg/dL to 60 mg/dL with a mean value of 50 mg/dL. HDL behaves differently than either LDL or TGL whose examples have been shown in 1410 and 1412. Unlike LDL and TGL the mean value of 50 mg/dT (having a SPD of 0 percent) is given a parameter score of 8 1424 instead of a parameter score of 10. This is because deviation of HDL value from the mean on the positive side is considered to be beneficial (not bad side, 1428) to human physiology. Therefore the value of the parameter score of 10 1426 is attributed to a HDL value of 80 mg/dL. However any values of HDL greater than 80 mg/dL is given a parameter score lower than 10. For example, a TR value of 100 having a SPD of 250 percent is given a parameter score of 5.0 1430 based on its negative effect on human physiology. One skilled in the art will appreciate that certain parameters may require a similar treatment as HDL depending on their effect on human physiology. FIG. 14 also includes the color scale 1432 as described herein above.

As discussed above the medical practitioners consider high and low sides of these parameters and rank them based on their effect on the human physiology. So, in the case of lipid profile sub-group shown in FIG. 1400, the parameter low HDL is known to have the biggest effect (among the three parameter that are now being considered) on human physiology and so it is ranked 1, high LDL is ranked 2, and high TGL is ranked 3. Accordingly low LDL, low TGL, and high HDL are considered to have a rank of 4, 5, and 6 respectively.

As described above, the parameter scores given by the medical practitioners may be used to find out the score slope of each of the important parameters within each defined range. So, in effect, each parameter is fitted with straight lines and polynomials depending on whether the parameter TR is within the normal parameter range or outside of this range.

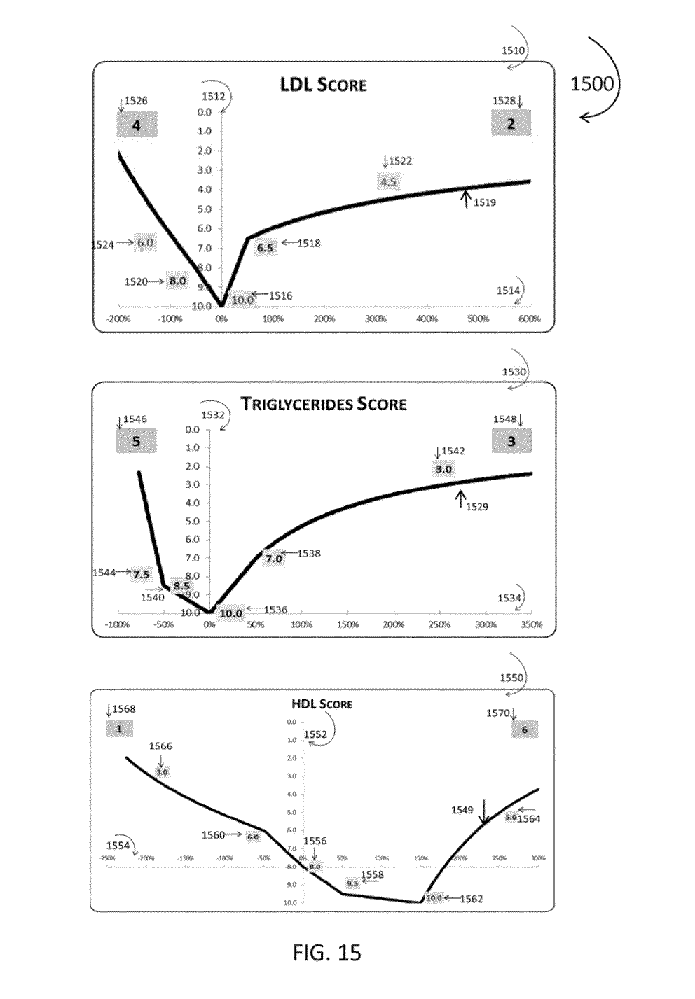

Referring to FIG. 15, graphs 1500 indicating the score slope plots for a group in accordance with embodiments of the present technique are provided. For example, parameter score slope plots for LDL 1510, TGL 1530, and HDL 1550 are shown in FIG. 15. For LDL 1510 the parameter score is plotted on the Y-axis 1512 and the SPD percent is plotted on the X-axis 1514. The X-axis includes the positive and negative SPD percent values. Instead of SPD percent values the X-axis may be plotted using TR (as shown in Formula I they are related). A parameter score slope 1519 is drawn using the LDL Mean 1516, LDL BH 1518, LDL BL 1520, LDL XL 1524, and LDL XH 1522. The PR for high LDL 1528 and low LDL 1526 are also shown in the graph. Using the parameter score slope 1519 the scores for any TR for LDL that may lie in the region defined by scores 0 to 10 may be determined.

In a second example, for TGL score slope plot 1530 the score value is plotted on the Y-axis 1532 and the SPD percent is plotted on the X-axis 1534. The X-axis includes the positive and negative SPD percent values. A parameter score slope 1529 is drawn using the TGL Mean 1536, TGL BL 1540, TGL BH 1538, TGLXL 1544 and TGLXH 1542. The PR for high TGL 1548 and low TGL 1546 are also shown in the graph. Using the parameter score slope 1529 the scores for any test result for TGL that may lie in the region defined by scores 0 to 10 may be determined. In another example, for HDL score slope plot 1550 the score value is plotted on the Y-axis 1552 and the SPD percent is plotted on the X-axis 1554. The X-axis includes the positive and negative SPD percent values. A parameter score slope 1549 is drawn using the HDL Mean 1556, HDL BH 1558, HDL BL 1560, HDL XL 1566, HDL XH 1564, and a HDL TR of 80 1562 (explained hereinbefore). Using the parameter score slope 1549 the scores for any test result for HDL that may lie in the region defined by scores 0 to 10 may be generated.

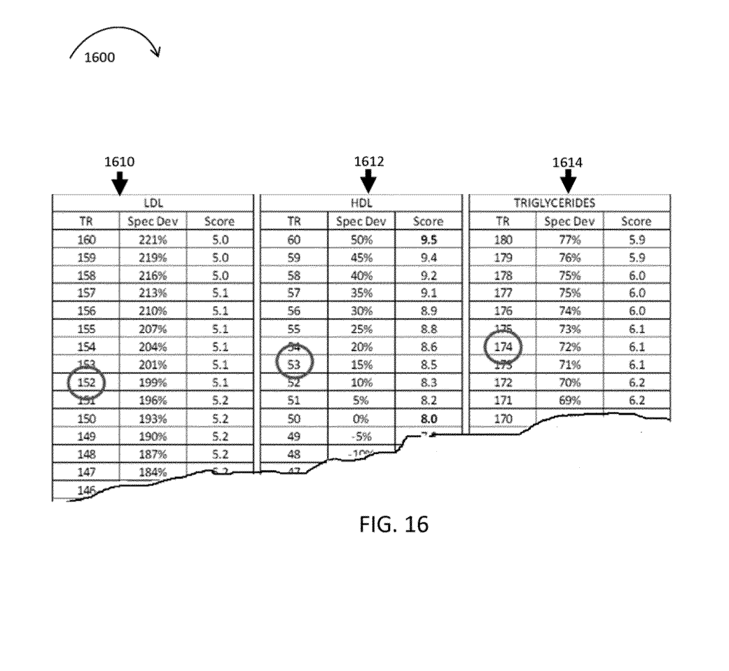

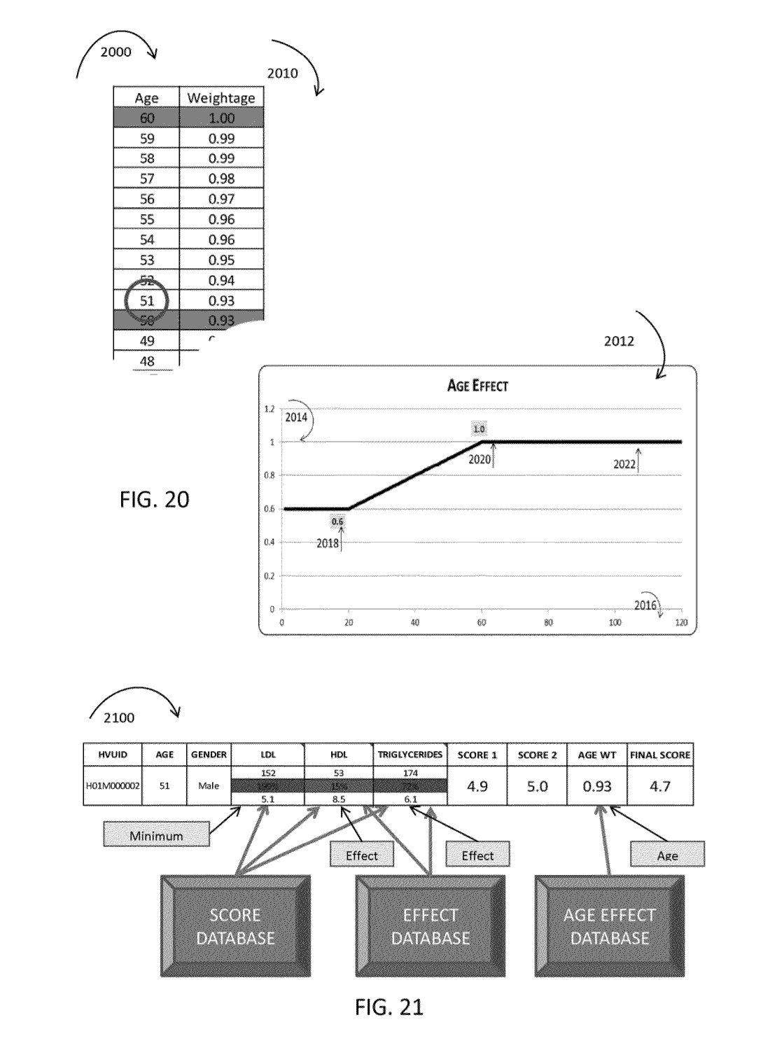

Using similar techniques the parameter score slopes for all the important parameters, within groups and sub-groups may be determined and a parameter score database for each of the top parameters in any group may be generated. Referring to FIG. 16, a score data base 1600 derived from the score slopes for the lipid profile sub-group in accordance with embodiments of the present technique are provided. The set of data i.e., the parameter scores in the database 1600 is derived from the score slope plots of LDL 1510, HDL 1550, and TGL 1530 respectively. Thus, FIG. 16 shows the parameter score database 1600 for LDL 1610, HDL 1612, and TGL 1614. In the parameter score database 1600 each TR has a corresponding parameter score. For example, for LDL TR 152 (indicated by a red colored circle) the corresponding parameter score is 5.1, for HDL TR 53 (indicated by a red colored circle) the corresponding parameter score is 8.5, and for TGLTR 174 the corresponding parameter score is 6.1. To compute the lipid profile sub-group score the first step is to select the parameter scores for top parameters in the lipid sub-group corresponding to the TR from the parameter score database 1600. Once the parameter scores for the top parameters in the sub-group are determined, the sub-group score for the given sub-group is calculated using the parameter scores database 1600 shown in FIG. 16, a parameter effect database 1800 shown in FIG. 18, and an age effect database 2000 shown in FIG. 20.

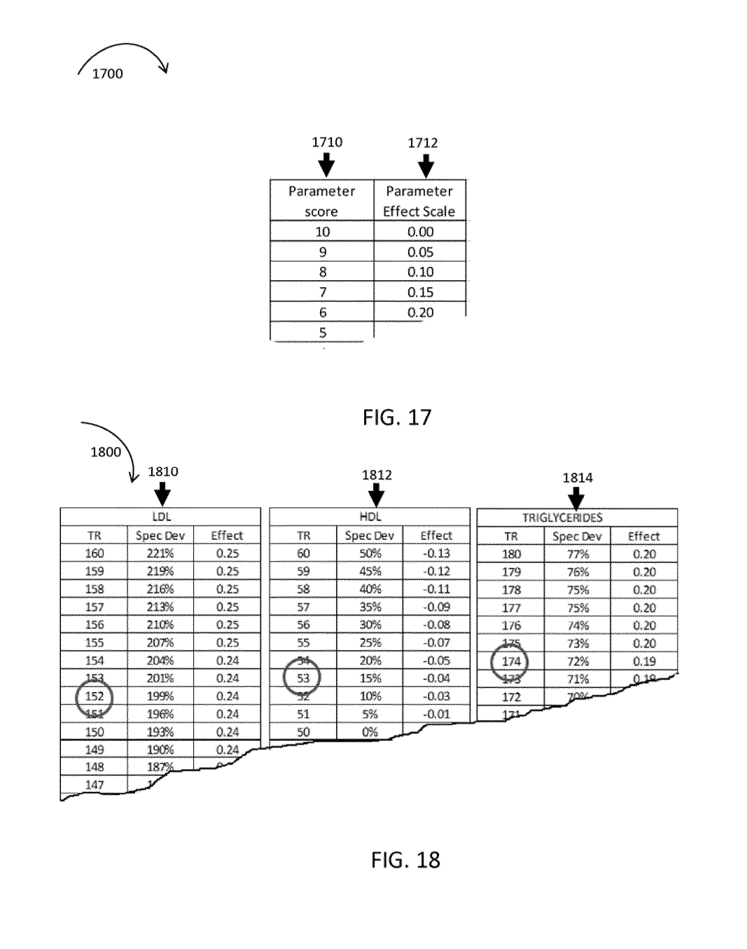

Referring to FIG. 17, a relative parameter effects scale 1700 in accordance with embodiments of the present technique is provided. The parameter effects scale 1712 is an arbitrary scale chosen via a simple logic based on the parameter score. The range of the parameter effects scale has been arbitrarily chosen to be in a range of 0 to 0.5. This range corresponds to parameter scores from 10 to 0 respectively 1710. Accordingly for a parameter score of 10 the parameter effect scale 1712 shows a value of 0.0 and for a parameter score of 0 the effect scale shows a value of 0.5.

Referring to FIG. 18, a parameter effects database 1800 in accordance with embodiments of the present technique is provided. In an example, as mentioned before, with reference to FIG. 16 LDL TR 152 for an individual provided the relatively lowest parameter score 5.1, TGL TR 174 provided the second relatively lowest parameter score 6.1 and HDL TR of 53 had the relatively highest parameter score 8.5. So first the effect of TGL (Effect 1) on LDL i.e., 0.19 is considered and then the effect of HDL (Effect 2) on the combined effect of LDL and TGL i.e., a negative 0.04 is considered. In this instance since HDL TR falling in a range of 50 mg/dL to 80 mg/dL has a positive effect on the human physiology the parameter effect values for HDL in this range will include a negative sign. When this negative value is used in the Formula III (described below) it provides a positive effect on the sub-group score. The parameter effect values for HDL are provided in FIG. 18. This shows certain parameter effect values in the negative range (these correspond to HDL TR falling in a range of 50 mg/dL to 80 mg/dL) and rest in the positive. Thus as explained before, with reference to FIG. 14 and FIG. 15, one skilled in the art will appreciate that certain parameters may require a similar treatment as HDL depending on their effect on human physiology.

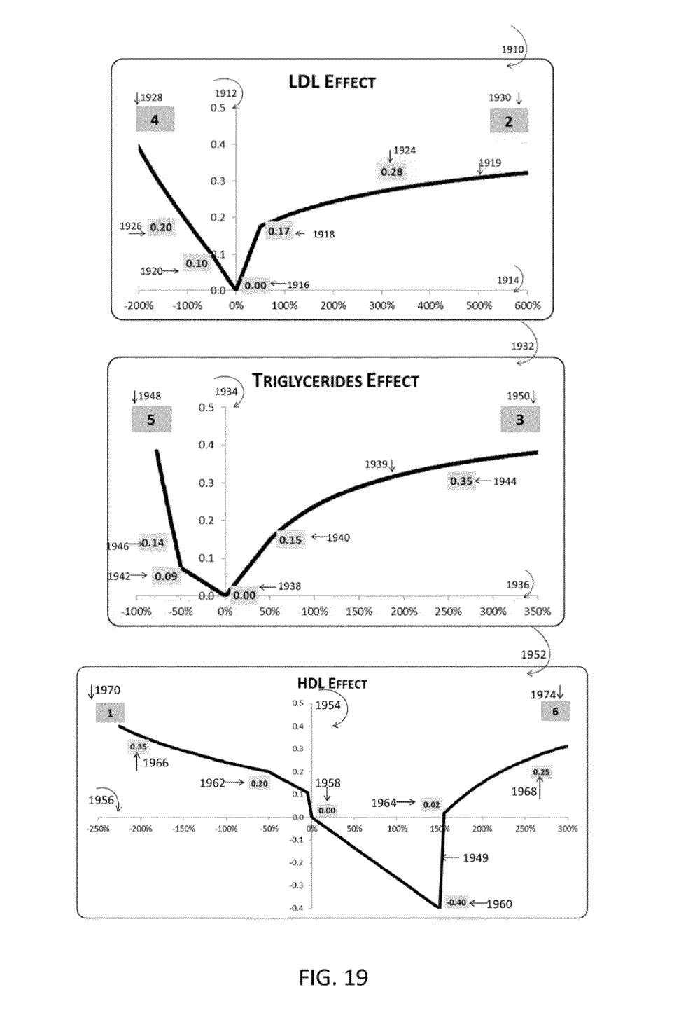

Referring to FIG. 19, the values shown in the parameter effects database 1800 shown in FIG. 18 are plotted as independent parameter effects 1900 in accordance with embodiments of the present technique. The graph 1910 provides the effect slopes for LDL effect, graph 1932 provides the effect slopes for TGL effect, and the graph 1952 provides the effect slopes for HDL effect. For example, LDL effect graph 1910 the parameter effect value is plotted on the Y-axis 1912 and the SPD percent is plotted on the X-axis 1914. The X-axis includes the positive and negative SPD percent values. The effect slope 1919 is drawn using the LDL Mean 1916, LDL BH 1918, LDL BL 1920, LDL XL 1926, and LDL XH 1924 values. The parameters ranks for low LDL 1928 and high LDL 1930 are also shown in the graph.

In a second example, for TGL effect graph 1932 the effect value is plotted on the Y-axis 1934 and the SPD percent is plotted on the X-axis 1936. The X-axis includes the positive and negative SPD percent values. The effect slope 1939 is drawn using the TGL mean 1938, TGL BL 1942, TGL BH 1940, TGL XL 1946, and TGL XH 1944. The parameters ranks for low TGL 1948 and high TGL 1950 are also shown in the graph. In another example, for HDL parameter effect graph 1952 the effect value is plotted on the Y-axis 1954 and the SPD percent is plotted on the X-axis 1956. The X-axis includes the positive and negative SPD percent values. The effect slope 1949 is drawn using the HDL mean 1958, HDL BH 1964, HDL BL 1962, effect value corresponding to TR 80 1960 that has a parameter effect of −0.4 and HDL XL 1966 and HDL XH 1968. Using the effect slope 1910, 1932, and 1952 the sub-group score for any lipid profile test result may be calculated. The X-axis may be also plotted using TR for all the three graphs.

In one embodiment, age of the individual may also have an effect on the score of an individual. Age has a significant role to play in the scoring process. According to medical practitioners, lesser the age greater is the effect value assigned to it because the person may carry the health risks for a longer period of time. Thus the weight ages in Table 2010 in FIG. 20 with respect to the age are provided by the medical practitioner based on their knowledge and experience. The age effect slope is generated from the age effect database. The age effect may differ from parameter to parameter, sub-group to sub-group, group to group and super group to super group. However, in certain instances, there may be no effect of age. Referring to FIG. 20, a lipid profile age effect database and lipid profile age effect slope 2000 in accordance with embodiments of the present technique is provided. In the example shown in FIG. 20, the graph 2012 (with age effect score on the Y-axis 2014 and age on the X-axis 2016) is plotted using the data in Table 2010. Example shown in FIG. 20 provides the effect of age on the sub-group lipid profile for an individual. According to medical practitioners the effects have a discontinuous variation with age. For ages under 20 years the effect is 0.6 and from age in a range of 20 to 60 years the effect changes linearly from 0.6 2018 to 1.0 2020. Beyond 60 years the effect remains the same at 1.0 2022. Thus as shown in Table 2010 for a 51 year old person (encircled in red) it is observed that the age effect multiplier is 0.93.

The sub-group score is calculated using a Formula III:

Sub-group score=(Minimum Parameter Score−(Effect 1+Effect 2))*(Age Effect)

In the example of the lipid profile data shown in FIG. 21, LDL with a TR of 152 has a parameter score of 5.1, HDL with a TR of 53 has a parameter score of 8.5, and TGL with a TR of 174 has a parameter score of 6.1. In this particular instance LDL shows the minimum parameter score 5.1, followed by TGL with a parameter score of 6.1 and then HDL with a parameter score of 8.5. Thus in this instance sub-group score is calculated beginning with the minimum parameter score of LDL (minimum parameter score) and the corresponding effect of HDL (Effect 1, −0.04) shown in FIG. 18 and effect of TGL (Effect 2, 0.19) shown in FIG. 18 and the age effect (0.93) of the individual shown in FIG. 20 using Formula III:

Sub-group LDL score=(5.1−(−0.04+0.19))*(0.93)=4.7

Thus the sub-group score of 4.7 in this instance is a single score that gives medical practitioners/individuals a direct understanding of the lipid profile status of an individual without always having to look into the detailed TR of each parameter in the lipid sub-group.

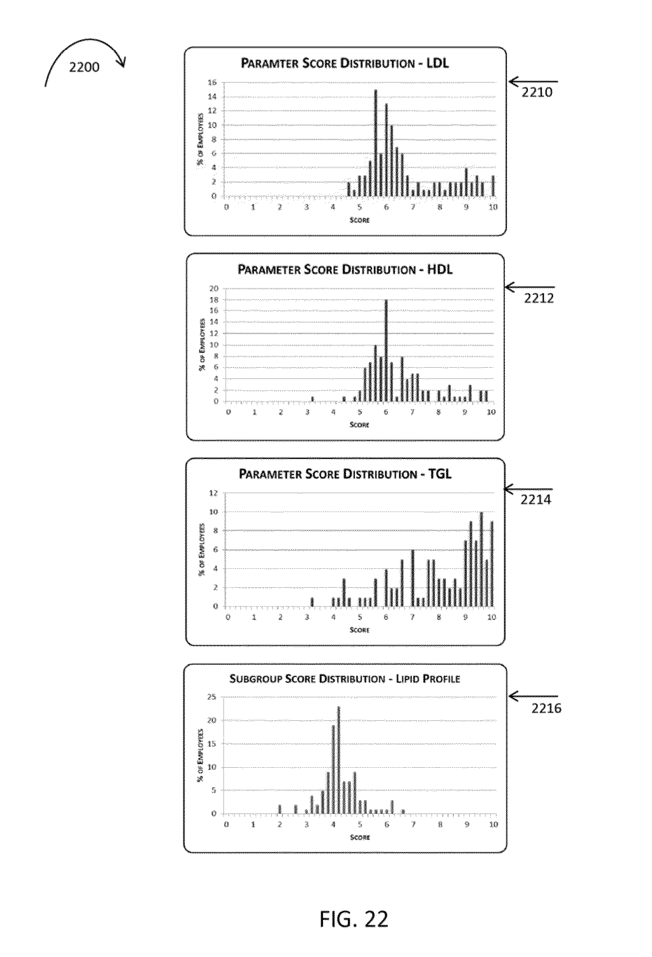

In various embodiments, the quantitative scoring process employed in the system and method of the instant disclosure may be repeated for a larger population of individuals, say for example, for all individuals in a company. Referring to FIG. 22, score distribution plots 2200 for a larger population of individuals in accordance with embodiments of the present technique are provided. The distribution of scores obtained from these plots enables one to get a fair idea of the lipid profile health of a population of individuals, in this case, employees in the company at one glance FIG. 22 includes an LDL score distribution plot 2210, an HDL score distribution plot 2212, a TGL score distribution plot 2214, and a sub-group score distribution plot (lipid profile) 2216. Similar plots can provide a fair idea of the sub-group scores of individuals when it comes to any parameter TR. For sub-groups belonging to a group a similar exercise can be carried out to obtain the Group Scores.

Once all the sub-group scores are calculated, the total group score may be calculated. The sub-groups considered for group blood, their ranking and respective weight ages are included in Table 7. The group scoring i.e., group score for group blood is included in Table 8.

As explained with respect to the parameters of sub-group lipid profile, based on a panel of experienced medical practitioner's views, the sub-groups for group blood are ranked based on the effects of these sub-groups on the human physiology. In other words, medical practitioners based on their knowledge and experience consider that the effect of glucose is more important than any of the other sub-groups for group blood. Hence sub-group glucose was ranked 1 and was given a weight age of 10. Similarly, lipid profile was ranked 2 and given a weight age of 9 relative to the others in the portfolio. Other sub-groups were treated similarly to obtain the data provided in Table 7.

Ina next step the individual sub-group scores for each individual were multiplied by their respective weight ages as shown in Table 8. This may be called the weighted score. All the weighted scores for each sub-group were then added. In this instance, the total value of the weighted score for this 51 year old male for the group blood is 277.1. This number was then divided by the sum of all the weight ages. In this case that number is 38 as shown in Table 8. This provides a group score for group blood in this example as 7.3 for the individual as shown in Table 8.

This scoring process may have multiple advantages. One advantage is that it may give the healthcare provider/medical practitioner a quick insight into the health of the individual without actually having to pour through various pages of data to get that view. Other advantages include but are not limited to enablement to make comparisons, graphical representations for quick visual deciphering, etc. . . .

As discussed in Table 5 above, in the scoring for super-group CMD, scoring process for group urine includes a qualitative parameters scoring process. Table 9 provides the raw data for the three individuals whose lipid profile data are provided in Table 6.

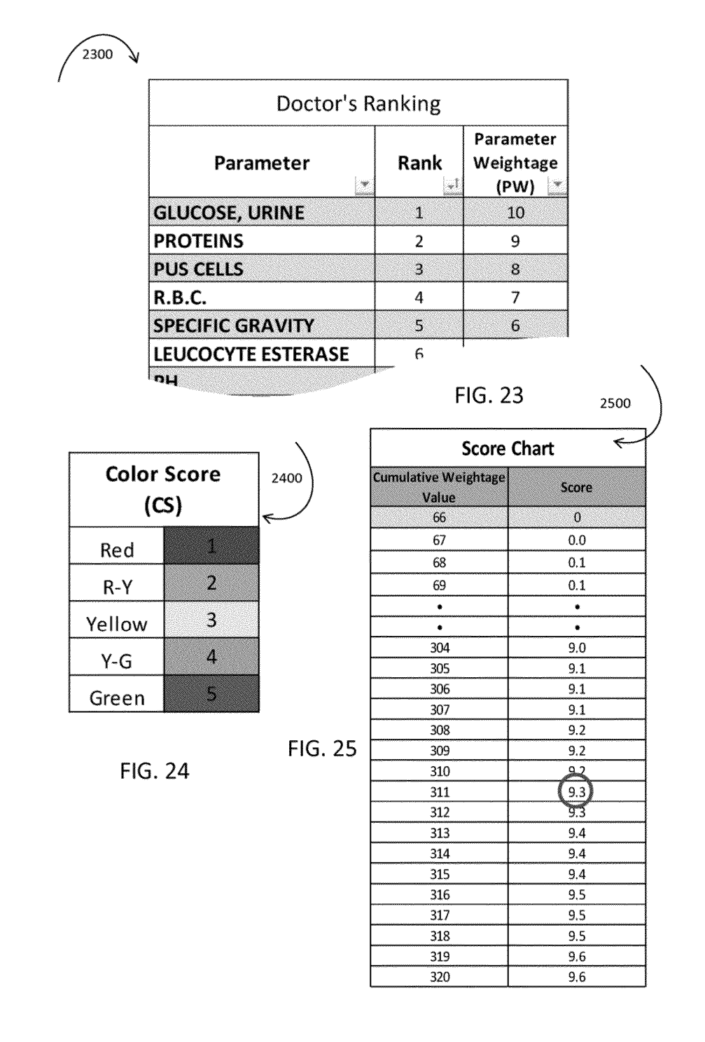

Referring to FIG. 23, rank and parameter weight age for parameters of group urine 2300 in accordance with embodiments of the present technique are provided. The technique employed to score the parameters of group urine and to arrive at the group urine score is similar to that used for the group blood score. Based on the opinion of a panel of knowledgeable and experienced medical practitioners', the relative ranks and parameter weight ages for different urine parameters are provided in FIG. 23. Referring to FIG. 24a color distribution based on parameter weight ages for parameters of a group in accordance with embodiments of the present technique is provided. However, since all the parameters here (in the case of urine) have qualitative results, the final group scoring process to find the group score of urine is slightly different than that of groups that have quantitative results. Each individual parameter in urine is provided a color and hence a score from 1 to 5 for colors i.e., red, reddish-yellow, yellow, yellow-green, and green respectively as shown with reference to FIG. 2400. The scoring process for qualitative parameters similar to those of group urine is divided into 5 colors instead of 3. This scoring process helps to give further granularity and clarity while explaining the results for qualitative test parameters.

Each parameter is accorded a weight age as shown in FIG. 2300. A master reference scale is then created whereby the best and worst possible cumulative weighted values are calculated as shown in Table 10. For example, in case of ketone the calculation may be done as follows.

Worst score=parameter weight age (PW) for Ketone multiplied by value for lowest colorscore (CS) indicated by red color i.e., 2*1=2.

Best score=PW for Ketone multiplied by value for highest CS indicated by green color i.e., 2*5=10

In a similar manner the worst and best scores are calculated for all parameters as shown in Table 10.
The weighted scores may then be added to provide the two ends of the spectrum of possible scores for each individual. In the data provided in Table 10 the sum of products of parameter weight age (PW) and color score (CS) at the two ends of the spectrum i.e., the cumulative weighted value are 66 and 330 with a respective score of 0 and 10.

In the next step to determine the group score for urine value of 66 is attributed a score of 0 and value of 330 is attributed a score of 10. Therefore, if an individual, based on his/her test results gets a cumulated weighted value of 66 or 330, he or she will get a group urine score of 0 or 10 respectively. Referring to FIG. 25, a group score chart 2500 including the result of multiplication of the parameter weight age given in FIG. 23 and the color weight age given in FIG. 24 and corresponding group scores for group urine in accordance with embodiments of the present technique is provided. Therefore, in the example shown in FIG. 25, the individual has cumulative weighted value of 310 for urine and the corresponding group urine score of 9.2.

Thus the system disclosed herein uses ranks and weight ages provided by experienced medical practitioners for different parameters to generate a score. The worst and best case scenarios for all parameters are determined and a score chart is prepared. As described herein above a graph may be used to prepare the score chart for qualitative data once the worst and best case scenarios are determined. However in case of data processed using a quantitative process a graph/database may be used to prepare the score chart, as demonstrated for example in relation to group blood.

As known to one skilled in the art, groups like ECG, Carotid Doppler etc. . . . contain parameters that are measured in both qualitative and quantitative terms. These groups may therefore be evaluated and scored using a mixed scoring process. The mixed scoring process essentially contains the elements of both quantitative and qualitative scoring processes. Based on medical knowledge and experience of a panel of medical practitioners weight ages are assigned to the qualitative and quantitative processes. The final score of these groups is then derived by a simple weighted average process as described in case of the urine group with reference to FIG. 25.

Accordingly a super group score for a super group CMD containing a number of groups like physicals, blood, urine, ECG, ECHO, etc. . . . , which in turn contain sub-groups and/or parameters may be calculated by the method as shown for the calculation of the group score for group blood. The groups physicals, blood, urine, ECG, ECHO, etc. . . . have also been associated with ranks and weight ages relative to each other and a super-group scoring for CMD is provided in Table 11. Thus all super-groups may be scored using the system and the method described herein.

As discussed herein above the first data set may include data obtained using PHQ as one part of the data set. The super group PHQ may include groups like LSH, FH, EH, MH&S, FMH, and KMC. The data collected in this manner may be scored using a qualitative parameter scoring process as shown in Table 12 for LSH.

As seen in the example provided in Table 12, a questionnaire for LSH may require the individual to answer questions on the individual's LSH including smoking, drinking, and pain in any part of the body. The scoring process for LSH is also similar to the scoring process used to score qualitative data, as discussed for group urine previously. Based on medical knowledge and experience of a panel of medical practitioners weight ages and ranks are assigned to the parameters while following a qualitative scoring processes. The ranking and weight age are included in Table 13.

In Table 13 the parameters of the super group LSH as suggested by the medical practitioners have a weight age from about 10 to 1. The weight age value for individual parameters may be multiplied by a color score from 1 to 5 as shown with reference to FIG. 2400 for qualitative grading of urine, i.e., red (1), reddish yellow (2), yellow (3), yellowish green (4), and green (5) to obtain the worst and best results respectively. Thus the scoring process used for LSH is similar to the scoring process used to score qualitative data, as done in the case of group urine. Table 14 includes a score scale for LSH prepared following a similar process as used for preparing the score scale in Table 10 for group urine.

This process may be repeated for any number of individuals as discussed hereinbefore.

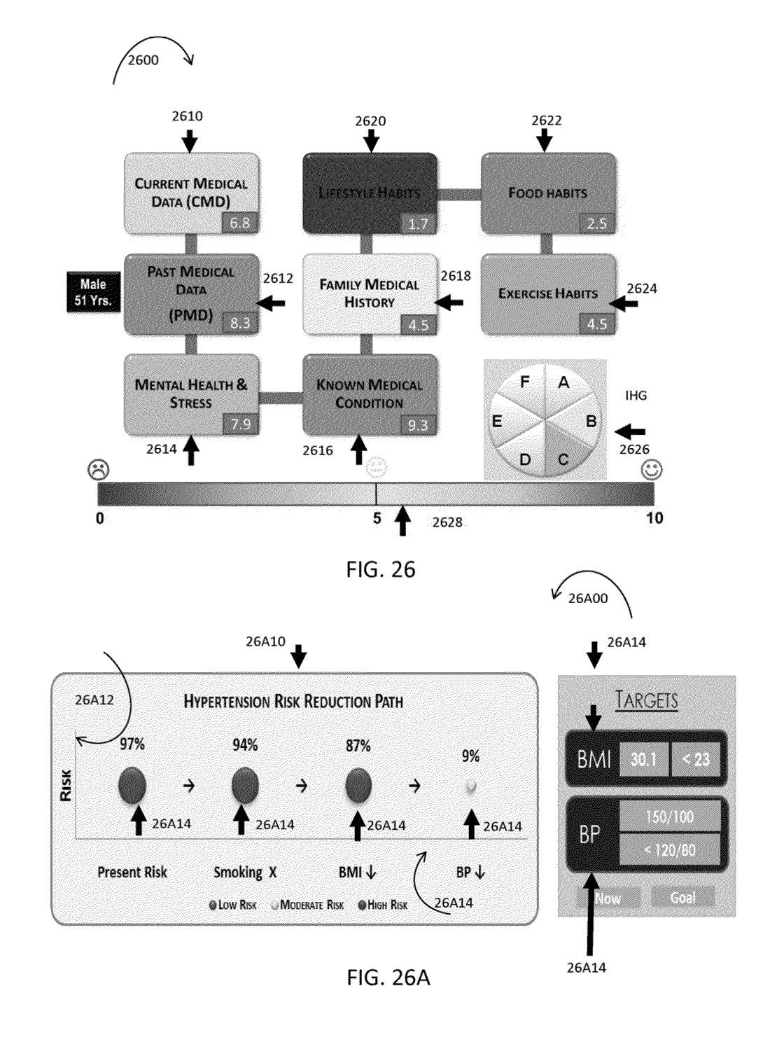

In one embodiment, an individual Health Grade (IHG) may be arrived at based on a single parameter state or combination of parameter states of an individual as explained with reference to Table 4 above. In another embodiment, an IHG may be arrived at based on parameter, sub-group, group, or super-group scores. In yet another embodiment, the IHG may be determined using a combination of the parameter states of an individual and the parameter, sub-group, group, or super-group scores. When an individual is employed with an organization the individual is referred to as an employee. Accordingly the IHG may then be referred to as the Employee Health Grade (EHG). Referring to FIG. 26, a flow chart 2600 showing the super groups, in accordance with the embodiments of the present technique is provided. This example is for one of the individuals among the three individuals whose scores have been discussed herein to understand the various embodiments of the system and method of the instant disclosure. The flow chart is also color coded based on the scores arrived at for each super group. The color coding is done based on the 0 to 10 colored scale 2628 as explained hereinbefore with respect to the colored scale 926, in FIG. 9. FIG. 26 includes in addition to CMD 2610 and PMD 2612 information obtained on MH&S 2614, LSH 2620, FMS 2618, KMC 2616, FH 2622, and EH 2624. As shown in the example demonstrated in FIG. 26 the individual was provided an IHG of E 2626. In addition to the scores arrived at for each super group certain other factors are considered while arriving at the IHG. These factors, corresponding IHG, and recommended actions are provided in Table 15.

TABLE 15

| Category | Cause | IHG | Actions |
|---|---|---|---|
| Deranged | Emergent (Beyond | F | Hospital/Clinic |
| Parameters 3 | Threshold) | | |
| KMC2 + DP2 | Compounding Effect | E | Doctor/Specialist |
| | | | Referral/Additional |
| | | | tests |
| Deranged | Beyond Threshold in | D | Doctor/Specialist |
| Parameters 2 | CMD | | Referral/Additional |
| | | | tests |
| Known Medical | Top Parameters in Red | C | Recommendation |
| Conditions 2 | | | |
| Known Medical | Non-Top Parameters in | B | Recommendation |
| Conditions 1 | Red | | |
| Deranged | Parameters in Red | | Recommendation |
| Parameters 1 | | | |
| Personal Risk | Parameters in Red | | Counselor |
| Factors | | | Recommended |
| Family Medical | Parameters in Red | | Recommendation |
| History | | | |
| All Parameters/ | All Parameters within | A | Recommendation |
| PHQ | either Green or Yellow | | |

A: If a subject shows all parameters in either green or yellow as per the coloring scheme discussed earlier—then the individual may be assigned an IHG of A and may be considered to have the best possible health status.

B: If an individual shows all parameters in green and yellow, except for the following: i.e., individual may have a family history of medical problems, individual carries any of the personal risk factors that encompass lifestyle habits (like smoking, drinking, etc.), food habits, and exercise habits; individual has any one or more of top parameters (as explained hereinbefore) in red (out of normal parameter range, but less than threshold values)—this condition has been defined as DP1 in Table 4; or individual may have indicated having one or more of disease states that are not considered life threatening in general—like allergies, asthma, etc. i.e., Known Medical Condition 1 (KMC 1), then the individual may be assigned an IHG of B. Currently the system and method of the present disclosure have identified about 36 top parameters as explained hereinbefore, but one skilled in the art will appreciate that this number may increase or decrease based on developments in the medical field. The IHGs C to E may be defined in a similar manner as shown in Table 15 in above. Further, IHG F is attributed to an individual having any one or more of the top parameters in an emergency state i.e., in DP3 condition as defined in Table 4, the individual needs immediate attention or the individual's life is in danger.

In a further embodiment, each IHG i.e., A, B, C, D, E, and F may have various levels of risks i.e., stratifications within the IHG depending on the severity of the risks. Various permutations and combinations of the risks may be used to determine the risk level that an individual carries. For example, IHG B has three risk levels 1, 2, 3. Risk level 1 within IHGB is when any one of the risks related to FMH, or Personal Risk Factors (PRF; including LSH, FH, EH, etc. . . . ) or Known Medical Conditions (KMC1) for non-life threatening parameters exists for an individual, i.e., IHG for an individual with risk level 1 is B1. Risk level 2 within MG B is when any two of these risks related to FMH, PRF, or KMC1 exist for an individual. There are various combinations that are enumerated in the Table 16 that will lead to a risk level 3 within IHG B. Similarly, for IHG C, D, and E there are various risk levels that exist as shown in Table 16. These levels are ascertained by trained individuals (medical practitioners, physicians, specialists, etc. . . . who have significant evidence based knowledge to make such risk level determinations and assertions.

In another embodiment, a health assessment, prediction, and management method is provided. The health assessment, prediction, and management method includes a first step of providing a first mechanism capable of acquiring and capturing a data set comprising an individual's health status. In a second step the method provides a local computer server wherein a first platform is provided for the first mechanism to input the data set. In a third step the method provides a central server in communication with the local computer wherein a second platform is provided for the transmittal of the data set from the local computer server to the central server. In a fourth step the method provides a second mechanism capable of accessing the data set in the central server and analysing the data set acquired by the first mechanism; wherein the second mechanism is capable of providing an analytical result. The analytical result may include a health score/grade/index generated with associated reasons provided by the second mechanism and a health risk assessment provided by the second mechanism. In a fifth step the method provides a third platform in the central server for the second mechanism to input the data set and the health score/grade/index. An expert system is created in the central server based on the data set and the health score/grade/index.

In yet another embodiment, a health assessment, prediction and management system is provided. The system includes a first mechanism capable of acquiring and capturing a first data set comprising an individual's health status. The system further includes a local computer server, wherein a first platform is provided for the first mechanism to input the first data set. The system also includes a central server in communication with the local computer wherein a second platform is provided for the transmittal of the first data set from the local computer server to the central server. The system includes a second mechanism capable of accessing the first data set in the central server and analysing the first data set acquired by the first mechanism. The second mechanism is capable of providing an analytical result. The analytical result may include a health score/grade/index generated with associated reasons provided by the second mechanism and a health risk assessment provided by the second mechanism. A third platform is provided in the central server for the second mechanism to input the first data set and the health score/grade/index. An expert system is created in the central server based on the first data set and the health score/grade/index. The expert system is further capable of discovery i.e., interpolating and extrapolating, and also capable of correlating the health score/grade/index to a second data set acquired by the first mechanism for the same, different, or related individuals in the absence of a second mechanism and generating a health score/grade/index for the second data set. The expert system is capable of identifying even infinitesimal changes in the second data set and providing a health score/grade/index associated even with the infinitesimal changes.

In still yet another embodiment, a health assessment, prediction, and management method is provided. The health assessment, prediction, and management method includes a first step of providing a first mechanism capable of acquiring and capturing a first data set comprising an individual's health status. In a second step the method provides a local computer server wherein a first platform is provided for the first mechanism to input the first data set. In a third step the method provides a central server in communication with the local computer wherein a second platform is provided for the transmittal of the first data set from the local computer server to the central server. In a fourth step the method provides a second mechanism capable of accessing the first data set in the central server and analysing the first data set acquired by the first mechanism; wherein the second mechanism is capable of providing an analytical result. The analytical result may include a health score/grade/index generated by the second mechanism and a health risk assessment provided by the second mechanism. In a fifth step the method provides a third platform in the central server for the second mechanism to input the first data set and the health score/grade/index. An expert system is created in the central server based on the first data set and the health score/grade/index. The expert system is capable of interpolating, extrapolating, and correlating the health score/grade/index to a second data set acquired by the first mechanism for the same, different, or related individuals in the absence of a second mechanism. The expert system is then capable of generating a health score/grade/index for the second data set. The expert system is capable of identifying infinitesimal changes in the second data set and providing a health score/grade/index associated with the infinitesimal changes.

The expert system is capable of predicting a state of health of an individual if no interventions (medical or general) are needed to made by a medical practitioner i.e., in the absence of any outlying cases. The expert system discussed herein may be a self-learning dynamic system that feeds on the repository of information captured, analysed, and stored in the expert system. With the increasing number of inputs in terms of data sets, health scores and IHG with associated reasons, recommendations, risk mitigation plans and health management plans, the expert system may be capable of mimicking or helping or identifying conflicts in a physician's decision making process. Eventually the expert system will be capable of being a self-sufficient health score/grade/index generator, recommendations generator, and may also provide the associated reasons. The expert system may thus be employed to aid the medical practitioners in taking quicker, consistent, and well informed decisions on a state of health of an individual. Eventually the expert system will be capable of freeing up a medical practitioner's valuable time with respect to analysing data and providing health score/grade/index. The expert system may allow the medical practitioner more time to focus on the level of intervention and treatment needed for an individual rather than on the analyses process. It is also important to note that even in the presence of outlying cases, because the system is constantly learning the expert system updates itself once a medical practitioner provides inputs for these outlying cases. The expert system picks up the right recommendations from the recommendation bank, decides on what action need to be taken for the individual, and decides Do's and Don'ts for diet of the individual along with diet plans picked form a nutrition bank (provided by a nutritionist). One skilled in the art will appreciate that various specialists can thus help in forming various recommendation banks for various health specialties like physiotherapy, MH&S counseling, etc. . . . The recommendations also include which medical practitioner/specialist needs to be consulted for respective health related risks. In addition the expert system can determine the health risk, the individual is carrying and small discrete steps the individual needs to take to alleviate those risks.

In one embodiment, the present technique provides a risk reduction path that can guide an individual to make a stepwise plan on reducing/eliminating/alleviating present health risks. For example, 4 year (4Y) hypertension is a medical state where an individual's systolic/diastolic blood pressure is greater than or equal to 140/90 millimeter of mercury. As known to one skilled in the art it is a factor to many diseases. In one embodiment, a promising risk score may be predicted using Framingham model. In this example, the parameter score indicates the chances of the individual developing hypertension in the next 4 years. A risk smaller than 5 percent is considered to be low risk, risk between 5 and 10 percent is considered to be medium risk and risk greater than 10 percent is considered to be high risk. The potential risks of hypertension include Stroke, impaired vision, stiff arteries, and kidney failure. Further, it is known in the art that factors like age, sex, BMI further add to the potential risks of high BP. For example females have higher chances of developing hypertensions than males under the same circumstances; smoking increases BP and heart rate; and high BMI is directly proportional to hypertension. An individual can walk the risk reduction path by say quitting smoking if the individual is a smoker or plan diet and exercise towards reducing the BMI. Thus the risk reduction path provided an individual with an idea of the parameters that the individual can control and the others which the individual can certainly work to improve upon.

Accordingly, referring to FIG. 26A, is provided a schematic representation Risk Reduction Path Tool 26A00 in accordance with the embodiments of the present technique. The risk reduction path tool 26A00 may include a graph 26A10. The graph 26A10 shows risk percentage on the Y-axis 26A12 and present risk and the different factors that aid enhance or abate the risk on the X-axis 26A14. For example in this figure, smoking, BMI and BP (the risk factors for 4-yr. hypertension) are shown. In this example the individual has a 97 percent present risk 26A16 of being hypertensive within a period of 4 years if the individual does not control any of the risk factors i.e., smoking 26A16, BMI 26A18, and BP 26A20. However, if the individual quits smoking 26A16, that risk may come down to 94 percent. Similarly, if the individual reduces their BMI 26A18, the present risk may come down to 87 percent, and by reducing BP 26A20 the present risk may come down to 9 percent. The risk reduction path 26A00 may include a targets window 26A22 that provides the individual with exact goals for the risk reduction path. In this example the BMI needs to reduce from a value of 30.1 to a value of less than 23, and the BP needs to reduce from a value of 150/100 to 120/80. Along with this if the individual quits smoking the individual's present risk 26A16 may reduce to 9 percent form 97 percent. Thus embodiments of the present technique provide a risk mitigation path for any disease state.

Further, as we progress into the future, the expert system may also be able to indicate/prompt/suggest the recommendations and the necessary interventions needed for the individual. In fact the expert system may make sure that the medical practitioner does not miss any issue/aspect in the matter of an individual's health. Also the recommendation and the actions may become uniform and may not be subject to change with change in the medical practitioner, with the change in locations, etc. . . . The expert system may similarly be equipped to provide the same level of interventions/suggestions and the same level of details as provided by medical practitioners including specialist physicians, nutritionist, MH&S counselor, and physiotherapist. This information resource could be extended to specialist physicians, nutritionist, MH&S counselor, and physiotherapist who may need similar information. The most important unique selling proposition (USP) for this expert system is that it makes no allowance for mistakes, provides uniformity in recommendations and actions and it enables much quicker turnaround enabling the user of this system (doctors, specialists, etc. . . . ) to see many more patients in the same amount of time. The expert system is also capable of detecting small charges and variations or precursors to a health risk that may be missed even by a trained professional.

In one embodiment, the system and method disclosed herein provides a dashboard i.e., an Individual Personal Dashboard (IPD) to view the individual's data. The IPD is provided a tan individual level that will enable the individual to assess or note the individual's health risk. When an individual is employed with an organization the individual is referred to as an employee. Accordingly the IPD may then be referred to as the Employee Personal Dashboard (EPD). This will enable the individuals to view their priorities, recommendations of doctors' and experts', and encourage/motivate them to take action from a point of view of improving their health status. Various elements displayed on the dashboards are color coded. The color coding provides a quick visual insight into the health status. The color code spans a wide band of colors as explained hereinbefore and also reflects the infinitesimal changes in the health data. The IPD may also equip the employees with a predictive tool that may allow the individual to understand the steps they need to undertake towards while edging towards a healthy life.

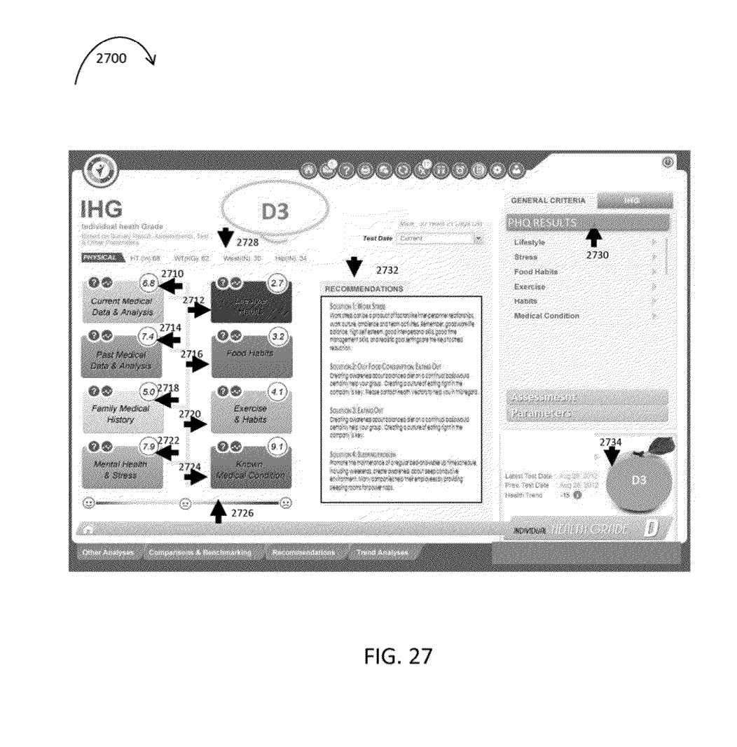

Referring to FIG. 27, an Individual Personal Dashboard 2700 (IPD) in accordance with an embodiment of the present technique is provided. The individual may use any convenient means to access the dashboard 2700. The convenient means may include a computer, a tablet PC, a mobile phone, etc. . . . The individual is provided access to the individual's health data using the IPD 2700. The super groups (as shown in FIG. 10) CMD 2710, PMD 2714, FMH 2718, MHS 2722, LHS 2712, FH 2716, EH 2720, and KMC 2724 may also be color coded. The color coding is based on the super group scores calculated for the respective super groups and the colored scale 2726 as described in previous embodiments. So in addition to looking at a particular numerical score the individual may get a quick visual insight of individual health status by just viewing the color of the data. Some important physical data 2728 may also be displayed as shown in the IPD 2700. The IPD 2700 also provides an individual with a quick access of the PHQ 2730 and also the recommendations 2732 provided to the individual. The individual may also be made aware of the IHG 2734 that may be determined using the scores and/or the parameters states (Table 4) when the individual views the IPD 2700. Each super group shown in the FIG. 2700 is a link to the details of the parameters, sub-groups, and groups and their respective health scores as discussed in detail hereinabove. The PHQ results 2730, risk assessments, parameters have cascading windows to allow the individual to view the details of how these results were arrived at.

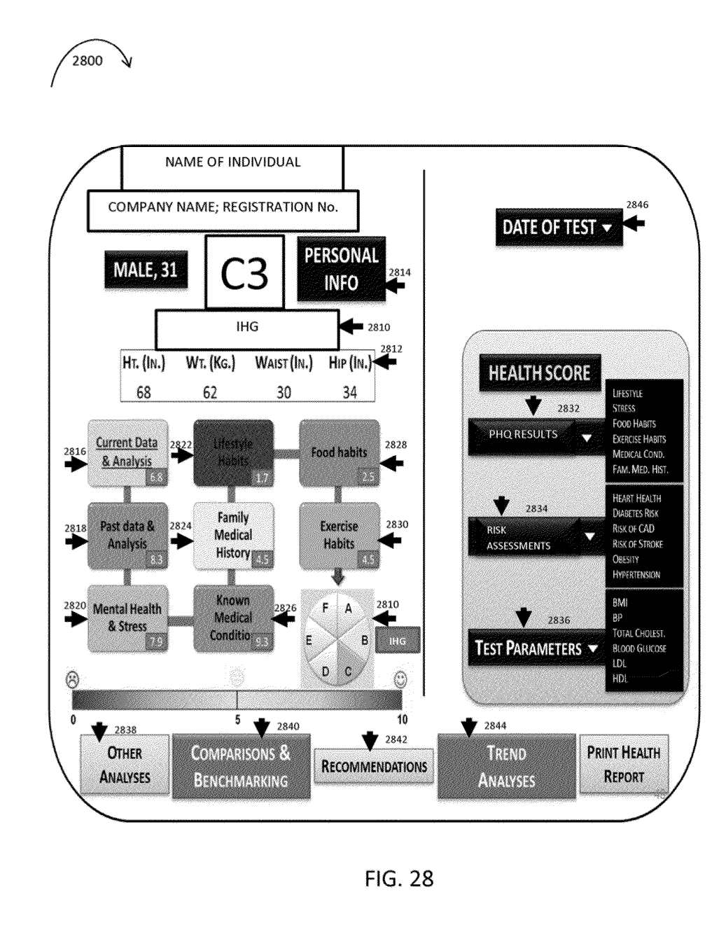

One skilled in the art will appreciate that the information provided in the IPD may be represented in various ways. Referring to FIG. 28, is provided another form of representing an Individual Personal Dashboard 2800 (IPD) in accordance with an embodiment of the present technique. The IPD 2800 includes IHG 2810, personal information 2814, date of test 2846, physical data 2812, super group information CMD 2816, PMD 2818, MH&S 2820, LSH 2822, FMH 2824, KMC 2826, FH 2828, and EH 2830. The IPD also includes PHQ 2832, risk assessments 2834, test parameters 2836, other analysis 2838, comparisons & benchmarking 2840, recommendations 2842, and trend analyses 2844. These data are made available to the individual using the IPD 2800.

The date of test 2846 is an important piece of information for an individual viewing the IHD 2800 provided by the system and method disclosed herein. It gives the individual an understanding of change in his/her health status over a period of time over different dates when the individual has undergone medical health check-ups. At different dates the individual may have the same IHG but the parameter scores, sub-group scores, group scores, and super group scores could change. Also there could be improvements with time within the same IHG like C3 going to C2 and then to CI. The individual can also view the trend analysis 2844 which will give the individual details of change in health status between two or more health check-ups.

The risk assessment panel 2834 is provided to enable the individual to look up various health risks that the individual is or may be facing. The individual can then correlate these risks with the recommendations provided by a doctor, nutritionist, etc. . . . which the individual can view in the recommendations 2842 provided by the IHD. The PHQ results 2832 and the test parameters 2836 are other links that the individual can access to view the details and understand the individual's health status. One skilled in the art will appreciate that the drop down panels as provided for PHQ results 2832, risk assessments 2834, and test parameters 2836 may also be used to provide additional links for relevant data. Additionally these drop down panels may themselves be populated with other relevant information links to enable an individual to better understand the individual's health status.

In one embodiment, the system and method disclosed herein provide a Health Assessment Tool (HAT). This is a tool provided to an ecosystem that includes an employee, an employer, and a medical practitioner. Accordingly access to different information presented by using the tool is provided to different members of the ecosystem subject to the sign up credentials incorporated into and hence permitted by the tool. In yet another embodiment is provided a health assessment, prediction and management system. The system includes a second mechanism, wherein the second mechanism provides a health risk assessment to an individual. The system also includes a first set of tools provided to an individual to act on the health risks assessed for the individual. The first set of tools consists of a Risk Control Tool, Health Assessment Tool, Health Risk Assessment Tool, and a Risk Reduction Path Tool. The system further includes a second set of tools provided to an organization housing a population of individuals to act on the health risks assessed for the population of individuals. The second set of tools consists of a Risk Mitigation Tool, Return on Investment Tool, Heat Map Tool, and Insurance Premium Negotiation Tool.

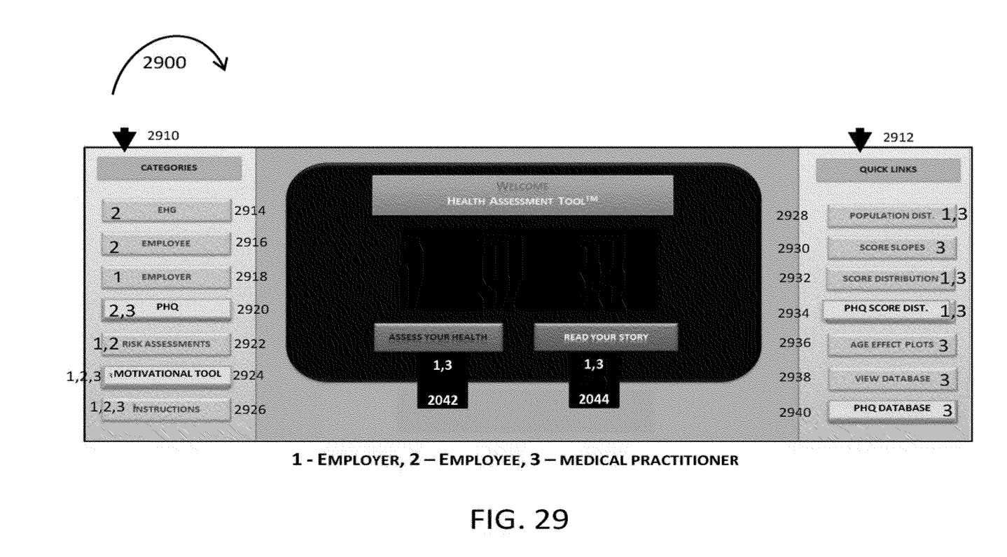

Referring to FIG. 29, is provided a HAT 2900 in accordance with embodiments of the present technique. More particularly HAT 2900 provides (1.) the organization (i.e., the employer), (2.) an individual employed in an organization (i.e., an employee) and (3.) a medical practitioner a tool to gain an insight into (i) the employee's health status and/or (ii) health status of all employees in the organization. However it is to be noted that every information in the tool is protected and allowed to be viewed only by permitted persons as described hereinbelow in detail with reference to FIG. 29. The tool 2900 includes 2 main sets of links i.e., categories 2910 and quick links 2912. The categories 2910 section includes links like EHG 2914, Employee 2916, Employer 2918, PHQ 2920, risk assessments 2922, motivational tool 2924 and instructions 2926 respectively. The quick link section 2912 includes links like population distribution 2928, score slopes 2930 (as shown in FIG. 15), clinical score distribution 2932, PHQ score distribution 2934, age effect plots 2936, view database 2938, and PHQ database 2940. The FIG. 29 also indicates with numerals 1, 2, and 3 representing employer, employee, and medical practitioner respectively, as to who has the permission to view which link. The employer can view links employer 2918, risk assessments 2922, motivational tool 2924, read instructions 2926, population distribution 2928, clinical score distribution 2932, and PHQ score distribution 2934. This shows that the employer can only get information at a holistic level that gives the employer an understanding of the health status of the entire population of employees that are employed with that employer. At no time the employer can view the details of the employees as provided by an EPD for an employee except with the explicit prior permission from the employee. The system and method disclosed herein also includes certain checks even in viewing this data based on the total number of employees the employer is viewing either in the drill down option or the total population of the employees. If the employer is viewing information on a population of employees say for example less than or equal to 5 in number then the system may not allow the employer to view even the data for this population unless the employer has permission from the employee/s to that effect. The system and method disclosed herein incorporates this check to maintain secrecy on the identity of the employee. One skilled in the art will appreciate this check because it is easier to assume and predict which employee may have what issues when a lesser number of employees are present in the population being monitored. The employee can view links employee 2916, EHG 2914, PHQ 2920, risk assessments 2922, motivational tool 2924, and read instructions 2926. As is evident the employee is capable of viewing only those links that show the employee's personal information on the status of the employee's health. A medical practitioner can view links PHQ 2920, motivational tool 2924, instructions 2926, population distribution 2928, score slopes 2930, clinical score distribution 2932, age effect plots 2936, view the clinical database 2938, and the PHQ data base 2940. The FIG. 29 also shows links assess your health 2942 and read your story 2944 that are both viewable by the employer and the medical practitioner. The IPD is included in the HAT in the form of the links that an employee is able to view. Although the same button is pressed (1,2), (2,3), (1,3), depending on the username and password credentials different information is viewed by different entities in the ecosystem.

The HAT tool provided by the system and method allows the employer a holistic view, the employee (limited access to employee's TR and scores) and the medical practitioner access to data of all employees if there is a need to look at the health data in detail. Table 17 included below indicates what kind of data is viewable by which member of the ecosystem.

TABLE 17

| MEMBER OF | HOLISTIC | INDIVIDUAL'S | INDIVIDUAL'S |
|---|---|---|---|
| ECOSYSTEM | DATA | IDENTITY | MEDICAL DATA |
| Employer (1) | Y | N | N |
| Employee (2) | Y | Y | Y |
| Medical | Y | N | Y |
| Practitioner (3) | | | |

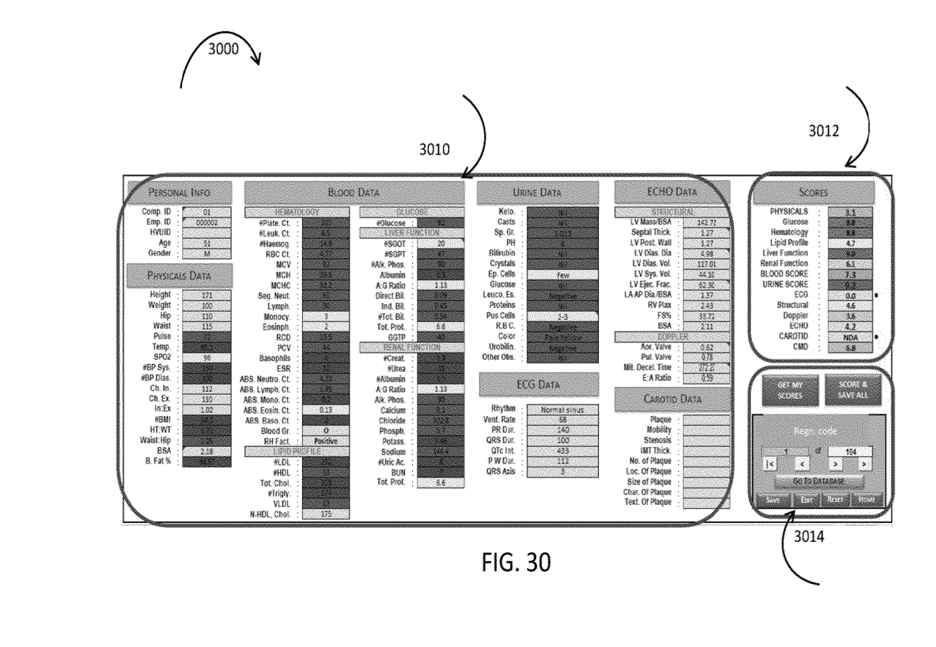

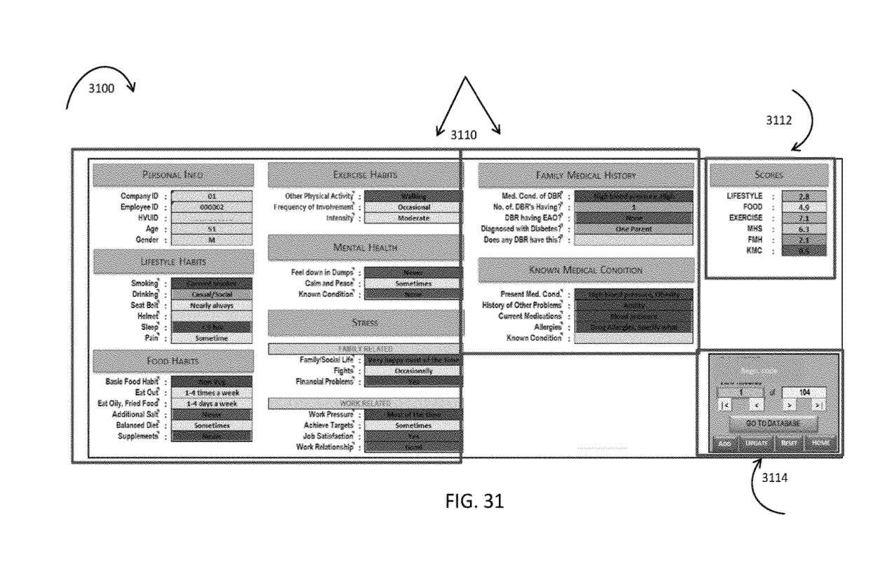

As provided in Table 17 a Y indicates the member can view the data and an N indicates that the member cannot view the data. Accordingly all three members can view a holistic data which gives them information on a population of individuals. From this information all they can gather is the general trend of the health status of a population of individuals. As mentioned hereinabove if the number of individuals in a population is below a particular number, for example below 5, even this holistic view is blocked for the employer and employee as it may be possible to relate a given health status to a member in the group. This is with an aim to keep the identity of the individuals secure. Only the employees can view their identity. Both an employer and a medical practitioner will have no access to the personal information that can relate a certain set of personal data, TR, health scores, and IHG to any particular employee. However, the detailed medical data of an individual is accessible to both the individual and a medical practitioner as shown in FIG. 30 and FIG. 31. Though the medical practitioner has no access to the identity of an individual, the medical practitioner has access to the TR, health scores, and IHG, since the medical practitioner is allowed to review and edit the data when needed and provide corresponding recommendations and risk assessments.

Referring to FIG. 30, a detailed view 3000 of individual's test results and analytical information derived using methods described herein by using the employee link 2916 provided in HAT 2900 in accordance with an embodiment of the present technique is provided. An individual i.e., an employee is provided access only to the individual's information. Accordingly when an individual is viewing this link the section 3014 in the view 3000 will not be visible to the individual. However, in a similar view that is accessible to a medical practitioner when the medical practitioner accesses the HAT using the view data base link 2938 provided in FIG. 29, the window 3014 is accessible to the medical practitioner. The medical practitioner can go through the data for each individual and add/edit recommendation or risk assessments based on the information the medical practitioner views. The view provided in FIG. 30 also provides a window 3010 that shows the employee or the medical practitioner a color coded view of the test results obtained for the employee. The view as shown in FIG. 30 includes the test results collected under super group CMD that includes physicals data, blood data, urine data, ECG data, echo data, and Carotid data. The test results for the corresponding group, sub-group, and parameters of the super group CMD are also included in this view. Further the FIG. 30 includes the parameter scores, sub-group scores, group scores, and the super group scores provided by the expert system in window 3012 which are obtained as a result of the analytics carried out as described with respect to various embodiments of the system and method disclosed herein. All the data included in window 3010 and 3012 are color coded in addition to providing the actual values. This gives a quick first glance visual understanding of the health status of the employee without actually going through all the details of the TRs and the scores. Thus the HAT allows the employee access to the employee's own TR and scores and the medical practitioner access to data of all employees, if there is a need to look at the health data in detail.

Referring to FIG. 31, a detailed view 3100 of individual's PHQ and analytical information derived using methods described herein by using the employee link 2916 provided in HAT 2900 in accordance with an embodiment of the present technique is provided. An individual i.e., an employee is provided access only to the individual's information. Accordingly when an individual is viewing this link the section 3114 in the view 3100 will not be visible to the individual. However, in a similar view that is accessible to a medical practitioner when the medical practitioner accesses the HAT using the view data base link 2938 provided in FIG. 29, the window 3114 is accessible to the medical practitioner. The medical practitioner can go through the data for each individual and add/edit recommendation or risk assessments based on the information the medical practitioner views. The view provided in FIG. 31 also provides a window 3110 that shows the employee or the medical practitioner a color coded view of the test results obtained for the employee. The view as shown in FIG. 31 includes the data collected using the PHQ. The test results for the corresponding sets of questions included in the PHQ i.e., LSH, FH, EH, MH&S, and FMH, KMC are also included in this view. Further, the FIG. 31 includes the parameter scores, sub-group scores, group scores, and the super group scores provided by the expert system in window 3112 which are obtained as a result of the analytics carried out as described with respect to various embodiments of the system and method disclosed herein. All the data included in window 3110 and 3112 are color coded in addition to providing the actual values. This gives a quick first glance visual understanding of the health status of the employee without actually going through all the details of the PHQ results and the scores.

In one embodiment, the system and method disclosed herein ensure total security of the data and anonymity of the individual's health status. As shown in Table 17 information regarding the individual may be shared only on a need-to-know basis only if the said individual grants such access to a concerned person or entity. Every individual is provided with a unique identification number i.e., a registration number and a user name and password.

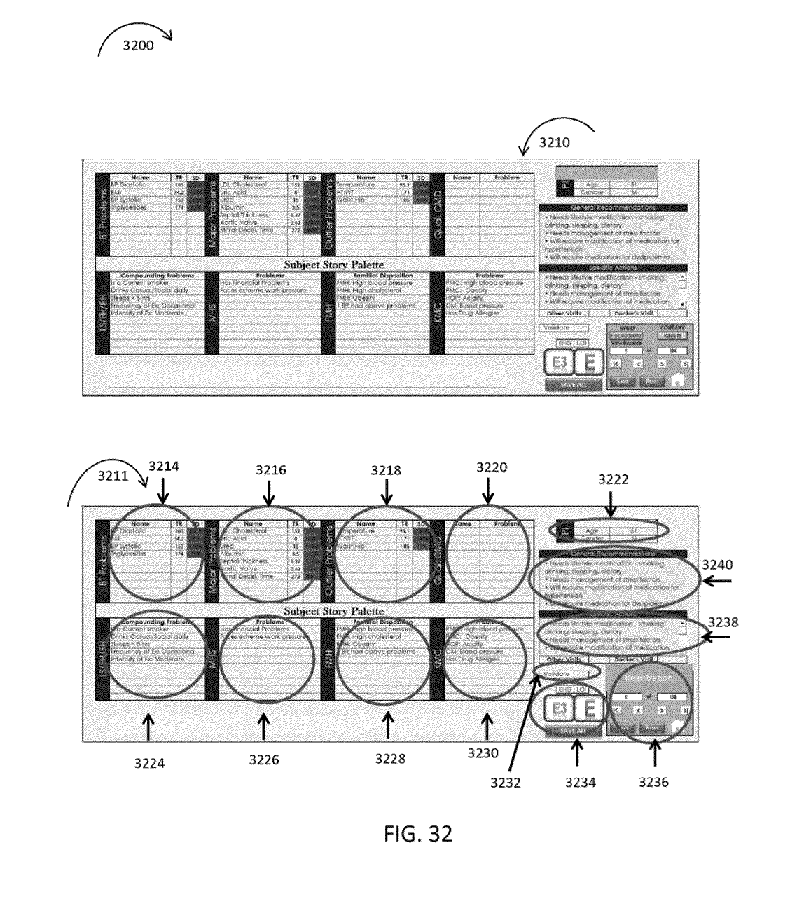

Referring to FIG. 32 is provided another view of the HAT 3200 in accordance with an embodiment of the present technique. In this view is provided a Subject Story Palette (SSP) 3210. The SSP 3210 is formed by collecting and bucketing the top parameters in a group or sub-group. Please note that SSP 3210 is repeated as 3211 in the FIG. 32 to clearly indicate the information that is provided in the SSP 3210. As shown in FIG. 32 the SSP 3211 includes clinical parameter buckets 3213 and PHQ parameter buckets 3215. The clinical parameter buckets 3213 include BT (Beyond Threshold) problems 3214, Major Problems 3216, Outlier Problems 3218, and problematic qualitative parameters 3220. The PHQ parameter buckets 3215 include LSH/FH/EH 3224, MH&S 3226, FMH 3228, and KMC 3330. The top parameters included in bucket BT 3214 are those where an individual's parameter TRs fall in the region between the threshold value and the emergency values as explained with reference to Table 4 and FIG. 8 above. The top parameters included in bucket Main Problems 3216 are those where an individual's parameter TRs fall in the red region as explained with reference to FIG. 8 above. The parameters that are not among the top parameters but are a cause for concern because of their abnormal TR which lies out of the normal parameter range are included in bucket Outlier Problems 3220. Thus, for example, as shown in bucket BT problems 3214 the health status of the individual with respect to BP diastolic, BP systolic, BMI, and TGL all have TR values in the beyond threshold region. The SSP 3211 shows information on personal information of the individual 3222 and automated info ration provided by the expert system including general recommendations 3240, specific actions that the individual needs to take to improve health status 3238, IHG, e.g., E and risk levels within that IHG e.g., E3 3234. As shown in FIG. 30 and FIG. 31 the SSP 3211 also includes a window 3236 accessible only to medical practitioners to look through the SSP for various individuals and validate 3232 the general recommendation 3240 and the specific actions 3238 provided by the expert system. If any recommendation 3240 or action 3238 needs to be edited the medical practitioner has the authority to do so. However, the window 3236 is not viewable to an individual accessing the SSP 3200 as described with reference to FIG. 30 and FIG. 31. The recommendations may be parameter specific or may be general recommendations. (i) Parameter Specific Recommendations:—Parameter specific recommendations based on top problems of the individual/employee, (ii) General Recommendations:—medical practitioner gives recommendation after having a holistic look at subject's data in SSP.

The SSP tool may be viewed only by an employee or a medical practitioner and not by an employer. The system and method described herein also provides a recommendations bank. Again this recommendation bank is formed based on the recommendations provided by knowledgeable and experienced medical practitioners based on the first data set, the analytical results, and the SSP provided in reference to embodiments described herein. These recommendations are used to form the recommendation bank which may then be used by the expert system to provide automated recommendations depending on the health conditions of each individual. Once an automated recommendation is provided by the expert system, the medical practitioner in charge may validate these recommendations for each individual. However if the medical practitioner does not agree with the recommendations then the medical practitioner has an option to edit this recommendation and resubmit. The recommendation bank is then updated to incorporate the new/revised recommendations and the expert system will now provide this revised recommendation for a similar future data set.

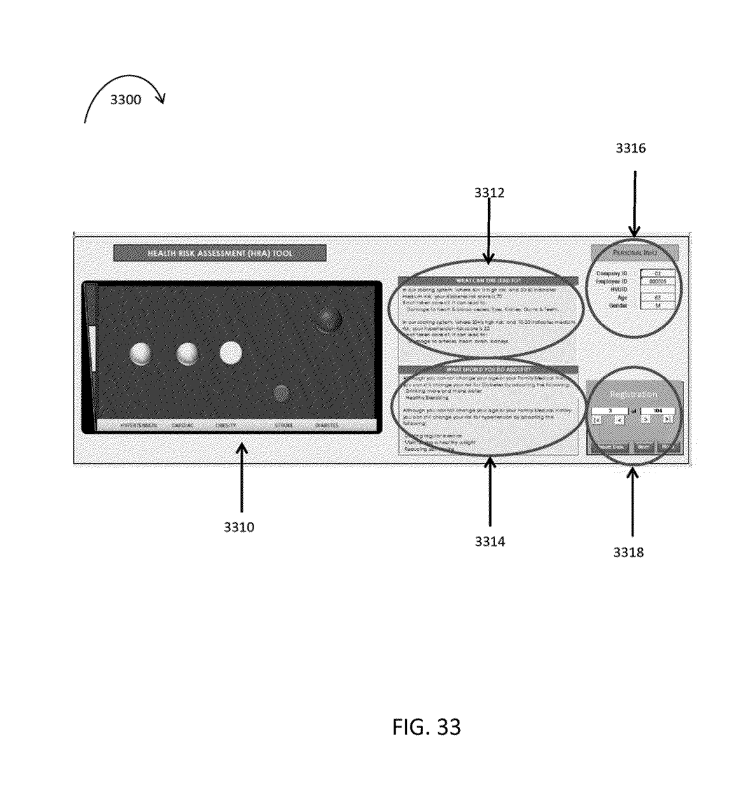

Referring to FIG. 33, a Health Risk Assessment Tool (HRAT) 3300 in accordance with the embodiments of the present technique is provided. Each individual's risk of being afflicted by various diseases is determined by different algorithms as known to a person skilled in the art. Data obtained for different super groups, groups, sub-groups, and parameters as explained herein are incorporated in these different algorithms to determine the health risk for an individual. These algorithms form the basis of the HRAT 3300. Individual risks are categorized by high, medium, and low values and are accordingly colored using colors of red, yellow, and green as described herein. The HRAT 3300 includes a view 3310 that indicates the health status of an individual with respect to various health risks. The view 3310 of HRAT 3300 shows these health risks in the form of colored balls which allow the individual to understand the health status at a glance. These balls are hyperlinked to the data of the individual as shown in FIG. 30 and FIG. 31 and to the SSP as shown in FIG. 32. The HRAT 3300 also includes windows that inform the individual“what can this lead to” 3312 and what corrective actions the individual needs to take i.e., “what should you do about it” 3314 to avoid or minimize these future risks based on the health data of the individual. These recommendations may also be automated as described herein above. The tool also includes personal information 3316, and the window 3318 for a medical practitioner to navigate between the health data of different individuals in the HRAT format. Window 3318 is not viewable for an individual just as personal information of an individual is not viewable by a medical practitioner. This view 3310 is accessible either to an individual or a medical practitioner and different information is made available based on sign in credentials as described herein above.

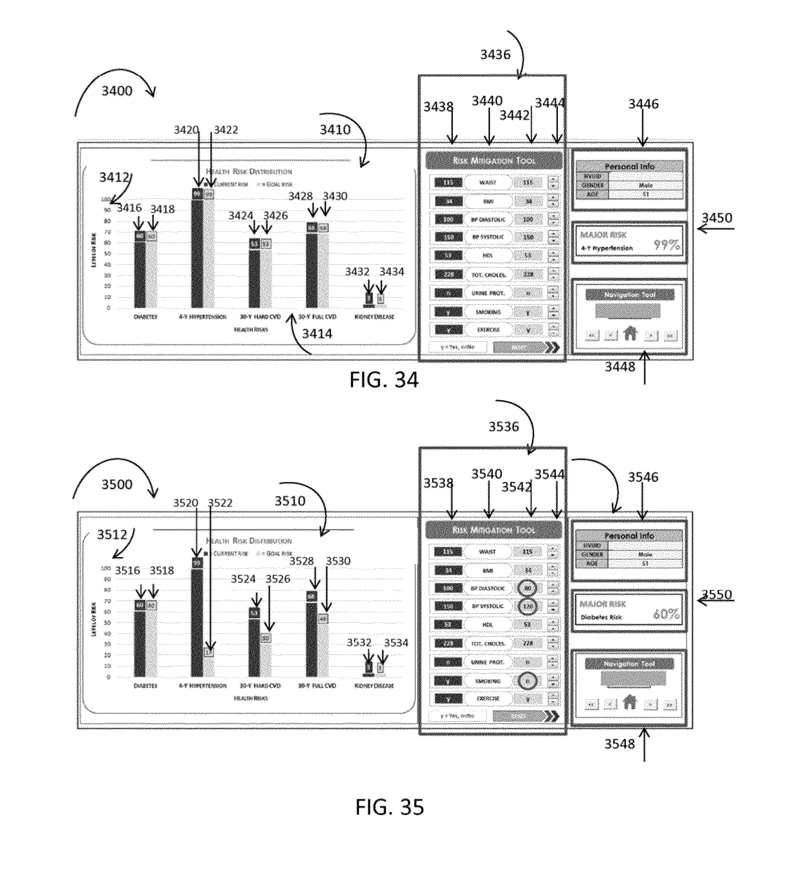

In one embodiment, the system and method of the present technique provide a motivational tool accessible to an individual and a medical practitioner. This tool allows an individual to set his/her own parameter specific goals and the fact that these goals reduce the health risks of individuals eventually motivates them. Referring to FIGS. 34 and 35, a Motivational Tool 3400, 3500 in accordance with the embodiments of the present technique is provided. As shown in FIG. 34 the graph 3410 includes level of risk on the Y-axis 3412 and health risks on the X-axis 3414. For example, in graph 3410 column 3416 indicates the current level of risk of diabetes and column 3418 indicates the individual's goal level of risk of diabetes. Accordingly the other pairs of columns indicate the current level risks and goal level risks of hypertension 3420, 3422; 30-Y hard CVD (risk of an individual facing hard CVD in the next 30 years) 3424, 3426; 30-Y full CVD (risk of an individual facing full CVD in the next 30 years) 3428, 3430; and kidney disease 3432, 3434. The FIG. 34 also includes a Risk Control Tool (RCT) 3436. The RCT 3436 includes four sections. The first section 3438 includes the current TR of an individual, second section 3440 includes the parameters for which the TR is provided in 3438, third section 3442 shows the goal TR values for the corresponding parameters included in the second section 3440, and the fourth section 3444 includes scroll up-down arrows. An individual may use the arrows in the fourth section 3444 and change the values in the third section 3442. The view of the RCT 3436 captured in FIG. 34 shows both the current TR values 3438 and the goal TR values 3442 to be the same. Accordingly graph 3410 shows both columns (current in red color and goal in sage color, colors used here are only for differentiation. Any color may be used for showing the different columns, these colors are not representative of the color scale described herein) for the different health risks having the same level of risks. i.e., diabetes 3416, 3418 with a level of risk 60; hypertension 3420, 3422 with a level of risk 99; 30-Y hard CVD 3424, 3426 with a level of risk 53; 30-Y full CVD 3428, 3430 with a level of risk 68; and kidney disease 3432, 3434 with a level of risk 3. An individual whose current TR reads as shown in the first section 3438 of the RCT 3436 may use the Motivational Tool 3400 to determine the foreseeable change in the individual's health risks by changing the goal TR values in the third section 3442 of the RCT 3436 using the scroll up-down arrows 3444. FIG. 35 shows the difference that an individual sees in the individual's risks when the individual changes the BP diastolic value to 80 (goal TR; marked with red circle in the figure) in third section 3542 from the individual's current TR value for BP diastolic 100 as shown in the first section 3538. Similarly the individual changes the BP systolic value from current TR 150 to goal TR 120, and the smoking parameter from current TR “yes” to goal TR “no”. The individual is then able to view the change in risk levels on comparing graph 3410 and graph 3510. Table 18 shows the change in current TR and goal TR when the individual changes the data in section three 3542 of the RCT.

TABLE 18

| | GRAPH 3510 | | | |
|---|---|---|---|---|
| | Changes BP Diastolic: 100 to 80, | | | |
| | BP Systolic: 150 to 120, | | | |
| | Smoking: Yes to No | | | |
| | Other parameters unchanged | | | |
| | | Reference | Goal | |
| | | numeral in | Risk | Reference |
| Health Risks | Current Risk level | Figure | level | numeral in Figure |
| Diabetes | 60 | 3516 | 60 | 3518 |
| Hypertension | 99 | 3520 | 27 | 3522 |
| Hard CVD | 53 | 3524 | 30 | 3526 |
| Full CVD | 68 | 3528 | 48 | 3530 |
| Kidney disease | 3 | 3532 | 3 | 3544 |

Thus as seen in Table 18 by using the RCT 3536 when an individual changes the goal TR values in section three 3542 individual gets a different value for goal risks as shown in graph 3510 in FIG. 35. The individual personally or along with the guidance of a medical practitioner may accordingly aim to achieve this goal. Only a medical practitioner can access the tool using navigation tool window 3448, 3548. The navigational tool window 3448, 3548 is not viewable to the individual. For example, based on the change the individual has made in the section three 3544 the information shown in the major risk showing window 3450 (4Y-hypertension with a 99 percent risk level) is different from the information shown in the major risk window 3550 (Diabetes 60 percent). Accordingly the individual can set targets that will help the individual to lower the risks for various health risks using the section three 3442, 3542 in the RCT 3436, 3536. The individual can see only the individual's data while the medical practitioner can browse the entire data base for all individuals. This tool can only be used by an employee and not by an employer. The tool also includes personal information 3446, 3546.

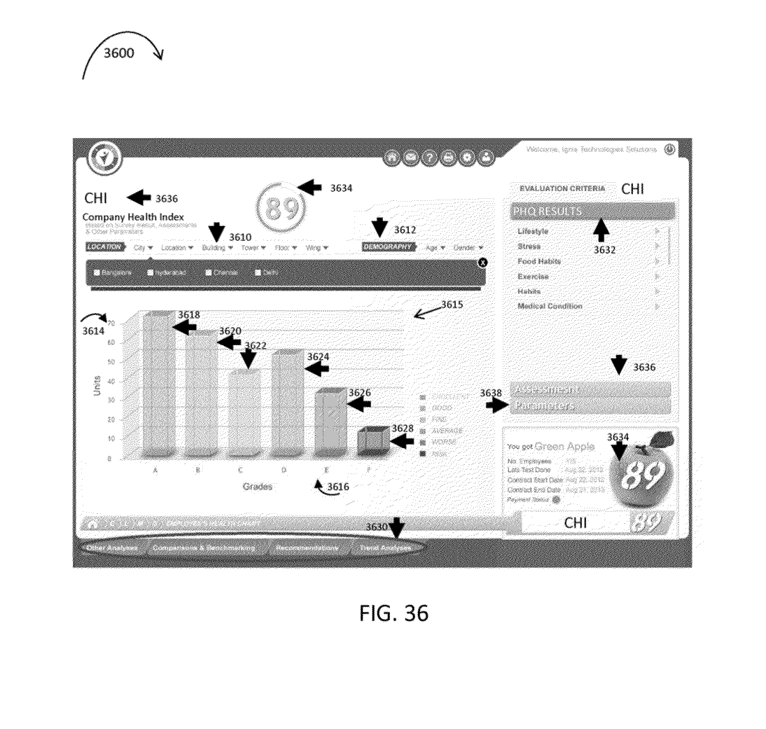

Till now we have discussed various links provided in FIG. 29 that may be used by an individual/employee and or a medical practitioner to obtain the details of the health status of the individual/employee. Now, if the individual is an employee of a body corporate, in one embodiment, the dashboard provided is an Employer Global Dashboard (EGD) may be provided to the employer. The EGD may allow the employer to use a variety of drill down options to determine the holistic state of health of all its employees, employees in a particular geographical location, employees doing a particular kind of work, among others, thus assessing the employer's risks associated with their employees' health. This determination may assist the employer to help in understanding the state of health of the employees holistically. Accordingly the employer may guide, assist, or provide the employees with a required level of intervention, for example, health programs, to help the employees lead a healthy life. Using this dashboard the employer may have a bird's eye view and a detailed drill down view of the collective health of a population of employees. The system will have adequate measures that would prevent the employer from viewing the individual health data of any particular employee unless the individual employee explicitly permits the employer to do so. Referring to FIG. 36, is provided a tool for an employer i.e., an Employer Global Dashboard 3600 (EGD) in accordance with an embodiment of the present technique. The HAT tool described in FIG. 29 has a link 2918. One of the tools accessible to an employer by accessing link 2918 is the EGD 3600. The employer may use any convenient means to access the EGD 3600. The versatility of the tool allows the employer to slice, dice, and view the health data of a population of employees in different ways as explained herein.

The employer is provided access to the data of a population of employees using the EGD 3600. The tool does not allow the employer to view the detailed data for each individual employee. As described herein before, the tool even has a feature of restricting the minimum number of employees in a population below which the employer will be unable even to view the data even for a population of employees. For example, if the number of employees in particular location of an employer is less than or equal to five the employer will not be able to view even a holistic data of this population of employees unless each individual penults the employer to do so. These features have been incorporated in the tool to ensure the secrecy of the employee's identity and individual employee's health results. Using the EGD the employer may sort and view health data of a population of employees by location 3610 i.e., city, location, building, tower, floor, wing, etc. The employer may also sort and view the health data of a population of employees using demographics 3612 of the employees i.e., age and gender. The EGD 3600 also includes a graph 3615 that shows percentage of employees with a particular health grade on Y-axis 3614 and EHG (employee health grade) on X-axis 3616. The graph 3615 may be generated in any convenient format. In the example shown in the graph 3615, columns 3618, 3620, 3622, 3624, 3626, 3628 indicate percentage of employees whose EHG is A, B, C, D, E, and F respectively. A through F indicates a health gradation from excellent to poor respectively. The columns may also be color coded as shown in graph 3615 to give a quick visual effect of the health status of a population of employees. The health grades A, B, C, D, E, and F have been determined for individual employees as explained in Table 15 above. The data shown in graph 3615 is for all the employees belonging to an organization. The employer may use the location tab 3610 or the demography tab 3612 to further narrow down to a particular population of employees located in a particular location and/or falling in a particular demography. The employer may also be enabled with viewing other analyses 3630 (encircled in red) including comparisons and benchmarking, recommendations, and trend analysis. The employer may also be able to holistically (i.e., for a population of employees at a particular location or of a particular demographic) view the results of the PHQ 3632, risk assessments 3636, and parameters 3638 for the whole or for the selected population of employees. One skilled in the art will appreciate that the data viewed in FIG. 36 may include links to other information that may be needed for an employer to get a holistic view of the health status of the employees. Accordingly the view may be amended to include these other links. In addition, the employer is provided a Company Health Index (CHI) based on the health grades of the individuals. In FIG. 36 the CHI 3634 for the organization is 89 based on a weighted average algorithm. Based on this weighted average algorithm the CHI of an organization can be a number having a value between 17 (worst) and 100 (best). The CHI 3634 provides the employer a relative grade based on the overall health of the employees based on the sorted/selected population. This also enables the employer to determine what specific health improvement/wellness programs they can incorporate to improve the overall health of the sorted/selected population.

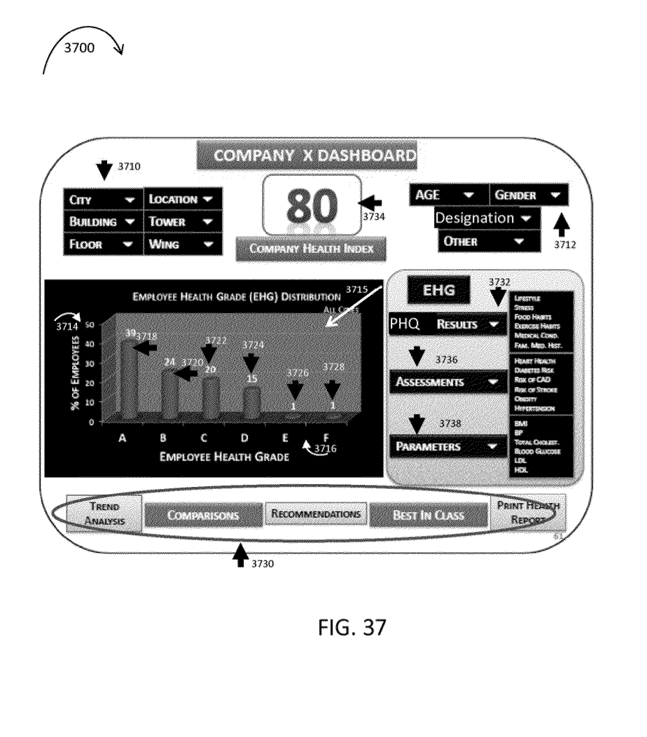

Referring to FIG. 37, is provided another format of an Employer Global Dashboard 3700 (EGD) in accordance with an embodiment of the present technique. The HAT tool described in FIG. 29 has a link 2918. The versatility of the tool allows the employer to slice, dice and view the employee health data of a population of employees in different ways as explained herein. The employer is provided access to the data of a population of employees using the EGD 3700. The employer can neither view the details of each individual employee nor is enabled to view the holistic data if a population of employees is below a pre-specified minimum number, for example 5. Using the EGD the employer may sort and view health data of a population of employees by location 3710 i.e., city, location, building, tower, floor, wing, etc. The employer may also sort and view the health data of a population of employees using demographics 3712 of the employees i.e., age and gender or based on their designation in the organization. In other embodiments the data can also be sorted using date of testing. The EGD also includes a graph 3715 of percentage of employees with a particular health grade on Y-axis 3714 and EHG on X-axis 3716. The graph may be generated in any convenient format. In the example shown in the graph 3715, columns 3718, 3720, 3722, 3724, 3726, 3728 indicate percentage of employees whose EHG is A, B, C, D, E, and F respectively. As mentioned with reference to FIG. 36, the health grades A, B, C, D, E, and F are determined for individual employees. The employer may also be enabled with viewing other analyses 3730 like trend analysis, comparisons, recommendations, and best in class. The employer may also be able to view the PHQ results 3732, risk assessments 3736, and parameters 3738 i.e., first data set collected from the employees but only on a holistic level. Each of 3732, 3736, and 3738 include further drill down features for the employer to use. One skilled in the art will appreciate that the system and method disclosed herein may allow the modification of these drill down features depending on what would be the best information that can provide more granular/actionable health insights. For example, using link lifestyle in PHQ results the employer may identify that the CHI of Bangalore is low due to an increased number of smokers at one location in Bangalore. The employer may plan to run a program at that location which may help to reduce the number of smokers and thereby improve the CHI of that location. In addition to all this information the employer i.e., the organization is provided a CHI based on the EHG of the individuals as explained with reference to FIG. 36 and Table 15. In FIG. 3700 the CHI 3734 for the organization as a whole is shown to be 80.

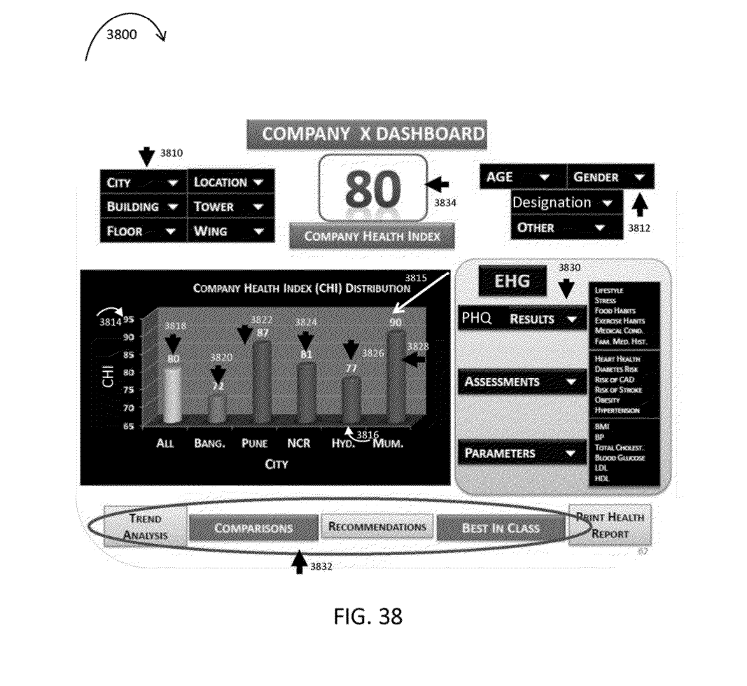

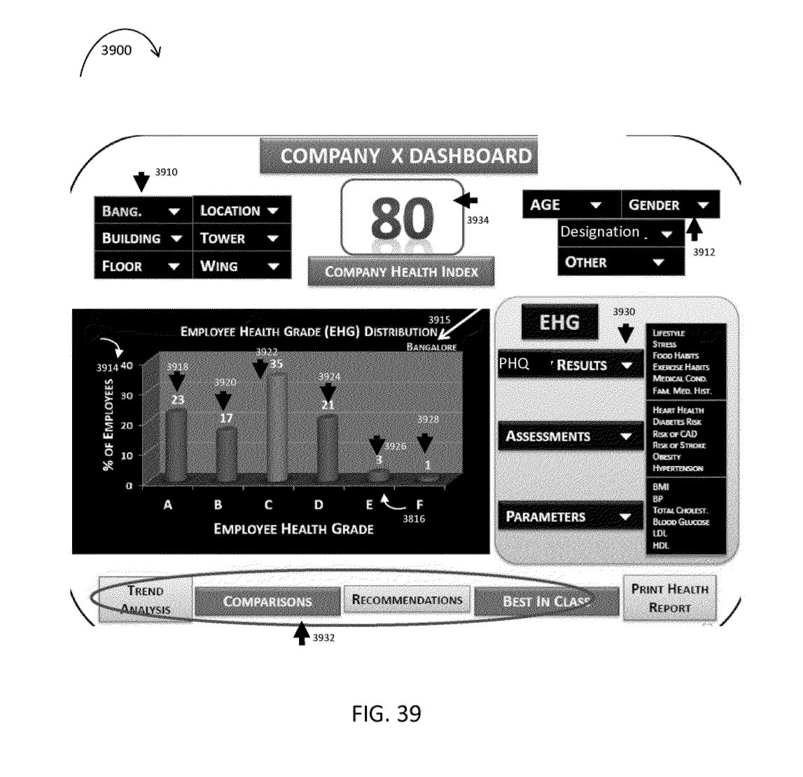

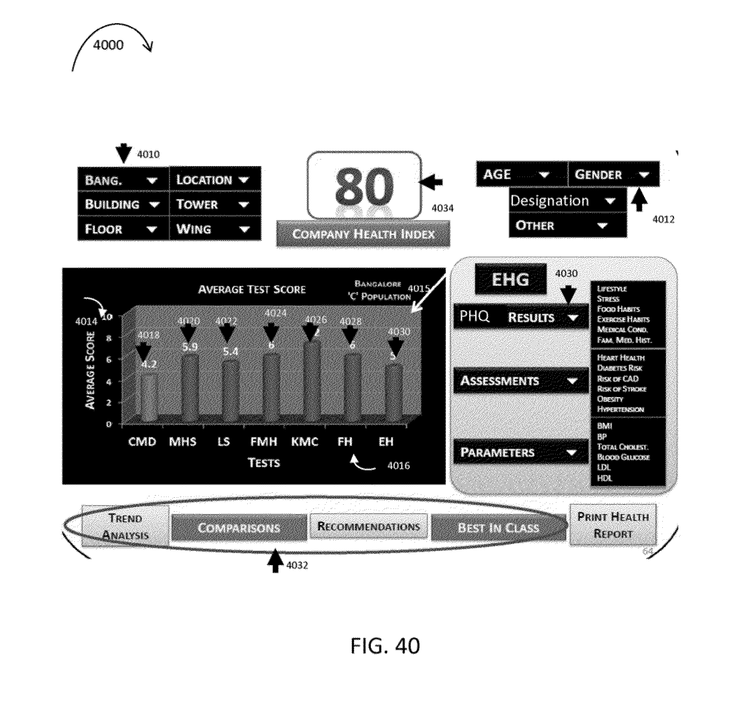

Referring to FIG. 38, is provided another view of the EGD shown in FIG. 36, 37 in accordance with an embodiment of the present technique. Each data point provided in these figures allows the employer to link to a further drill down of the information. For example, if an employer wants to know the distribution of CHI as a function of different cities where the organization is located in, then the employer can click on the CHI 3734 as shown in FIG. 37 and view data in the format as shown in FIG. 38. Thus either by clicking on the CHI 80 or selecting “All” for city in 3810 the employer is now enabled to view a graph 3815. In the example shown in the graph 3815, column 3818 indicates CHI of the whole organization as 80, CHI for Bangalore branch 3820 as 72, for Pune 3822 as 87, for NCR 3824 as 81, for Hyderabad 3826 as 77, and for Mumbai 3828 is 90. This enables the employer to understand that the CH for Mumbai is the highest and for Bangalore is the lowest. The employer may then try to understand the health issues of the employees in Bangalore and plan some health initiatives. If the employer has population of employees located in more than one location in Bangalore the employer may use the location tab 3810 to further drill down by building, tower, floor, and wing respectively to determine which specific population of employees would need immediate attention. The employer may use the demography tab 3812 to further narrow down to a population of employees based on their age, gender, or designation and determine which subset of the employees would need immediate attention. However, as explained herein before the employer is restricted by a minimum number of employees in a subset. If the minimum number is below a specified number the employer cannot view even the holistic information. The view also includes the other links 3830 like PHQ results, risk assessments and parameters, and other analysis 3832. Using the view shown in FIG. 38, the employer can now select the location as Bangalore as shown in location tab 3810 or can click the Bangalore column in FIG. 38 to view FIG. 39.

Referring to FIG. 39 is provided, another view of the EGD in accordance with an embodiment of the present technique. In FIG. 39 the employer is able to view the EHG of the employees located in Bangalore 3910. The graph 3915 shows percentage of employees on Y-axis 3914 and EHG on X-axis 3916 for the Bangalore subset of employees. In the example shown in the graph 3915, columns 3918, 3920, 3922, 3924, 3926, and 3928 indicate percentage of employees whose EHG is A (23 percent), B (17 percent), C (35 percent), D (21 percent), E (3 percent), and F (1 percent) respectively. From this information the employer can identify that the maximum percentage of employees in Bangalore have an EHG “C” and may take necessary steps to assist this population of employees to achieve an EHG of B or A. The view shown in FIG. 39 includes the links to the other information demographics 3912, (PHQ, risk assessments, parameters) 3930, other analysis 3932, and CBI 3934 for the employer to use to further drill down and better understand the reason for the determined CHI in Bangalore.

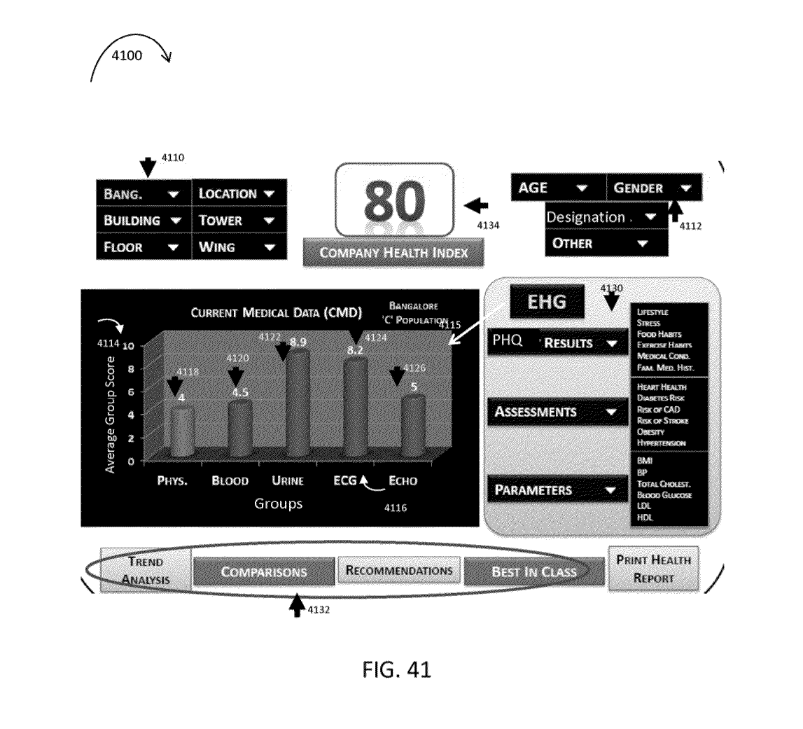

The employer may then click on column C 3922 to further understand the details for the maximum percentage of the employees at Bangalore falling under this EHG. The view obtained by clicking on column C 3922 is shown in FIG. 40. Referring to FIG. 40 is provided another view 4000 of the EGD in accordance with an embodiment of the present technique. In FIG. 40 the employer is able to view a graph 4015 of average score of employees on Y-axis 4014 and corresponding super groups on X-axis 4016. In the example shown in the graph 4015, columns indicate the super group average scores for employees in Bangalore having a EHG “C” i.e., CMD 4018, MH&S 4020, LS 4022, FMH 4024, KMS 4026, FH 4028, and EH 4030. For this subset of employees shows the lowest score value of 4.2 for super group CMD. Links to the other details i.e., demography 4012, (PHQ results, risk assessments, parameters) 4030 and other analysis 4032 are also included in the FIG. 40. If the employer would like to determine the problem areas for this score of CMD the employer can click on column 4018 to view further details as shown in FIG. 41.

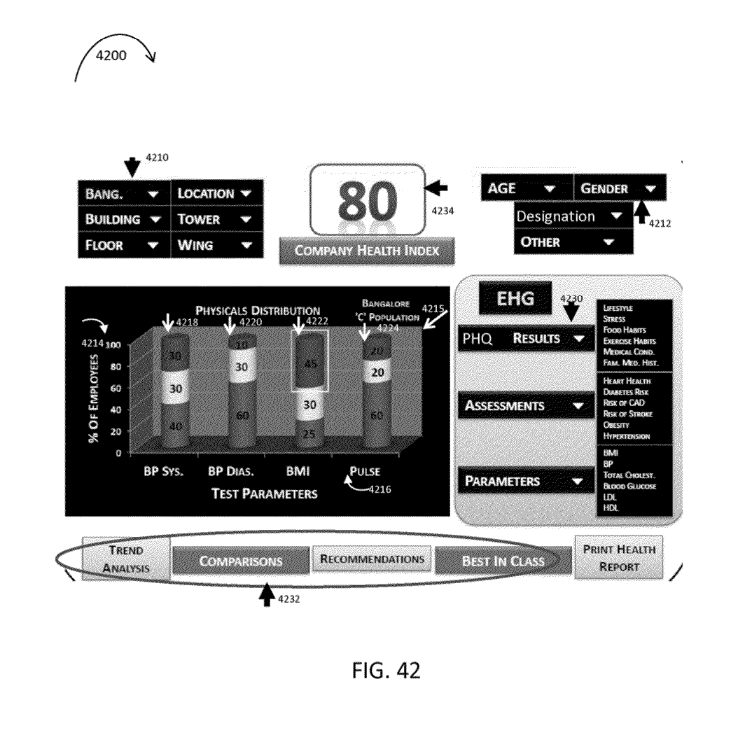

Referring to FIG. 41, is provided another view of the EGD in accordance with an embodiment of the present technique. Graph 4115 of average group score of employees on Y-axis 4114 and corresponding groups on X-axis 4116 shows the CMD for employees in Bangalore having an EHG “C”. Columns indicate group scores for physicals 4118, blood 4120, urine 4122, ECG 4124, and ECHO 4126. The employer now observes that the average group score for physicals is lowest at 4. The employer will now try to determine the reason and hence the corrective action needed to be taken to remedy this low average group score for physicals. The view shown in FIG. 41 includes links to the other information demographics 4112, (PHQ, risk assessments, parameters) 4130, other analysis 4132, and CHI 4134 for the employer to use to further drill down and better understand the reason for the determined CHI. The employer may now click the column physicals 4118 to further drill down and identify the sub-groups/parameters that may be the cause for the group physicals having the lowest score and obtain the view shown in FIG. 42.

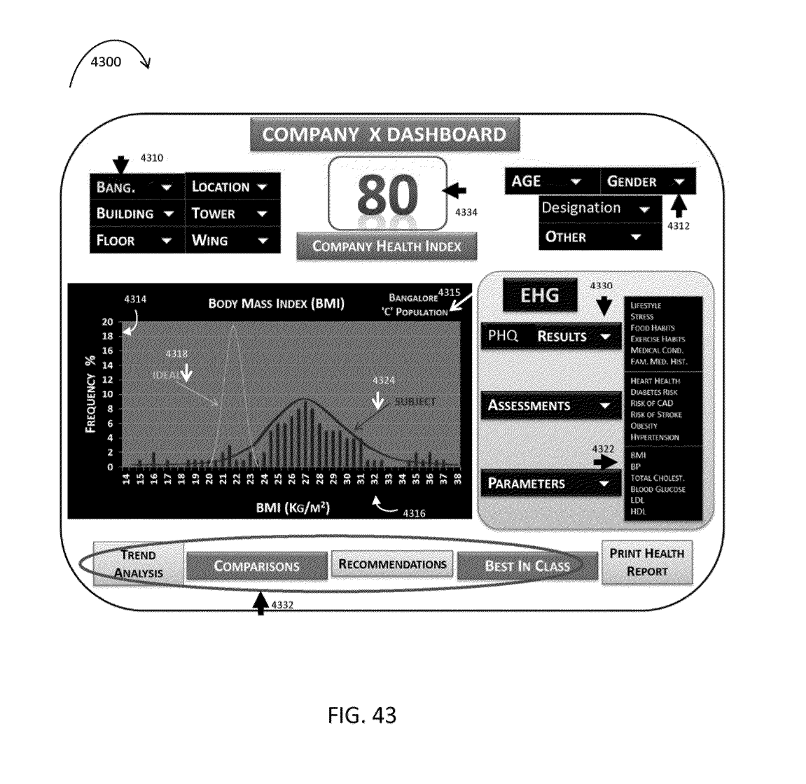

Referring to FIG. 42, is provided another view of the EGD in accordance with an embodiment of the present technique. Graph 4215 shows percentage of employees on Y-axis 4214 and corresponding tests parameters on X-axis 4216. Columns indicate the test parameters for group-physicals for a subset of employees having EHG “C” in Bangalore. The test parameters shown in X-axis 4216 include BP systolic 4218, BP Diastolic 4220, BMI 4222, and Pulse 4224. The columns also show a distribution of the percentage of employees whose parameter scores fall in the green region, yellow region, and red region (the colors having the same signification as described hereinabove at least with respect to FIG. 5 and FIG. 6). The column 4222 representing BMI shows the highest percentage of employees in the red color i.e., 45 percent. The employer can thus now understand that this is the reason for the CHI of 80 for the company and CHI 72 for Bangalore. The employer may now click the red region of the BMI column 4222 to further drill down and identify the distribution of the subset of employees in this 45 percent and the population shift from the normal BMI values. This information can be obtained in the view shown in FIG. 43.

Referring to FIG. 43 is provided another view of the EGD in accordance with an embodiment of the present technique. Graph 4315 with frequency percentage on the Y-axis 4314 and the BMI in kilograms per square meter on the X-axis 4316 now shows the distribution of the employees under the curve 4324 (subject curve, for Bangalore “C” population). The graph 4315 also shows the ideal BMI curve 4318 that the employees need to attain. The difference in the mean positions of the peaks helps the employer to design health programs to ensure that the gap between the mean positions is minimized for this subset of employees facing the BMI problem. Similar programs like exercise, yoga, counseling, etc. . . . can also be administered if the drill down process mentioned herein above would lead to such requirements. Thus the employer can use various levels of drill downs for the globalized improvement of the CHI of the company by administering specific localized targeted health programs. The date of testing (not shown in figure) may also be included in the EGD 3700 to 4300 and used for sorting and viewing the health data. The employer may also use the parameters link provided in window 4330 (parameter BMI 4332) to view the details shown in FIG. 43 after first drilling down to Bangalore “C” population.

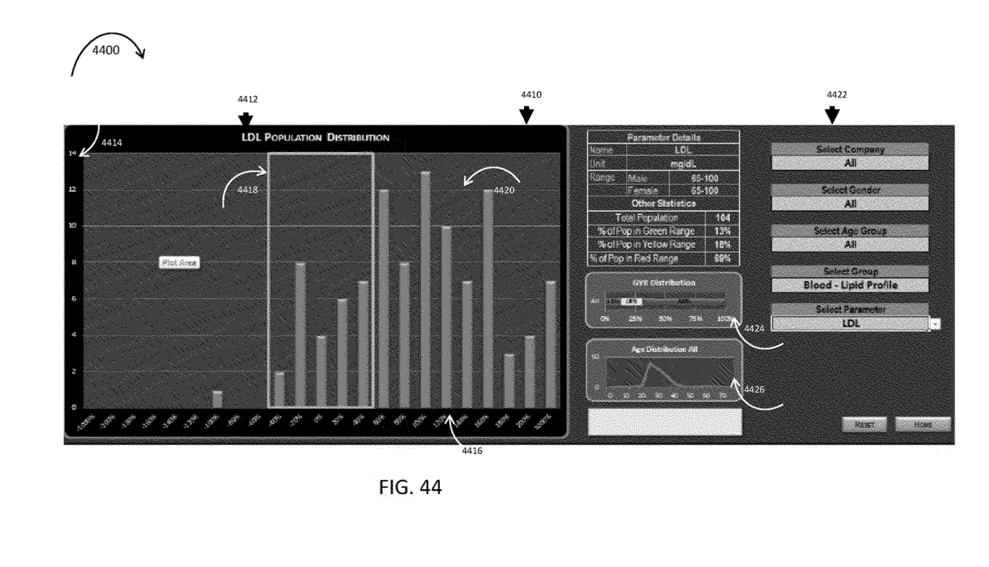

Referring to FIG. 44, is provided another representation 4400 of the EGD in accordance with an embodiment of the present technique. Similar to the EGD's discussed hereinabove this view also provides an employer various drill down options to determine the base problem resulting in a subset of population. Accordingly in FIG. 44 is shown the population distribution for a population of employees with respect to parameter LDL. FIG. 44 includes a graph 4412 of frequency distribution of employees on Y-Axis 4414 and percentage SPD on X-Axis 4416. The graph as shown indicates the population of employees falling within the normal parameter range for LDL i.e., the ideal range 4418 and those falling outside the normal parameter range 4420. Using the selection window 4422 the employer can narrow or widen the selection to include all locations or a particular location, particular or all genders, particular or all age groups, or a particular group. For example, view 4400 shows the group blood narrowed down to its sub-group lipid profile and selected parameter “LDL”. Thus by using the selection window 4422 the employer can view the ideal and actual health status for different population of employees. A color bar representation 4424 of percentage of employees falling under different color regions i.e., red, green, and yellow, is also provided. A plot 4426 showing the age distribution of a population of employees is also provided.

Accordingly one skilled in the art will appreciate that the system and method described herein are flexible in terms of representing the data while at the same time allowing the employer to have a number of drill down options to help determine the problem area.

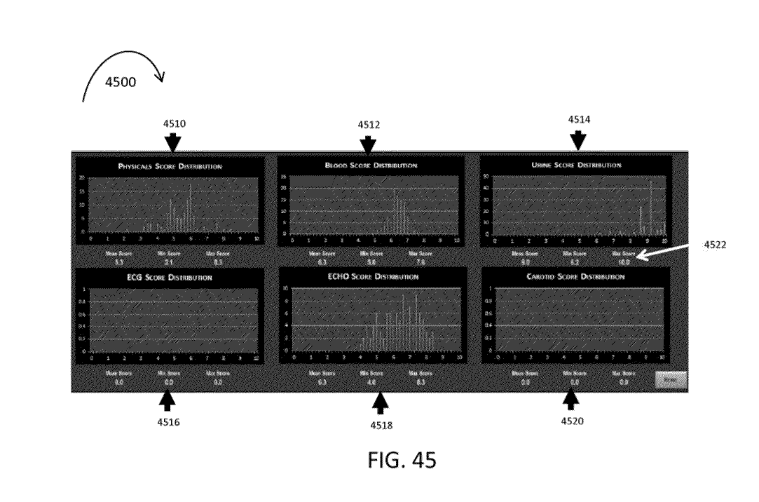

Referring to FIG. 45, the employer can view the graphs for different group score distributions, for example, physicals score distribution 4510, blood score distribution 4512, urine score distribution 4514, ECG score distribution 4516, ECHO score distribution 4518, and Carotid score distribution 4520. FIG. 45 thus provides a quick glance at the groups for super group CMD. Similar views can be obtained for drilled down data, for example, all the sub-groups for group blood and then for all the parameters for the sub-group for group blood which at a glance will tell the employer which parameter or sub-group of the group is the reason for the low CHI/EHG. The maximum, mean, and minimum scores are indicated for each score distribution 4522.

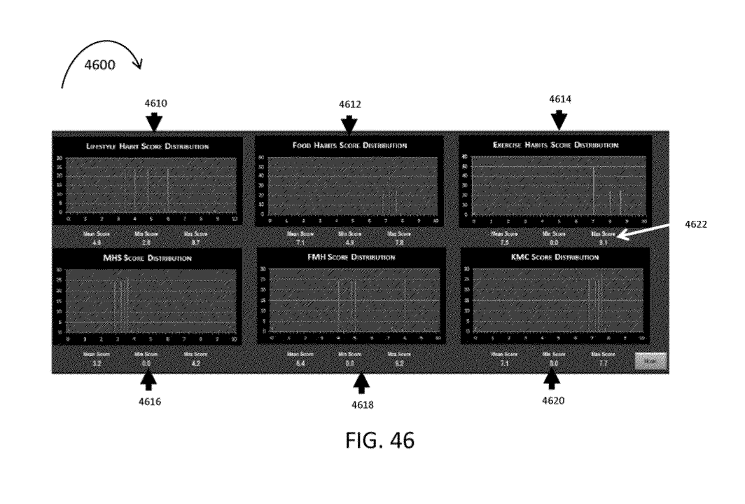

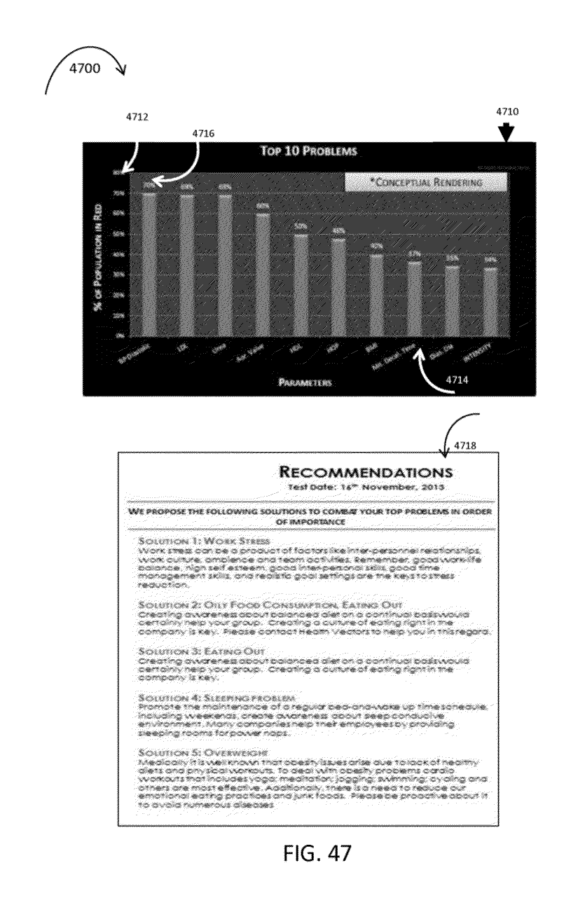

Similarly the employer can view the PHQ scores for a population of employees after sorting the data using the various filters provided to the employer as described herein before. Referring to FIG. 46, is provided another view of the EGD 4600 in accordance with an embodiment of the present technique. As shown in FIG. 46, the employer can view the score distribution graphs for different PHQ scores, for example, LHS score distribution 4610, FHscore distribution 4612, EHscore distribution 4614, MH&S score distribution 4616, FMH score distribution 4618, and KMC score distribution 4620. The maximum, mean, and minimum scores are indicated for each score distribution 4622.

Referring to FIG. 47, the employer is also provided another EGD view 4700. FIG. 47 is a conceptual rendering of a view accessible to the employer when the employer uses drill down options to identify the top problems (as explained herein before). For example, top ten problems affecting the health status and hence lowering the CHI of the organization. The top ten problems may be viewed in a graph 4710 format with percentage of population in the out of normal parameter range on the Y-axis 4712 and the corresponding parameters on the X-axis 4714. Thus as shown in FIG. 47 the employer may determine that the BP diastolic is the top most problem even among the top ten problems since 70 percent of the employees fall in the out of nominal parameter range.

This view of the EGD 4700 also shows a recommendations field 4718 as described herein above. These are automated recommendations provided by the expert self-learning system described herein and may require the intervention of a medical practitioner only in case of outlying cases. Thus, based on the problems that are specific to the given population, proper recommendations populate the recommendations field automatically when the second mechanism is a processing engine. For the initial results that were used to prepare the recommendation bank a second mechanism i.e., the medical practitioner may populate recommendation field.

In one embodiment, the selection of the top ten problems may be done using the following process. First the medical practitioners are asked to provide a list of top problem areas based on their experience and knowledge. The percentage of people who fall in these problem areas based on clinical data and PHQ data is then determined. Then the problem areas may be sorted with respect to the percentage of people in them. Of these the top ten problems are selected and these ten problems are arranged in accordance with the percentage of individuals in those problem areas. Then recommendations are generated by the system specifically for these top ten problems. These top ten problems may differ based on the gender of the population.

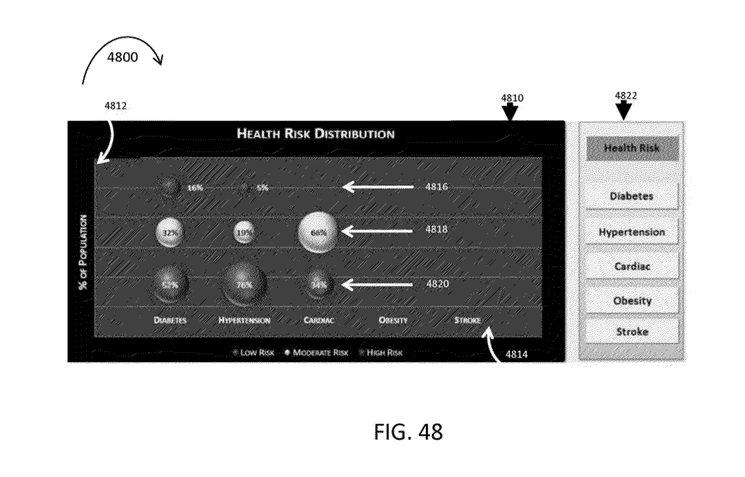

The system and method described herein thus provide different options to an employer to arrive at and view the health status of a population of employees. Referring to FIG. 48, another view 4800 of the EGD in accordance with an embodiment of the present technique is provided. FIG. 48 includes a health risk distribution graph 4810 with percentage of population on the Y-axis 4812 and various disease states (diabetes, hypertension, cardiac, obesity, stroke) on the X-axis 4814. This view is aimed at providing a size and colored visual representation to the employer. The percentage of their employees who are at high risk shown by the red balls 4816, moderate risk shown by the yellow balls 4818, and low risk shown by the green balls 4820. In this view also the employer is provided with a selection window 4822 that will enable the employer to obtain a drill down view on the parameters that are a cause for the health risks. The sizes of the balls are proportionate to the population percentage in the risk category. The balls are also hyperlinked to the details that can be holistically viewed by an employer for a population of employees.

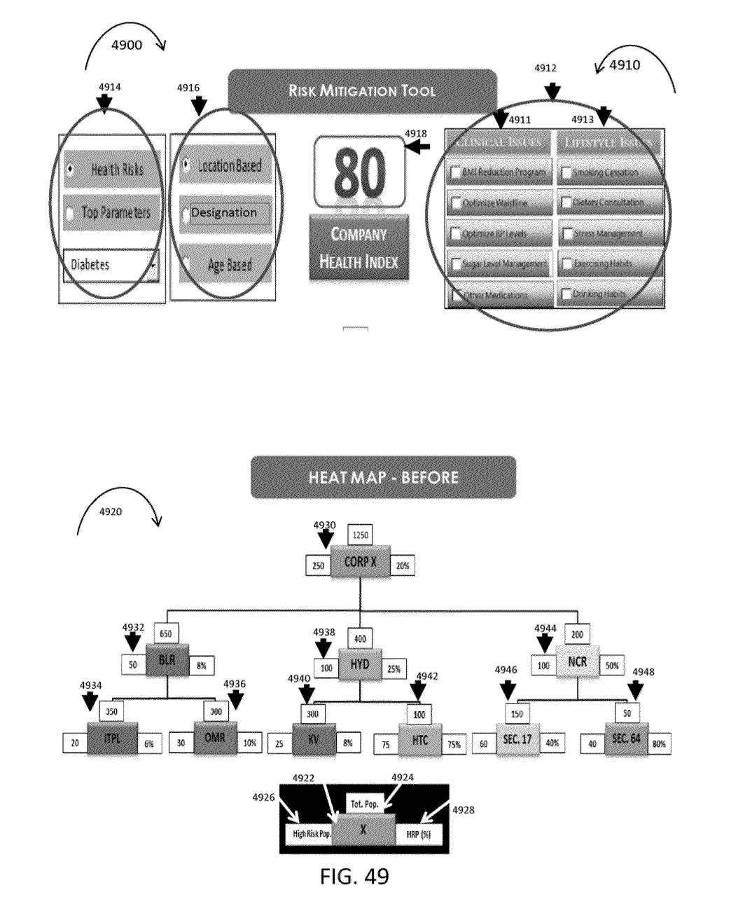

Referring to FIG. 49, a Risk Mitigation Tool (RMT) is 4900 is provided to the employer. The FIG. 49 shows a first view 4910 of the RMT 4900. FIG. 49 also includes a Heat Map Tool of an EGD 4920 that allows the employer to view the health data of the employees in extreme granularity. The RMT enables an employer with various selection criteria i.e., health programs, that when employed may help to increase the CHI. The employer accordingly may use the RMT, 4900 to determine the appropriate health programs and to see the effect of introducing the various health programs on the CHI value of the organization before actual implementation of these programs. As shown in FIG. 4900 the CHI value for the organization is shown to be 80 4918. The selection window 4912 includes a list of programs that may be used alone or in combination to improve the clinical and/or lifestyle issues of the employees and thus result in an improved all value of the organization. The window 4912 thus includes health programs for clinical issues 4911 including BMI reduction program, optimize waistline, optimize BP levels, sugar level management, other medications and health programs for lifestyle issues 4913 including smoking cessation, dietary consultation, stress management, exercising habit, and drinking habits. In one embodiment, the selection window 4914 enables the employer to select and view each health risks at a time, for example, diabetes. In another embodiment, the selection window 4914 enables the employer to select and view one top parameter at a time. Selection window 4916 enables the employer to view a population heat map tool 4920 based on location, designation, and/or age of the population of employees.

The heat map tool 4920 may be viewed in combination with or independently of the RMT. As shown in FIG. 49, the heat map tool 4920 represents the health risk due to diabetes for the complete organization and also provides the drill down information of health risk due to diabetes at the various location of the organization. The heat map tool 4920 includes a distribution chart. Each four blocker in the chart indicates the company/organization/location of the company 4922, total population of employees in the company 4924, number of the population that is facing the health risk of a particular disease 4926 and the percentage of the population facing the health risk of a particular disease 4928. The heat map tool may be further distributed into cities where the total population of employees is distributed into population positioned in different cities and for each city the population of the employees facing the health risk of a particular disease is provided in numbers and percentage. The heat map tool may be further distributed into locations within these cities where the population of employees in each city is distributed into population positioned in different locations and for each location the population of the employees facing the health risk of a particular diseases is provided in numbers and percentage. Thus in the conceptual rendering of the heat map tool 4920, at first the total population of employees (1250) of a company 4930 (CORP X) and the number (250) and percentage (20 percent) of employees facing a health risk of diabetes is shown. This 20 percent population of employees of the company is then bifurcated to show the health risk of diabetes for the different cities that the company is located in. i.e., Bangalore 4932 (8 percent), Hyderabad 4938 (25 percent), and NCR 4944 (50 percent). The population of employees in each city is then bifurcated to show the health risk of diabetes for the different locations within each city that the company is located i.e., Bangalore 4932 (8 percent) is bifurcated into ITPL 4934 (6 percent) and OMR 4936 (10 percent), Hyderabad 4938 (25 percent) is bifurcated into KV 4940 (8 percent) and HTC 4942 (75 percent), and NCR 4944 (50 percent) is bifurcated into Sec. 17 4946 (40 percent) and Sec. 64 4948 (80 percent). From these values the employer can immediately identify the location where the employer may prioritize the initiation of health programs that will reduce the diabetes risk of the organization.

In addition to expressing the numbers in values, the health risk is also indicated in color where the color of the boxes denoting the company, cities, and locations are in accordance with the color scale that is described in detail herein before. Accordingly in the heat map tool 4920 the health risk of diabetes for employees in city Hyderabad 4938 (25 percent) is shown in a shade of green that is more yellower than that for city Bangalore 4932 which is a deeper green (8 percent) and that for city NCR 4944 (50 percent) is yellow in color. Similarly, in the next level of drill down the health risk for employees in location HTC 4942 of city Hyderabad 4938 is orange in color while in location of KV 4940 of city Hyderabad 4938 is green. Now the employer can understand at a glance without even looking at the numbers the reason for city Hyderabad 4938 having the green color more yellower than that shown for city Bangalore 4932 is due to HTC 4942. Similarly, in the next level of drill down the health risk for employees in location Sec. 17 4946 of city NCR 4944 is a yellowish green shade in color while in location of Sec. 64 4948 of city NCR 4944 is orange. Now the employer can understand at a glance without even looking at the numbers the reason for city NCR 4944 having a yellow color. Although the company as a whole shows only 20 percent of its employees with high risk of diabetes, the actual distribution on a granular level shows that Bangalore's ITPL location has only 5 percent of the population with high risk of diabetes while HTC of Hyderabad has 75 percent and Sec. 64 of NCR has 80 percent of the population with high risk of diabetes. When administering a diabetes risk reduction program on a limited budget the employer can get maximum returns on their investment if they focus the programs in Sec. 64 of NCR 4948 and HTC of Hyderabad 4942.

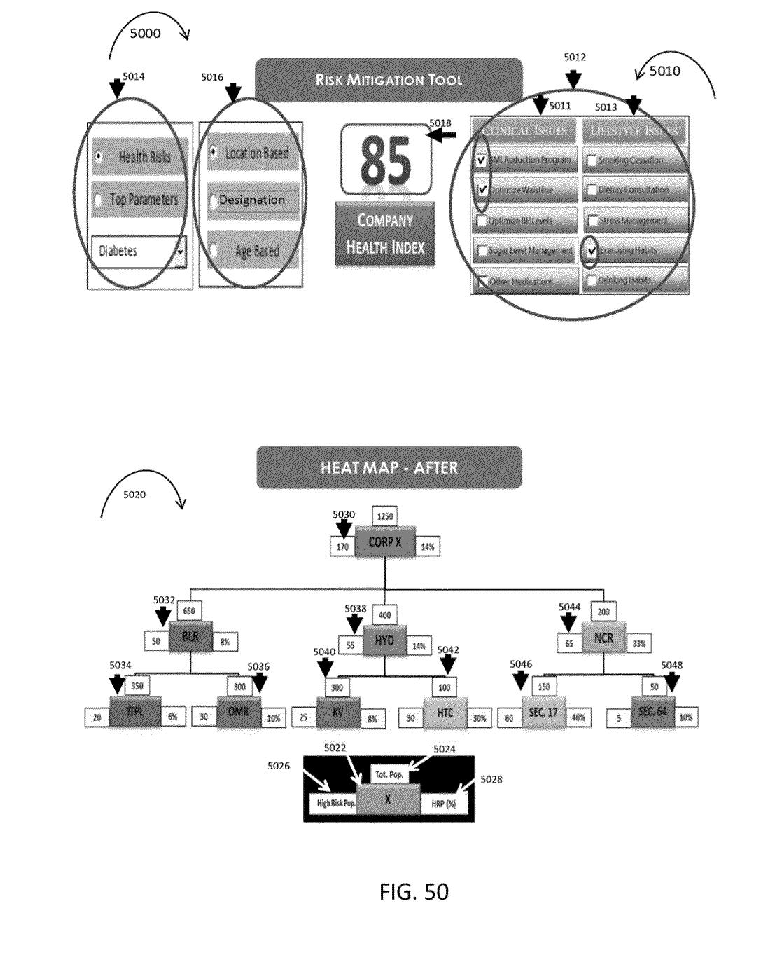

Thus, referring to FIG. 50, is provided another view 5000 of the RMT 5010 and the heat map tool 5020 with reference to the view provided in FIG. 49. All referral numbers in FIG. 50 have the same meaning as explained in FIG. 49. i.e. 4932 corresponds to 5032, 4938 corresponds to 5038, etc. . . . except where particularly mentioned. In FIG. 50 the employer has used the RMT and planned to address certain issues under clinical issues 5011 like BMI reduction program and optimize waistline and lifestyle issue 5013 of exercising habits all indicated by red circles in the HTC 5042 location of Hyderabad 5038 and Sec. 64 5048 locations of NCR 5044. These health programs are known to reduce the health risk of diabetes. By planning to address these issues the employer can view the potential effect on the CHI 5018, now increased to 85 from the previous 80 and corresponding effect on the heat map tool 5020. The population of employees in HTC 5042 in Hyderabad 5038 now show a light green color instead of the previous orange color (with only 30 percent of employees now having the health risk of diabetes). The population of employees in Sec. 64 5048 in NCR 5044 now show a deep green color instead of the previous orange color (with only 10 percent of employees now having the health risk of diabetes). Accordingly the population of employees in the company shows only 14 percent of employees having health risk of diabetes instead of the previous 20 percent. Thus the RMT helps the employer to plan on focused health programs that will benefit the employees and hence the organization.

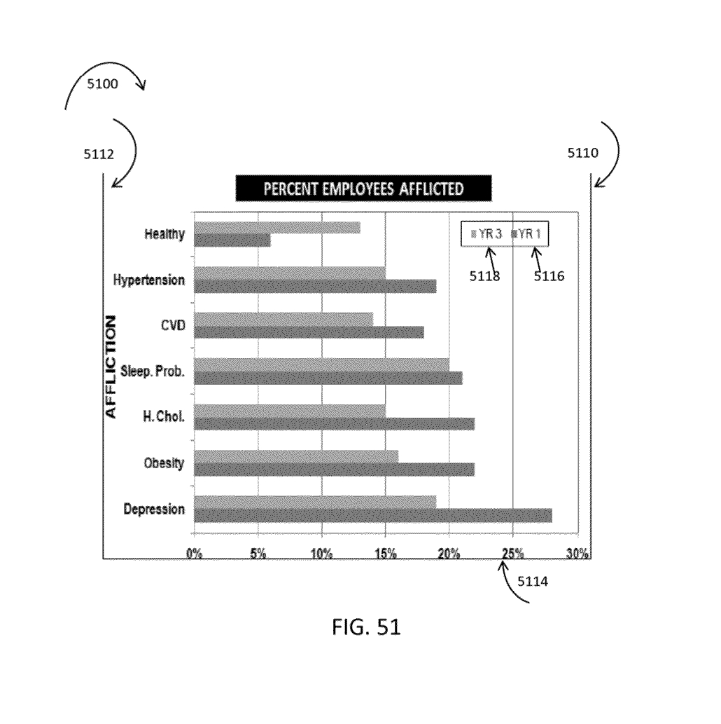

Referring to FIG. 51 is provided an Insurance Premium Negotiation tool 5100 providing an actionable insight for an employer in accordance with an embodiment of the present technique. The tool 5100 gives the employer a means to negotiate health insurance premiums with insurance providers. FIG. 51 shows a graph 5110 wherein the Y-Axis 5112 includes the type of health related issues afflicting a population and the X-axis 5114 includes the percentage of employees in an organization afflicted by those issues. The graph for example shows the percentage of the population affected by issues like hypertension, CVD, sleep problems, high cholesterol, obesity, and depression. It also shows the percentage of the healthy population. The graph provides the data for Year 1 5116 (in blue) and Year 3 5118 (in green) as horizontal bar charts. The Year 3 data clearly shows a distinct improvement in the health status of the population. This improvement may be a result of the employees having used the RCT and followed the recommendations and the employer having used the RMT and introduced health programs in the organizations. The employers may use the data for year 3 5118, indicating the better health of its employees to bargain for a reduced premium from the insurance service providers. In embodiments, where the year 3 results are relatively poorer than year 1 results the employer can understand the magnitude of the issues and use this as a tool to negotiate increase in premium values. This actionable insight can be obtained for the company as a whole and/or for different specific locations.

In one embodiment, the system and method disclosed herein may provide a Return on Investment (ROI) Calculator to the employer. This calculator tool enables an employer understand what the returns employer either earns or can earn when spending money to follow the system and method disclosed in the present technique. The basis of this calculation is knowing the prevalence rates of diseases and the associated expenses versus reducing the percent of people (below prevalence rates) who actually need to be treated. As described herein above the system and method disclosed herein is designed to predict and prevent diseases before they actually afflict the individuals.

There are three ways in which a corporation can usually save money. 1. Medical Cost Savings, 2. Productivity Savings, 3. Onsite Testing Savings. Medical Cost Saving can be realized by disease prevention or via curbing the progression of diseases. By actually preventing diseases, employees can avoid hospital stays and therefore provide Productivity Savings to the employer. Typically any health check program requires about a 2.5 to 3 days of subject involvement. The onsite testing program, disclosed in accordance with the present technique, typically requires less than an hour per employee and hence adoption of this program provides Onsite Testing Savings for the employer. The system disclosed in accordance with the present technique is able to benchmark an individual's health related scores/grades and disease risk status. When the employee goes through the system and method disclosed herein the second and third time (every year program), the system can detect the changes/improvements/disease risk status. This change is then incorporated into the ROI tool and this tool is then able to calculate all the savings mentioned above. Knowing how much the health program in accordance with the present technique costs, this tool is then able to calculate the ROI which the employer enjoys.

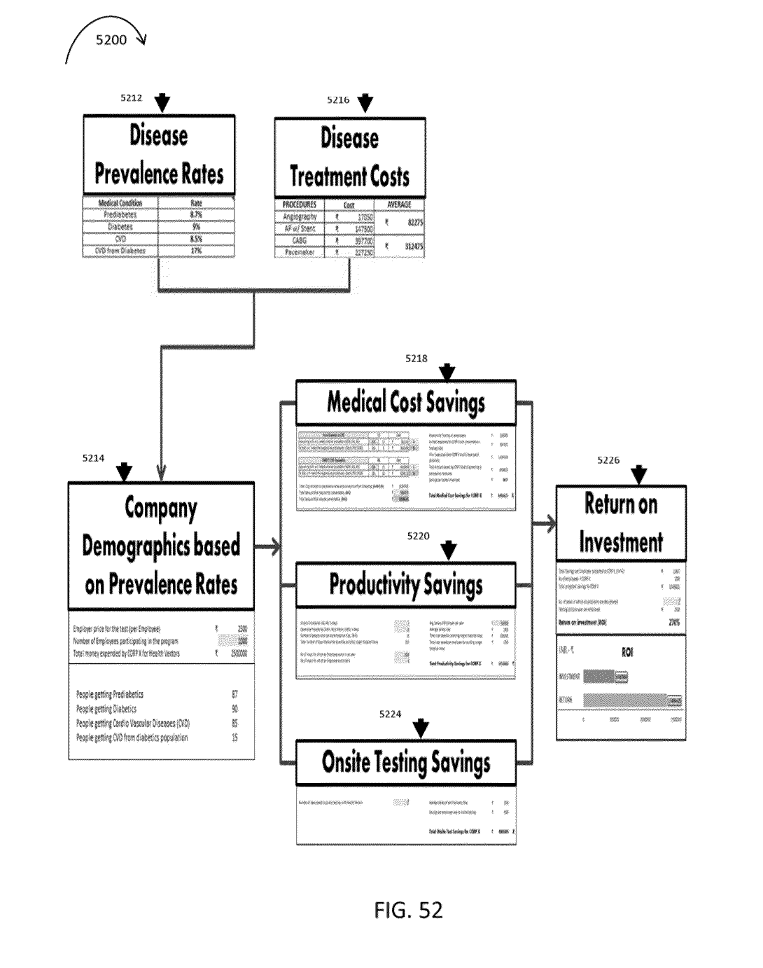

FIG. 52 shows a partial view of this ROI tool 5200. The prevalence rates of diseases 5212, disease treatment costs 5216 the actual number of people who are using the program in an organization and the program cost per person etc. . . . 5214 is first determined Medical Cost Savings section 5218, Productivity Savings section 5220, and Onsite Testing Savings section 5224 is also determined. The calculations are then performed by the tool and the output ROI is shown in section 5226.

Thus the system and method disclosed herein provide an employer huge return on investments made for testing their employees with a 360 degree perspective and providing preventing or on-time interventions to the employees. In one embodiment, an organization can expect an ROI of about 250 percent to about on using program per the system and method disclosed in accordance with the present technique.

The second mechanism includes physicians and specialists, for example, mathematicians, statisticians, who may be trained on health assessment methodologies as required by the systems and method disclosed herein. The physicians and/or specialists review the data set associated with each and every information collected for an individual and provide a health score/grade/index for each data set. In the process of providing the health score/grade/index the physicians and/or specialists may also provide a reason for why a particular health score/grade/index has been provided for the acquired data sets. While evaluating/analyzing the health scores the physicians and specialist take into consideration the entire data set including family history and lifestyle habits etc. . . . While evaluating/analyzing the health grades the physicians and specialist take into consideration parameter states and while evaluating/analyzing the health index the physicians and specialist take into consideration the health grade of a population of individuals in an ecosystem. In one embodiment, the individual's health data can be accessed from anywhere, anytime using the World Wide Web only by those who are provided access to such data. In various embodiments the First platform and the third platform can include tools know in the art for inputting data into system including a keyboard, a touch pad, a scanner, etc. . . .

In one embodiment, the local computer server may be provided with a first platform as envisaged by one skilled in the art to enable the input of the data set obtained by the first mechanism and the data set may be then transmitted to the central server in communication with the local computer server using the second platform. A third platform is provided in the central server for the second mechanism to input the data set and the health score/grade/index; wherein an expert system is created in the central server based on the data set and the health score/grade/index. The third platform may enable the central server system to use a statistical number of health score/grade/index generated and the reasons provided for the different data sets and correlate the health score/grade/index provided by the second mechanism to a typical data set obtained by the first mechanism.

Among various other advantages provided by this system, the first mechanism and second mechanism may also include a system and method for looking for trends on a regular/periodic basis and provide proactive medical intervention. More particularly the intervention may be provided for infinitesimal changes observed by evaluating the trends that are indicative of the disease precursors and/or disease progression to life threatening medical conditions in the future. This aspect itself may increase the motivation factor for employee's to undertake their health check-up. In one embodiment, the first mechanism is aimed at acquiring the data set required for the analysis within a maximum time period of about 45 minutes to about an hour, which implies that there is no wasted day for an individual, especially working individuals for getting a health check-up done.

The invention described herein aims to provide a technology based medical screening and diagnostics services for the corporate and retail sectors. The invention described herein is directed at making the world a healthier place—one individual at a time.

The invention provides a solution to the long standing need of keeping individuals healthy, reduce risks by changing health-related behaviors, arrest the onset or progression of diseases, and/or optimize care for those with serious health concerns by appropriately directing them to hospitals or external experts. The invention further aims to surround the individuals with a tailored proactive intervention wherever they are, at home or at work, so that they may go about their daily activities without having to worry about their health. The system and method described herein enables the making of appropriate connections at the appropriate time, and when and where interventions are most needed, thus optimizing the end results. The system and method enable managing health risks based on authentic data, detailed analyses, and timely proactive medical intervention.

The foregoing embodiments meet the overall objectives of this disclosure as summarized above. However, it will be clearly understood by those skilled in the art that the foregoing description has been made in terms only of the most preferred specific embodiments. Therefore, many other changes and modifications clearly and easily can be made that are also useful improvements and definitely outside the existing art without departing from the scope of the present disclosure, indeed which remain within its very broad overall scope, and which disclosure is to be defined over the existing art by the appended claims.

We claim:

1. A health assessment, prediction, and management system comprising:
a first mechanism capable of acquiring and capturing a data set comprising an individual's health status;
a local computer server, wherein a first platform is provided for the first mechanism to input the data set;
a central server in communication with the local computer server, wherein a second platform is provided for the transmittal of the data set from the local computer server to the central server;
a second mechanism capable of accessing the data set in the central server, and analysing the data set acquired by the first mechanism, wherein the second mechanism is capable of providing an analytical result, wherein the analytical result comprises a health score/grade/index generated by the second mechanism, wherein the second mechanism provides associated reasons for the health score/grade/index, wherein the second provides a health risk assessment for the individual;
a third platform, wherein the third platform is provided in the central server for the second mechanism to input the data set and the health score/grade/index in the central server; and
an expert system, wherein the expert system is created in the central server based on the data set, the health score/grade/index, the associated reasons, and the health risk assessment provided for the individual.

2. The system of claim 1, wherein the individual is provided a dashboard to view the individual's data.

3. The system of claim 2, wherein the dashboard consists of an Individual Personal Dashboard, which comprises a Subject Story Palette, Clinical Data, Personal Health Questionnaire Data, recommendations, trends, comparisons, and tools.

4. The system of claim 1, wherein an organization is provided a dashboard to view the data of a population of individuals.

5. The system of claim 4, wherein the dashboard consists of an Employer Global Dashboard, which comprises population distribution, score distributions, top problems and corresponding recommendations, Employee Health Grade distribution, trends, comparisons, Health Risk Distribution and tools.

6. The system of claim 1, wherein the system provides the individual a tool to act on the health risks assessed for the individual.

7. The system of claim 6, wherein the tool consists of a Risk Control Tool, Health Assessment Tool, Health Risk Assessment Tool, and a Risk Reduction Path.

8. The system of claim 1, wherein the system provides an organization housing a population of individuals a tool to act on the health risks assessed for the population of individual.

9. The system of claim 8, wherein the tool consists of a Risk Mitigation Tool, Return on Investment Tool, Heat Map, and Insurance Premium Negotiation Tool.

10. A health assessment, prediction, and management method comprising:
a first step of providing a first mechanism capable of acquiring and capturing a data set comprising an individual's health status;
a second step of providing a local computer server, wherein a first platform is provided for the first mechanism to input the data set,
a third step of providing a central server in communication with the local computer, wherein a second platform is provided for the transmittal of the data set from the local computer server to the central server,
a fourth step of providing a second mechanism capable of accessing the data set in the central server and analysing the data set acquired by the first mechanism, wherein the second mechanism is capable of providing an analytical result, wherein the analytical result comprises a health score/grade/index generated by the second mechanism, wherein the second mechanism provides associated reasons for the health score/grade/index, wherein the second provides a health risk assessment for the individual;
a fifth step of providing a third platform in the central server for the second mechanism to input the data set and the health score/grade/index; and
a sixth step of creating an expert system in the central server based on the data set, the health score/grade/index, the associated reasons, and the health risk assessment provided for the individual.

11. A health assessment, prediction and management system comprising:
a first mechanism capable of acquiring and capturing a first data set comprising an individual's health status;
a local computer server, wherein a first platform is provided for the first mechanism to input the data set;
a central server in communication with the local computer server, wherein a second platform is provided for the transmittal of the data set from the local computer server to the central server;
a second mechanism capable of accessing the data set in the central server, and analysing the data set acquired by the first mechanism, wherein the second mechanism is capable of providing an analytical result, wherein the analytical result comprises a health score/grade/index generated by the second mechanism, wherein the second mechanism provides associated reasons for the health score/grade/index, wherein the second mechanism provides a health risk assessment for the individual;
a third platform, wherein the third platform is provided in the central server for the second mechanism to input the data set and the health score/grade/index in the central server; and
an expert system, wherein the expert system is created in the central server based on the data set, health score/grade/index, the associated reasons, and the health risk assessment provided for the individual; wherein the expert system is further capable of interpolating, extrapolating, and correlating the health score/grade/index to a second data set acquired by the first mechanism for the same, different, or related individuals in the presence or absence of a second mechanism;
wherein the expert system is then capable of generating a health score/grade/index for the second data set; and
wherein the expert system is capable of identifying infinitesimal changes in the second data set and providing a health score/grade/index associated with the infinitesimal changes.

12. The system of claim 11, wherein the expert system is capable of self-learning and discovery.

13. A health assessment, prediction and management system comprising:
a second mechanism, wherein the second mechanism provides a health risk assessment to an individual;
a first set of tools provided to an individual to act on the health risks assessed for the individual, wherein the first set of tools consists of a Risk Control Tool, Health Assessment Tool, Health Risk Assessment Tool, and a Risk Reduction Path Tool; and
a second set of tools provided to an organization housing a population of individuals to act on the health risks assessed for the population of individuals, wherein the second set of tools consists of a Risk Mitigation Tool, Return on Investment Tool, Heat Map Tool, and Insurance Premium Negotiation Tool.
